(19) United States
(12) Patent Application Publication
(10) Pub. No.: US 2026/0003158 A1
(43) Pub. Date: Jan. 1, 2026

(54) OPTICAL SYSTEM AND OPTICAL APPARATUS

(71) Applicant: FUJIFILM Corporation, Tokyo (JP)

(72) Inventors: Daiki KOMATSU, Saitama-shi (JP); Takuya TANAKA, Saitama-shi (JP); Hiroki SAITO, Saitama-shi (JP)

(73) Assignee: FUJIFILM Corporation, Tokyo (JP)

(21) Appl. No.: 19/322,062

(22) Filed: Sep. 8, 2025

Related U.S. Application Data
(63) Continuation of application No. PCT/JP2024/001828, filed on Jan. 23, 2024.

(30) Foreign Application Priority Data
Mar. 22, 2023 (JP) 2023-045217

(51) Int. Cl. G02B 9/12; G03B 9/02

(52) U.S. Cl. CPC G02B 9/12; G03B 9/02

(57) ABSTRACT

An optical system includes an aperture stop that has a variable opening diameter and that determines an F number of the optical system, in which at least one positive lens and at least one negative lens are disposed closer to an object side than the aperture stop, and at least one positive lens and at least one negative lens are disposed closer to an image side than the aperture stop. An image side surface of at least one negative lens among the negative lenses disposed closer to the object side than the aperture stop has a concave shape. The optical system satisfies a predetermined conditional expression.

### CROSS-REFERENCE TO RELATED APPLICATIONS

This application is a continuation application of International Application No. PCT/JP2024/001828, filed on Jan. 23, 2024, which claims priority from Japanese Patent Application No. 2023-045217, filed on Mar. 22, 2023. The entire disclosure of each of the above applications is incorporated herein by reference.

### BACKGROUND

### Technical Field

The technology of the present disclosure relates to an optical system and an optical apparatus.

### Related Art

In the related art, as optical systems that can be used in an optical apparatus such as a camera, optical systems disclosed in JP1995-035972A (JP-H07-035972A) and JP2005-292344A are known.

### SUMMARY

There is a demand for an optical system having a large image circle, a small size, and favorably corrected aberrations. These requirement levels are increasing year by year.

An object of the present disclosure is to provide an optical system having a large image circle, a small size, and favorably corrected aberrations, and an optical apparatus comprising the optical system.

According to a first aspect of the present disclosure, there is provided an optical system comprising: an aperture stop that has a variable opening diameter and that determines an F number of the optical system, in which at least one positive lens and at least one negative lens are disposed closer to an object side than the aperture stop, at least one positive lens and at least one negative lens are disposed closer to an image side than the aperture stop, an image side surface of at least one negative lens among the negative lenses disposed closer to the object side than the aperture stop has a concave shape, and in a case where a sum of a distance on an optical axis from a lens surface of the optical system closest to the object side to a lens surface of the optical system closest to the image side and a back focal length of the optical system at an air conversion distance in a state where an infinite distance object is in focus is denoted by TL, a focal length of the optical system in a state where the infinite distance object is in focus is denoted by f, a maximum half angle of view in a state where the infinite distance object is in focus is denoted by om, and Y=f×tan ωm is established, Conditional Expression (1) is satisfied, which is represented by 1<TL/Y<6.5 (1).

According to a second aspect of the present disclosure, in the optical system according to the first aspect, the optical system consists of, in order from the object side to the image side, a first lens group that has a refractive power, a second lens group that has a positive refractive power, and a third lens group that has a refractive power, during focusing, the first lens group and the third lens group do not move with respect to an image plane, and the second lens group moves along the optical axis, and in a case where the back focal length of the optical system at the air conversion distance in a state where the infinite distance object is in focus is denoted by Bf, Conditional Expression (2) is satisfied, which is represented by 0.5<Bf/f<3 (2).

According to a third aspect of the present disclosure, in the optical system according to the first aspect, the optical system further comprises, successively in order from a position closest to the object side to the image side: a first lens group that has a refractive power; and a second lens group that has a positive refractive power, in which the aperture stop is disposed between a lens surface of the first lens group closest to the image side and a lens surface of the second lens group closest to the object side, during focusing, the first lens group does not move with respect to an image plane, and the second lens group moves along the optical axis, the first lens group includes at least one cemented lens formed by cementing at least one positive lens and at least one negative lens, a surface of a first cemented lens, which is a cemented lens closest to the image side among the cemented lenses included in the first lens group, closest to the object side has a concave shape, and in a case where an average value of Abbe numbers of all negative lenses included in the first cemented lens based on a d line is denoted by vnc1, and an average value of Abbe numbers of all positive lenses included in the first cemented lens based on the d line is denoted by vpc1, Conditional Expression (3) is satisfied, which is represented by 16<vnc1−vpc1<75 (3).

According to a fourth aspect of the present disclosure, in the optical system according to the first aspect, in a case where the back focal length of the optical system at the air conversion distance in a state where the infinite distance object is in focus is denoted by Bf, Conditional Expression (2) is satisfied, which is represented by 0.5<Bf/f<3 (2).

According to a fifth aspect of the present disclosure, in the optical system according to the first aspect, in a case where a group consisting of all optical elements disposed closer to the object side than a spacing closest to the object side among spacings that change during focusing is defined as a first lens group, the first lens group includes at least one cemented lens formed by cementing at least one positive lens and at least one negative lens, and in a case where a cemented lens closest to the image side among the cemented lenses included in the first lens group is defined as a first cemented lens, an average value of Abbe numbers of all negative lenses included in the first cemented lens based on a d line is denoted by vnc1, and an average value of Abbe numbers of all positive lenses included in the first cemented lens based on the d line is denoted by vpc1, Conditional Expression (3) is satisfied, which is represented by 16<vnc1−vpc1<75 (3).

According to a sixth aspect of the present disclosure, in the optical system according to the first aspect, in a case where a group consisting of all optical elements disposed closer to the object side than a spacing closest to the object side among spacings that change during focusing is defined as a first lens group, the first lens group includes at least one cemented lens formed by cementing at least one positive lens and at least one negative lens, and in a case where a cemented lens closest to the image side among the cemented lenses included in the first lens group is defined as a first cemented lens, the first lens group includes, on the object side with respect to the first cemented lens, a negative meniscus lens convex toward the object side, a negative meniscus lens convex toward the object side, and a negative lens successively in order from the object side to the image side.

According to a seventh aspect of the present disclosure, in the optical system according to the first aspect, the optical system consists of, in order from the object side to the image side, a first lens group, a second lens group, and a third lens group that has a refractive power, with spacings that change during focusing as boundaries between the lens groups.

According to an eighth aspect of the present disclosure, in the optical system according to the first aspect, the optical system further comprises, successively in order from a position closest to the object side to the image side: a first lens group; a second lens group; and a third lens group that has a refractive power, in which spacings that change during focusing are provided as boundaries between the lens groups, and during focusing, the third lens group does not move with respect to an image plane.

According to a ninth aspect of the present disclosure, in the optical system according to the first aspect, the optical system further comprises, successively in order from a position closest to the object side to the image side: a first lens group; a second lens group; and a third lens group that has a refractive power, in which spacings that change during focusing are provided as boundaries between the lens groups, and the third lens group includes at least one positive lens and at least one negative lens.

According to a tenth aspect of the present disclosure, in the optical system according to the ninth aspect, in a case where an average value of Abbe numbers of all negative lenses included in the third lens group based on a d line is denoted by vn3, and an average value of Abbe numbers of all positive lenses included in the third lens group based on the d line is denoted by vp3, Conditional Expression (4) is satisfied, which is represented by −20<vn3−vp3<20 (4).

According to an eleventh aspect of the present disclosure, in the optical system according to the first aspect, the optical system further comprises, successively in order from a position closest to the object side to the image side: a first lens group; a second lens group; and a third lens group that has a refractive power, in which spacings that change during focusing are provided as boundaries between the lens groups, the third lens group includes at least one cemented lens formed by cementing at least one positive lens and at least one negative lens, and in a case where a cemented lens closest to the image side among the cemented lenses included in the third lens group is defined as a third cemented lens, an average value of Abbe numbers of all negative lenses included in the third cemented lens based on a d line is denoted by vnc3, and an average value of Abbe numbers of all positive lenses included in the third cemented lens based on the d line is denoted by vpc3, Conditional Expression (5) is satisfied, which is represented by −80<vnc3−vpc3<20 (5).

According to a twelfth aspect of the present disclosure, in the optical system according to the first aspect, the optical system further comprises, successively in order from a position closest to the object side to the image side: a first lens group; a second lens group; and a third lens group that has a negative refractive power, in which spacings that change during focusing are provided as boundaries between the lens groups.

According to a thirteenth aspect of the present disclosure, in the optical system according to the first aspect, in a case where a distance on the optical axis from the lens surface of the optical system closest to the object side to a paraxial entrance pupil position in a state where the infinite distance object is in focus is denoted by Enp, Conditional Expression (6) is satisfied, which is represented by 0.28<Enp/Y<1.2 (6).

According to a fourteenth aspect of the present disclosure, in the optical system according to the first aspect, the optical system further comprises, successively in order from a position closest to the object side to the image side: a first lens group; and a second lens group, in which a spacing that changes during focusing is provided as a boundary between the lens groups, and during focusing, all lenses in the second lens group and the aperture stop move along the optical axis in an integrated manner.

According to a fifteenth aspect of the present disclosure, in the optical system according to the first aspect, the optical system further comprises, successively in order from a position closest to the object side to the image side: a first lens group; and a second lens group, in which a spacing that changes during focusing is provided as a boundary between the lens groups, and the aperture stop is disposed closest to the object side in the second lens group.

According to a sixteenth aspect of the present disclosure, in the optical system according to the first aspect, the optical system further comprises, successively in order from a position closest to the object side to the image side: a first lens group; and a second lens group, in which a spacing that changes during focusing is provided as a boundary between the lens groups, and in a case where a negative lens which is second from the object side among negative lenses included in the first lens group is defined as a second negative lens, and a combined focal length of all optical elements in the first lens group disposed closer to the image side than the second negative lens in a state where the infinite distance object is in focus is denoted by fG1R, Conditional Expression (7) is satisfied, which is represented by 0.45<fG1R/f<3.5 (7).

According to a seventeenth aspect of the present disclosure, in the optical system according to the first aspect, Conditional expression (8) is satisfied, which is represented by 3.6<TL²/(Y×f)<30 (8).

According to an eighteenth aspect of the present disclosure, in the optical system according to the first aspect, in a case where a distance on the optical axis from a paraxial exit pupil position to an image plane in a state where the infinite distance object is in focus is denoted by Exp, and Exp is calculated using the air conversion distance for an optical member having no refractive power in a case where the optical member is disposed between the image plane and the paraxial exit pupil position, Conditional Expression (9) is satisfied, which is represented by 1.2<Exp/Y<3.8 (9).

According to a nineteenth aspect of the present disclosure, in the optical system according to the first aspect, the optical system further comprises, successively in order from a position closest to the object side to the image side: a first lens group that has a negative refractive power; and a second lens group, in which a spacing that changes during focusing is provided as a boundary between the lens groups.

According to a twentieth aspect of the present disclosure, in the optical system according to the first aspect, in a case where the back focal length of the optical system at the air conversion distance in a state where the infinite distance object is in focus is denoted by Bf, Conditional Expression (10) is satisfied, which is represented by 0.3<Y/Bf<1.2 (10).

According to a twenty-first aspect of the present disclosure, in the optical system according to the first aspect, in a case where a distance on the optical axis from the lens surface of the optical system closest to the object side to a paraxial entrance pupil position in a state where the infinite distance object is in focus is denoted by Enp, Conditional Expression (11) is satisfied, which is represented by 0.01<Enp/f<0.8 (11).

According to a twenty-second aspect of the present disclosure, in the optical system according to the twenty-first aspect, Conditional Expression (11-1) is satisfied, which is represented by 0.01<Enp/f<0.2 (11-1).

According to a twenty-third aspect of the present disclosure, in the optical system according to the first aspect, in a case where the back focal length of the optical system at the air conversion distance in a state where the infinite distance object is in focus is denoted by Bf, Conditional Expression (12) is satisfied, which is represented by 0.2<Bf/TL<10 (12).

According to a twenty-fourth aspect of the present disclosure, in the optical system according to the first aspect, in a case where a distance on the optical axis from the lens surface of the optical system closest to the object side to a paraxial entrance pupil position in a state where the infinite distance object is in focus is denoted by Enp, and the back focal length of the optical system at the air conversion distance in a state where the infinite distance object is in focus is denoted by Bf, Conditional Expressions (11-2) and (12-1) are satisfied, which are represented by 0.01<Enp/f<0.26 (11-2), and 0.5<Bf/TL<10 (12-1).

According to a twenty-fifth aspect of the present disclosure, in the optical system according to the first aspect, in a case where a distance on the optical axis from the lens surface of the optical system closest to the object side to a paraxial entrance pupil position in a state where the infinite distance object is in focus is denoted by Enp, and the back focal length of the optical system at the air conversion distance in a state where the infinite distance object is in focus is denoted by Bf, Conditional Expressions (6-3) and (12-1) are satisfied, which are represented by 0.01<Enp/Y<0.57 (6-3), and 0.5<Bf/TL<10 (12-1).

According to a twenty-sixth aspect of the present disclosure, in the optical system according to the first aspect, in a case where a lateral magnification of the optical system in a state where a nearest object is in focus is denoted by B, Conditional Expression (13) is satisfied, which is represented by 0.2<Bl<1.2 (13).

According to a twenty-seventh aspect of the present disclosure, in the optical system according to the first aspect, in a case where a maximum radius of an opening of the aperture stop is denoted by Hstp, Conditional Expression (14) is satisfied, which is represented by 0.03<Hstp/f<0.4 (14).

According to a twenty-eight aspect of the present disclosure, in the optical system according to the first aspect, in a case where a group closest to the object side among groups that move during focusing is defined as a first focusing group, a lateral magnification of the first focusing group in a state where the infinite distance object is in focus is denoted by βFF, a combined lateral magnification of all lenses closer to the image side than the first focusing group in a state where the infinite distance object is in focus is denoted by βR, and βR=1 is established in a case where there is no lens on the image side with respect to the first focusing group, Conditional Expression (15) is satisfied, which is represented by 0.3<|(1−βFF²)×βR²|<4 (15).

According to a twenty-ninth aspect of the present disclosure, in the optical system according to the first aspect, in a case where a paraxial radius of curvature of an image side surface of a lens closest to the object side is denoted by R1r, and a paraxial radius of curvature of an object side surface of a lens which is second from the object side is denoted by R2f, Conditional Expression (16) is satisfied, which is represented by −1.5<(R1r−R2f)/(R1r+R2f)<1.5 (16).

According to a thirtieth aspect of the present disclosure, in the optical system according to the first aspect, in a case where a paraxial radius of curvature of an object side surface of a lens which is third from the object side is denoted by R3f, and a paraxial radius of curvature of an image side surface of the lens which is third from the object side is denoted by R3r, Conditional Expression (17) is satisfied, which is represented by −1<(R3f+R3r)/(R3f−R3r)<2.5 (17).

According to a thirty-first aspect of the present disclosure, in the optical system according to the first aspect, in a case where a spacing on the optical axis between a lens closest to the object side and a lens which is second from the object side is denoted by d12, a distance on the optical axis from the lens surface of the optical system closest to the object side to a paraxial entrance pupil position in a state where the infinite distance object is in focus is denoted by Enp, a paraxial radius of curvature of an image side surface of the lens closest to the object side is denoted by R1r, a paraxial radius of curvature of an object side surface of the lens which is second from the object side is denoted by R2f, and h1=Enp×tan ωm is established, Conditional Expression (18) is satisfied, which is represented by 0.05<d12/h1−(1/R1r−1/R2f)×h1<0.7 (18).

According to a thirty-second aspect of the present disclosure, in the optical system according to the first aspect, at least one first aspherical lens having at least one surface whose absolute value of a curvature at a position of a maximum effective diameter is greater than an absolute value of a paraxial curvature is disposed closer to the object side than the aperture stop.

According to a thirty-third aspect of the present disclosure, in the optical system according to the thirty-second aspect, in a case where a refractive index of a first aspherical lens closest to the object side among the first aspherical lenses at a d line is denoted by Noa, Conditional Expression (19) is satisfied, which is represented by 1.45<Noa<1.7 (19).

According to a thirty-fourth aspect of the present disclosure, in the optical system according to the thirty-second aspect, in a case where an Abbe number of a first aspherical lens closest to the object side among the first aspherical lenses based on a d line is voa, Conditional Expression (20) is satisfied, which is represented by 45<voa<85 (20).

According to a thirty-fifth aspect of the present disclosure, in the optical system according to the first aspect, at least one second aspherical lens in which a refractive power at a position of a maximum effective diameter is shifted in a negative direction with respect to a refractive power in a paraxial region is disposed closer to the image side than the aperture stop.

According to a thirty-sixth aspect of the present disclosure, in the optical system according to thirty-fifth aspect, in a case where a refractive index of an aspherical lens closest to the image side among aspherical lenses disposed closer to the image side than the aperture stop at a d line is denoted by Nia, Conditional Expression (21) is satisfied, which is represented by 1.45<Nia<2 (21).

According to a thirty-seventh aspect of the present disclosure, in the optical system according to the thirty-fifth aspect, in a case where an Abbe number of an aspherical lens closest to the image side among aspherical lenses disposed closer to the image side than the aperture stop based on a d line is denoted by via, Conditional Expression (22) is satisfied, which is represented by 38<via<100 (22).

According to a thirty-eighth aspect of the present disclosure, in the optical system according to the first aspect, an image side surface of a positive lens closest to the aperture stop among positive lenses disposed closer to the object side than the aperture stop has a convex shape.

According to a thirty-ninth aspect of the present disclosure, in the optical system according to the first aspect, a negative meniscus lens, a negative meniscus lens, and a negative lens are disposed successively in order from a position closest to the object side to the image side.

According to a fortieth aspect of the present disclosure, in the optical system according to the first aspect, the optical system further comprises: at least one cemented lens, in which a cemented lens closest to the image side among the cemented lenses included in the optical system has a cemented surface convex toward the object side.

According to a forty-first aspect of the present disclosure, in the optical system according to the first aspect, a cemented lens is disposed closest to the image side, and the cemented lens disposed closest to the image side has a cemented surface convex toward the object side.

According to a forty-second aspect of the present disclosure, in the optical system according to the first aspect, a negative lens and a positive lens are disposed successively in order from a position closest to the image side to the object side.

According to a forty-third aspect of the present disclosure, in the optical system according to the first aspect, a negative lens, a negative lens, a positive lens are disposed successively in order from a position closest to the image side to the object side.

According to a forty-fourth aspect of the present disclosure, in the optical system according to the first aspect, in a case where a group closest to the object side among groups that move during focusing is defined as a first focusing group, a lens surface of the first focusing group closest to the object side has a convex shape.

According to a forty-fifth aspect of the present disclosure, in the optical system according to the first aspect, in a case where a group closest to the object side among groups that move during focusing is defined as a first focusing group, the first focusing group includes five or more lenses.

According to a forty-sixth aspect of the present disclosure, in the optical system according to the first aspect, in a case where a group closest to the object side among groups that move during focusing is defined as a first focusing group, the aperture stop is disposed between a lens surface of the first focusing group closest to the object side and a lens surface of the first focusing group closest to the image side.

According to a forty-seventh aspect of the present disclosure, in the optical system according to the first aspect, in a case where a group closest to the object side among groups that move during focusing is defined as a first focusing group, a lens closest to the image side in the first focusing group is a positive lens convex toward the image side.

According to a forty-eighth aspect of the present disclosure, in the optical system according to the forty-seventh aspect, in a case where an effective radius of an image side surface of the lens closest to the image side in the first focusing group is denoted by hLfi, a paraxial radius of curvature of the image side surface of the lens closest to the image side in the first focusing group is denoted by RLfi, and a thickness on the optical axis of the lens closest to the image side in the first focusing group is DLfi, Conditional Expression (23) is satisfied, which is represented by 0.3<hLfi×(1/RLfi+1/DLfi)<5 (23).

According to a forty-ninth aspect of the present disclosure, in the optical system according to the first aspect, the optical system further comprises: at least one concave surface that is concave toward the image side and that is in contact with air, in which, in a case where a concave surface closest to the image side among the concave surfaces is defined as an image side concave surface, a paraxial radius of curvature of the image side concave surface is Rne, a combined focal length of all optical elements in the optical system disposed closer to the image side than the image side concave surface is denoted by fe, fe takes an infinite value in a case where there is no optical element on the image side with respect to the image side concave surface, and the back focal length of the optical system at the air conversion distance in a state where the infinite distance object is in focus is denoted by Bf, Conditional Expression (24) is satisfied, which is represented by −8<Rne×(1/fe−1/Bf)<−0.1 (24).

According to a fiftieth aspect of the present disclosure, in the optical system according to the first aspect, the optical system further comprises, successively in order from a position closest to the object side to the image side: a first lens group; and a second lens group, in which a spacing that changes during focusing is provided as a boundary between the lens groups, and in a case where a focal length of the first lens group is denoted by f1, Conditional Expression (25) is satisfied, which is represented by −2<f/f1<3 (25).

According to a fiftieth-first aspect of the present disclosure, in the optical system according to the first aspect, the optical system further comprises, successively in order from a position closest to the object side to the image side: a first lens group; and a second lens group, in which a spacing that changes during focusing is provided as a boundary between the lens groups, and in a case where a focal length of the second lens group is denoted by f2, Conditional Expression (26) is satisfied, which is represented by −2.5<f/f2<2 (26).

According to a fiftieth-second aspect of the present disclosure, in the optical system according to the first aspect, the optical system further comprises, successively in order from a position closest to the object side to the image side: a first lens group; a second lens group; and a third lens group, in which spacings that change during focusing are provided as boundaries between the lens groups, and in a case where a focal length of the third lens group is denoted by f3, Conditional Expression (27) is satisfied, which is represented by −0.35<f/f3<1.8 (27).

According to a fiftieth-third aspect of the present disclosure, in the optical system according to the first aspect, the optical system further comprises, successively in order from a position closest to the object side to the image side: a first lens group; a second lens group; a third lens group; and a fourth lens group, in which spacings that change during focusing are provided as boundaries between the lens groups, and in a case where a focal length of the fourth lens group is denoted by f4, Conditional Expression (28) is satisfied, which is represented by 0.6<f/f4<1.6 (28).

According to a fiftieth-fourth aspect of the present disclosure, in the optical system according to the first aspect, the optical system further comprises, successively in order from a position closest to the object side to the image side: a first lens group; and a second lens group, in which a spacing that changes during focusing is provided as a boundary between the lens groups, and in a case where a focal length of the first lens group is denoted by f1, and a focal length of the second lens group is denoted by f2, Conditional Expression (29) is satisfied, which is represented by −7<f2/f1<0.5 (29).

According to a fiftieth-fifth aspect of the present disclosure, in the optical system according to the first aspect, the optical system further comprises, successively in order from a position closest to the object side to the image side: a first lens group; a second lens group; and a third lens group, in which spacings that change during focusing are provided as boundaries between the lens groups, and in a case where a focal length of the second lens group is denoted by f2, and a focal length of the third lens group is denoted by f3, Conditional Expression (30) is satisfied, which is represented by −2.5<f2/f3<1.5 (30).

According to a fiftieth-sixth aspect of the present disclosure, in the optical system according to the first aspect, in a case where a combined focal length of all optical elements in the optical system disposed closer to the image side than the aperture stop is fsR, Conditional Expression (31) is satisfied, which is represented by −0.2<Y/fsR<1.1 (31).

According to a fiftieth-seventh aspect of the present disclosure, there is provided an optical apparatus comprising: the optical system according to any one of the first to fiftieth-sixth aspects.

According to a fiftieth-eighth aspect of the present disclosure, in the optical apparatus according to the fiftieth-seventh aspect, the optical apparatus further comprises: a body part, in which the optical system is tilt-rotatable with respect to the body part.

According to a fiftieth-ninth aspect of the present disclosure, in the optical apparatus according to the fiftieth-eighth aspect, in a case where a maximum angle range of the tilt rotation is denoted by θ, a unit of θ is defined as degrees, and the back focal length of the optical system at the air conversion distance in a state where the optical system is focused on the infinite distance object is denoted by Bf, Conditional Expression (32) is satisfied, which is represented by 0.08<(Y×tan θ)/Bf<1 (32).

The expressions “consists of” and “consisting of” in the present specification indicate that a lens substantially not having a refractive power, an optical element other than a lens, such as a stop, a filter, and a cover glass, a mechanism part such as a lens flange, a lens barrel, an imaging element, and a camera shake correction mechanism, and the like may be included in addition to the illustrated constituents.

The expression “˜ group having a positive refractive power” in the present specification means that the group has a positive refractive power as a whole. Likewise, the expression “˜ group having a negative refractive power” means that the group has a negative refractive power as a whole. The expression “˜ group” in the present specification is not limited to a configuration consisting of a plurality of lenses and may be a configuration consisting of only one lens.

A compound aspherical lens (a lens in which a lens (for example, a spherical lens) and a film of an aspherical shape formed on the lens are integrally formed and that functions as one aspherical lens as a whole) is not regarded as a cemented lens and is regarded as one lens. Unless otherwise noted, a curvature radius, a sign of a refractive power, and a surface shape related to a lens including an aspherical surface in a paraxial region are used. A sign of the curvature radius is defined such that a sign of the curvature radius of a surface having a convex shape facing the object side is positive, and a sign of the curvature radius of a surface having a convex shape facing the image side is negative.

The expression “focal length” used in the conditional expressions means a paraxial focal length. Unless otherwise noted, the expression “distance on the optical axis” used in the conditional expressions means a geometrical distance. The expression “back focal length at the air conversion distance” means an air conversion distance on the optical axis from the lens surface of the optical system closest to the image side to the image plane. Unless otherwise noted, values used in the conditional expressions are values based on the d line in a state where the infinite distance object is in focus.

According to the present disclosure, it is possible to provide an optical system having a large image circle, a small size, and favorably corrected aberrations, and an optical apparatus comprising the optical system.

### BRIEF DESCRIPTION OF THE DRAWINGS

FIG. 1 is a cross-sectional view showing a configuration of an optical system according to one embodiment, which corresponds to an optical system of Example 1.

FIG. 2 is a cross-sectional view showing a configuration and luminous fluxes of the optical system in FIG. 1 in each in-focus state.

FIG. 3 is a diagram showing an example of an aperture stop having a variable opening diameter.

FIG. 4 is a diagram for describing a position of a maximum effective diameter and an effective radius.

FIG. 5 is a diagram for describing symbols of conditional expressions.

FIG. 6 is a diagram of aberrations of the optical system of Example 1.

FIG. 7 is a cross-sectional view showing a configuration of an optical system of Example 2.

FIG. 8 is a diagram of aberrations of the optical system of Example 2.

FIG. 9 is a cross-sectional view showing a configuration of an optical system of Example 3.

FIG. 10 is a diagram of aberrations of the optical system of Example 3.

FIG. 11 is a cross-sectional view showing a configuration of an optical system of Example 4.

FIG. 12 is a diagram of aberrations of the optical system of Example 4.

FIG. 13 is a cross-sectional view showing a configuration of an optical system of Example 5.

FIG. 14 is a diagram of aberrations of the optical system of Example 5.

FIG. 15 is a cross-sectional view showing a configuration of an optical system of Example 6.

FIG. 16 is a diagram of aberrations of the optical system of Example 6.

FIG. 17 is a cross-sectional view showing a configuration of an optical system of Example 7.

FIG. 18 is a diagram of aberrations of the optical system of Example 7.

FIG. 19 is a cross-sectional view showing a configuration of an optical system of Example 8.

FIG. 20 is a diagram of aberrations of the optical system of Example 8.

FIG. 21 is a cross-sectional view showing a configuration of an optical system of Example 9.

FIG. 22 is a diagram of aberrations of the optical system of Example 9.

FIG. 23 is a cross-sectional view showing a configuration of an optical system of Example 10.

FIG. 24 is a diagram of aberrations of the optical system of Example 10.

FIG. 25 is a cross-sectional view showing a configuration of an optical system of Example 11.

FIG. 26 is a diagram of aberrations of the optical system of Example 11.

FIG. 27 is a cross-sectional view showing a configuration of an optical system of Example 12.

FIG. 28 is a diagram of aberrations of the optical system of Example 12.

FIG. 29 is a cross-sectional view showing a configuration of an optical system of Example 13.

FIG. 30 is a diagram of aberrations of the optical system of Example 13.

FIG. 31 is a cross-sectional view showing a configuration of an optical system of Example 14.

FIG. 32 is a diagram of aberrations of the optical system of Example 14.

FIG. 33 is a cross-sectional view showing a configuration of an optical system of Example 15.

FIG. 34 is a diagram of aberrations of the optical system of Example 15.

FIG. 35 is a cross-sectional view showing a configuration of an optical system of Example 16.

FIG. 36 is a diagram of aberrations of the optical system of Example 16.

FIG. 37 is a cross-sectional view showing a configuration of an optical system of Example 17.

FIG. 38 is a diagram of aberrations of the optical system of Example 17.

FIG. 39 is a cross-sectional view showing a configuration of an optical system of Example 18.

FIG. 40 is a diagram of aberrations of the optical system of Example 18.

FIG. 41A is a diagram showing an example of a lens barrel in a state where no tilt rotation is performed.

FIG. 41B is a diagram showing an example of the lens barrel in a state where tilt rotation is performed.

FIG. 42 is a diagram showing a schematic configuration of an optical apparatus according to one embodiment.

### DETAILED DESCRIPTION

Hereinafter, an embodiment of the present disclosure will be described with reference to the accompanying drawings.

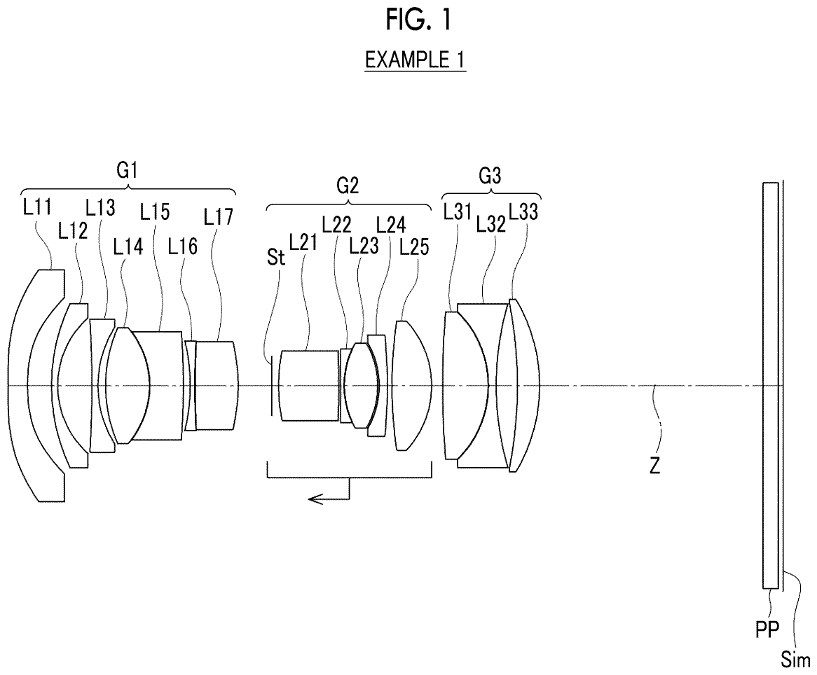

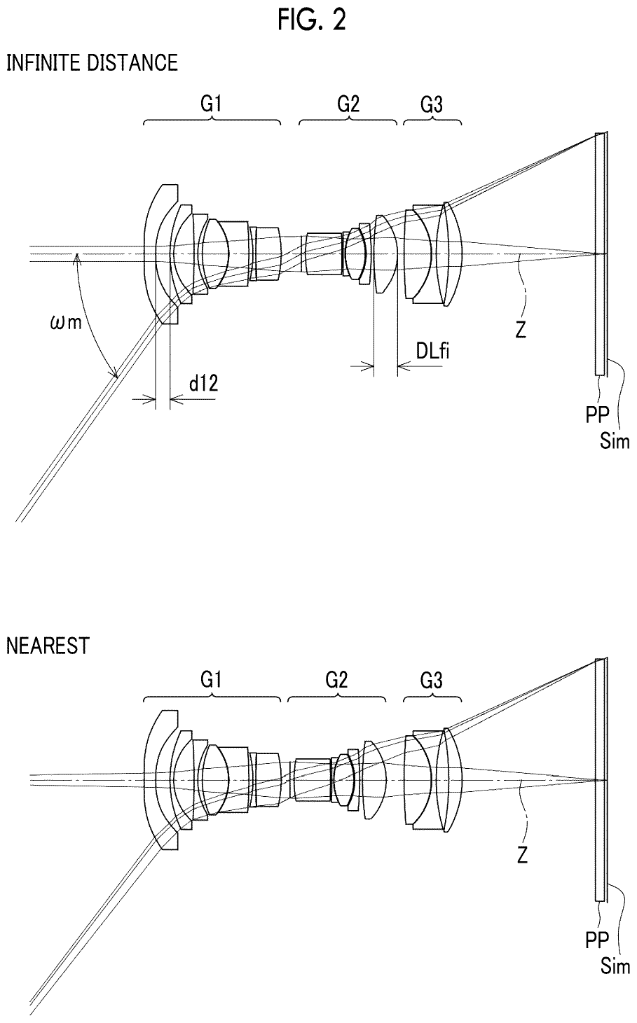

FIG. 1 shows a cross-sectional view of a configuration of an optical system according to one embodiment of the present disclosure in a state where an infinite distance object is in focus. FIG. 2 shows a cross-sectional view showing a configuration and luminous fluxes of the optical system in FIG. 1 in each in-focus state. In FIG. 2, an upper part labeled “infinite distance” shows a state where the infinite distance object is in focus, and a lower part labeled “nearest” shows a state where a nearest object is in focus. In the present specification, an object at an infinite distance will be referred to as the “infinite distance object”, and an object at a nearest distance will be referred to as the “nearest object”. The upper part of FIG. 2 shows, as the luminous flux, an on-axis luminous flux and a luminous flux having a maximum half angle of view om in a state where the infinite distance object is in focus. The lower part of FIG. 2 shows, as the luminous flux, an on-axis luminous flux and a luminous flux having a maximum half angle of view in a state where the nearest object is in focus. In FIGS. 1 and 2, a left side is an object side, and a right side is an image side. Examples shown in FIGS. 1 and 2 correspond to an optical system of Example 1 described below. Hereinafter, the description will be made mainly with reference to FIG. 1.

As an example, the optical system in FIG. 1 is configured as follows. The optical system of FIG. 1 consists of, in order from the object side to the image side, a first lens group G1 that has a refractive power, a second lens group G2 that has a refractive power, and a third lens group G3 that has a refractive power. During focusing, a spacing between the first lens group G1 and the second lens group G2 changes, and a spacing between the second lens group G2 and the third lens group G3 changes. The first lens group G1 consists of, in order from the object side to the image side, seven lenses including lenses L11 to L17. The second lens group G2 consists of, in order from the object side to the image side, an aperture stop St, and five lenses including lenses L21 to L25. The third lens group G3 consists of, in order from the object side to the image side, three lenses including lenses L31 to L33. The aperture stop St in FIG. 1 does not indicate a size and a shape, and indicates a position in an optical axis direction. An illustration method of the aperture stop St also applies to other cross-sectional views showing the configuration of the optical system.

In the example of FIG. 1, during focusing from the infinite distance object to the nearest object, the first lens group G1 and the third lens group G3 do not move with respect to an image plane Sim, and the second lens group G2 moves toward the object side. The parentheses and the leftward arrow below the second lens group G2 in FIG. 1 indicate that a group (hereinafter, also referred to as a focusing group) that moves during focusing is the second lens group G2, and indicate a direction in which the focusing group moves during focusing from the infinite distance object to the nearest object.

FIG. 1 shows an example in which an optical member PP having a parallel plate shape is disposed between the optical system and the image plane Sim, assuming that the optical system is applied to an optical apparatus. The optical member PP is a member assumed to be various filters and/or a cover glass. The various filters include a low-pass filter, an infrared cut filter, and/or a filter or the like that cuts a specific wavelength range. The optical member PP is a member that does not have a refractive power. The optical apparatus can also be configured without the optical member PP.

The optical system of the present disclosure includes an aperture stop St that determines an F number of the optical system. The aperture stop St has an opening having a variable opening diameter, and the F number can be changed by changing the opening diameter.

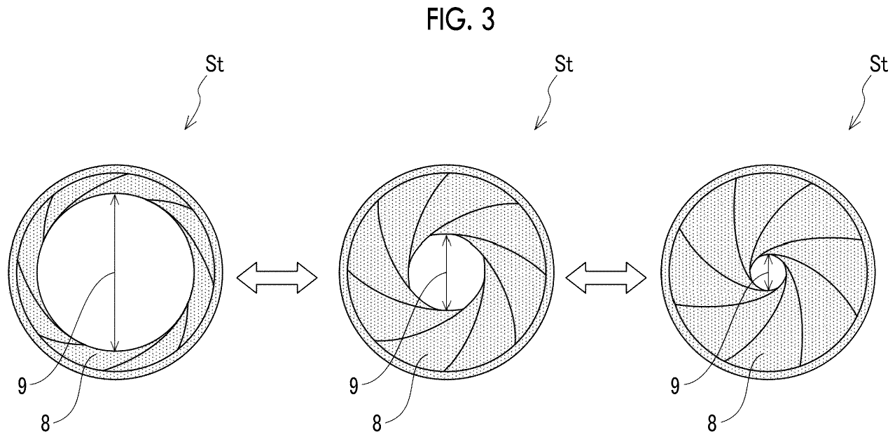

For example, as shown in FIG. 3 as an example, the aperture stop St has a plurality of stop leaf blades 8 disposed at spacings on a circumference centered on an optical axis Z and thus can be configured to form an annular light blocking portion as a whole. A portion radially inward from the light blocking portion in a diameter direction is the opening, through which light passes. The opening has a substantially circular shape, and a diameter of the circular shape is an opening diameter 9. The opening diameter 9 is changed as shown in FIG. 3 by moving the plurality of stop leaf blades 8 in an opening and closing direction. Although the aperture stop St in FIG. 3 includes eight stop leaf blades 8, only one stop leaf blade 8 is denoted by the reference numeral in FIG. 3 in order to avoid complication of the drawing. In addition, FIG. 3 is merely an example, and any number of stop leaf blades 8 can be set to be included in one aperture stop St.

In the optical system of the present disclosure, at least one positive lens and at least one negative lens are disposed closer to the object side than the aperture stop St. With this configuration, there is an advantage in correcting axial chromatic aberration and lateral chromatic aberration.

It is preferable that an image side surface of a positive lens closest to the aperture stop St among the positive lenses disposed closer to the object side than the aperture stop St has a convex shape. In such a case, there is an advantage in correcting spherical aberration.

It is preferable that an image side surface of at least one negative lens among the negative lenses disposed closer to the object side than the aperture stop St has a concave shape. In such a case, there is an advantage in suppressing various aberrations caused by off-axis rays.

In addition, in the optical system of the present disclosure, at least one positive lens and at least one negative lens are disposed closer to the image side than the aperture stop St. With this configuration, there is an advantage in correcting axial chromatic aberration and lateral chromatic aberration.

The optical system of the present disclosure is preferably configured to include, successively in order from a position closest to the object side to the image side, a first lens group G1 and a second lens group G2, in which a spacing that changes during focusing is provided as a boundary between the lens groups. In such a case, there is an advantage in suppressing fluctuations in aberration by performing focusing by changing a mutual spacing between at least two groups having different degrees of separation between the on-axis luminous flux and the off-axis luminous flux.

The expression “a spacing that changes during focusing is provided as a boundary between the lens groups” in the present specification means that, during focusing, a mutual spacing between adjacent lens groups changes, and a mutual spacing between lenses does not change inside each lens group. That is, during focusing, lenses are configured to move in units of each lens group or not move. In a case where the spacings that change during focusing among spacings between surfaces are referred to as variable surface spacings, then, for example, in the example in FIG. 1, a group consisting of all optical elements disposed closer to the object side than the variable surface spacing closest to the object side is the first lens group G1, and a group consisting of all optical elements disposed between the variable surface spacing closest to the object side and the variable surface spacing which is second from the object side is the second lens group G2. The term “optical element” in the present specification includes a lens and an aperture stop. That is, each lens group may include a stop such as an aperture stop in addition to a lens.

In a case where the optical system includes the first lens group G1 and the second lens group G2 as described above, all lenses in the second lens group G2 and the aperture stop St may be configured to move integrally along the optical axis Z during focusing. In such a case, there is an advantage in suppressing fluctuations in various aberrations caused by off-axis rays during focusing. The phrase “moving integrally” means moving simultaneously in the same direction and by the same amount.

In a case where the optical system includes the first lens group G1 and the second lens group G2 as described above, the aperture stop St may be configured to be disposed closest to the object side in the second lens group G2. In such a case, there is an advantage in achieving reduction in diameter of a lens located on the object side in the optical system while suppressing various aberrations caused by off-axis rays.

In a case where the optical system includes the first lens group G1 and the second lens group G2 as described above, a sign of the refractive power of the first lens group G1 may be configured to be negative. In such a case, there is an advantage in ensuring the amount of peripheral light.

The optical system of the present disclosure may be configured to include, successively in order from a position closest to the object side to the image side, a first lens group G1 that has a refractive power and a second lens group G2 that has a positive refractive power, in which a spacing that changes during focusing is provided as a boundary between the lens groups. In such a case, the first lens group G1 is advantageous in correcting distortion, and the second lens group G2 is advantageous in correcting spherical aberration.

In a case where the optical system includes the first lens group G1 that has a refractive power and the second lens group G2 that has a positive refractive power as described above, the aperture stop St may be configured to be disposed between a lens surface of the first lens group G1 closest to the image side and a lens surface of the second lens group G2 closest to the object side. In such a case, there is an advantage in achieving reduction in diameter of a lens located on the object side in the optical system. The aperture stop St may be disposed closest to the image side in the first lens group G1 or may be disposed closest to the object side in the second lens group G2.

In a case where the optical system includes the first lens group G1 that has a refractive power and the second lens group G2 that has a positive refractive power as described above, the first lens group G1 may be configured not to move with respect to the image plane Sim and the second lens group G2 may be configured to move along the optical axis Z during focusing. During focusing, the first lens group G1 is fixed, which is advantageous for a dust-proof and drip-proof structure.

In a case where the optical system includes the first lens group G1 that has a refractive power and the second lens group G2 that has a positive refractive power as described above, it is preferable that the first lens group G1 includes at least one cemented lens formed by cementing at least one positive lens and at least one negative lens. In such a case, there is an advantage in correcting axial chromatic aberration.

As described above, in a case where the first lens group G1 includes at least one cemented lens formed by cementing at least one positive lens and at least one negative lens, a cemented lens closest to the image side among the cemented lenses included in the first lens group G1 will be referred to as a first cemented lens. In the example of FIG. 1, a cemented lens consisting of the lens L16 and the lens L17 corresponds to the first cemented lens.

It is preferable that a surface of the first cemented lens closest to the object side has a concave shape. In such a case, there is an advantage in correcting spherical aberration.

It is preferable that the first lens group G1 includes, on the object side with respect to the first cemented lens, a negative meniscus lens convex toward the object side, a negative meniscus lens convex toward the object side, and a negative lens successively in order from the position closest to the object side to the image side. In such a case, there is an advantage in correcting distortion while maintaining the reduction in size.

The optical system of the present disclosure may be configured to include, successively in order from a position closest to the object side to the image side, a first lens group G1, a second lens group G2, and a third lens group G3 that has a refractive power, in which spacings that change during focusing are provided as boundaries between the lens groups. In such a case, there is an advantage in suppressing fluctuations in aberration by performing focusing by changing a spacing between adjacent groups for at least three groups having different degrees of separation between the on-axis luminous flux and the off-axis luminous flux.

In a case where the optical system includes the first lens group G1, the second lens group G2, and the third lens group G3 that has a refractive power as described above, the third lens group G3 may be configured not to move with respect to the image plane Sim during focusing. In such a case, there is an advantage in simplifying the focus mechanism and improving the robustness of the optical system.

In a case where the optical system includes the first lens group G1, the second lens group G2, and the third lens group G3 that has a refractive power as described above, the third lens group G3 may be configured to include at least one positive lens and at least one negative lens. In such a case, there is an advantage in suppressing fluctuations in lateral chromatic aberration during focusing.

In a case where the optical system includes the first lens group G1, the second lens group G2, and the third lens group G3 that has a refractive power as described above, it is preferable that the third lens group G3 includes at least one cemented lens formed by cementing at least one positive lens and at least one negative lens. In such a case, there is an advantage in suppressing fluctuations in lateral chromatic aberration during focusing while suppressing astigmatism.

As described above, in a case where the third lens group G3 includes at least one cemented lens formed by cementing at least one positive lens and at least one negative lens, a cemented lens closest to the image side among the cemented lenses included in the third lens group G3 will be referred to as a third cemented lens. In the example of FIG. 1, a cemented lens consisting of the lens L31 and the lens L32 corresponds to the third cemented lens.

In a case where the optical system includes the first lens group G1, the second lens group G2, and the third lens group G3 that has a refractive power as described above, a sign of the refractive power of the third lens group G3 may be configured to be negative. In such a case, there is an advantage in reducing the total length of the optical system.

The optical system of the present disclosure may be configured to consist of, in order from the object side to the image side, a first lens group G1, a second lens group G2, and a third lens group G3 that has a refractive power, in which spacings that change during focusing are provided as boundaries between the lens groups. In such a case, there is an advantage in suppressing fluctuations in aberration by performing focusing by changing a spacing between adjacent groups for three groups having different degrees of separation between the on-axis luminous flux and the off-axis luminous flux.

The optical system of the present disclosure may be configured to consist of, in order from the object side to the image side, a first lens group G1 that has a refractive power, a second lens group G2 that has a positive refractive power, and a third lens group G3 that has a refractive power. In this case, during focusing, the first lens group G1 and the third lens group G3 may be configured not to move with respect to the image plane Sim, and the second lens group G2 may be configured to move along the optical axis Z. In such a case, the first lens group G1 is advantageous in correcting distortion, the second lens group G2 is advantageous in correcting spherical aberration, and the third lens group G3 is advantageous in correcting field curvature. In addition, during focusing, the first lens group G1 is fixed, which is advantageous for a dust-proof and drip-proof structure. During focusing, the third lens group G3 is fixed and the second lens group G2 is moved. As a result, the second lens group G2 is relatively moved with respect to the third lens group G3, so that it is possible to effectively correct fluctuations in field curvature during focusing.

In the present specification, among the groups that move during focusing, a group closest to the object side will be referred to as a first focusing group. In a case where the optical system has only one group that moves during focusing, the group is the first focusing group. In the example of FIG. 1, the second lens group G2 corresponds to the first focusing group.

In the optical system of the present disclosure, a lens surface of the first focusing group closest to the object side may be configured to have a convex shape. In such a case, there is an advantage in suppressing fluctuations in spherical aberration during focusing.

In the optical system of the present disclosure, the first focusing group may be configured to include five or more lenses. In such a case, there is an advantage in suppressing fluctuations in various aberrations during focusing.

In the optical system of the present disclosure, a lens closest to the image side in the first focusing group may be configured as a positive lens convex toward the image side. In such a case, there is an advantage in suppressing fluctuations in spherical aberration during focusing.

In the optical system of the present disclosure, it is preferable that at least one first aspherical lens having at least one surface whose absolute value of a curvature at a position of a maximum effective diameter is greater than an absolute value of a paraxial curvature is disposed closer to the object side than the aperture stop St. In such a case, there is an advantage in suppressing lateral chromatic aberration and distortion. In the example of FIG. 1, the lens L11 corresponds to the first aspherical lens.

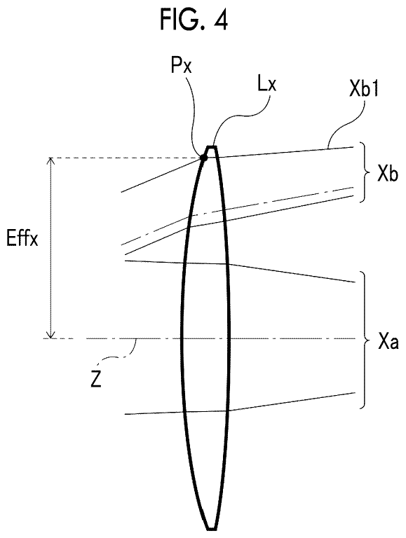

FIG. 4 shows an example of the “position of the maximum effective diameter”. In FIG. 4, a left side is the object side, and a right side is the image side. FIG. 4 shows an on-axis luminous flux Xa and an off-axis luminous flux Xb passing through a lens Lx. In the example in FIG. 4, a ray Xb1 that is a ray on an upper side of the off-axis luminous flux Xb is a ray passing through an outermost side. The term “outer side” means an outer side in a diameter direction centered on the optical axis Z, that is, a side away from the optical axis Z. In the present specification, a position of an intersection between the ray passing through the outermost side and a lens surface is a position Px of the maximum effective diameter. In addition, a distance from the position Px of the maximum effective diameter to the optical axis Z is an effective radius Effx of the lens surface. FIG. 4 is a diagram for description. In the example of FIG. 4, the upper ray of the off-axis luminous flux Xb is the ray passing through the outermost side, but which ray is the ray passing through the outermost side varies depending on the case.

In the optical system of the present disclosure, it is preferable that at least one second aspherical lens in which a refractive power at a position of a maximum effective diameter is shifted in a negative direction with respect to a refractive power in a paraxial region is disposed closer to the image side than the aperture stop St. In such a case, there is an advantage in suppressing lateral chromatic aberration and astigmatism. In the example of FIG. 1, the lens L24 corresponds to the second aspherical lens.

The “refractive power in a paraxial region” and “refractive power at a position of a maximum effective diameter” used in the definition of the second aspherical lens are not a refractive power of a surface but a refractive power of a lens. In a case where an object side surface and an image side surface of the lens have different maximum effective diameters, the “maximum effective diameter” related to the second aspherical lens is a maximum effective diameter of a surface having a smaller maximum effective diameter. In addition, the above-described expression “a refractive power at a position of a maximum effective diameter is shifted in a negative direction with respect to a refractive power in a paraxial region” has the following meanings based on a sign of the refractive power. In a case where the lens has a negative refractive power in both of the paraxial region and the position of the maximum effective diameter, the expression means that the negative refractive power is stronger at the position of the maximum effective diameter than that in the paraxial region. In a case where the lens has a positive refractive power in both of the paraxial region and the position of the maximum effective diameter, the expression means that the positive refractive power is weaker at the position of the maximum effective diameter than that in the paraxial region. In a case where the lens has refractive powers of different signs between the paraxial region and the position of the maximum effective diameter, the expression means that the refractive power is positive in the paraxial region, and the refractive power is negative at the position of the maximum effective diameter.

Next, a preferred configuration of the optical system of the present disclosure related to the conditional expressions will be described. In the following description of the conditional expressions, in order to avoid redundancy, the same symbol will be used for the same definition, and the duplicate description of the symbol will be omitted. In addition, hereinafter, the expression “optical system of the present disclosure” will be simply referred to as the “optical system” in order to avoid redundancy.

The optical system preferably satisfies Conditional Expression (1). Here, a sum of a distance on the optical axis from a lens surface of the optical system closest to the object side to a lens surface of the optical system closest to the image side in a state where the infinite distance object is in focus and a back focal length of the optical system at an air conversion distance is denoted by TL. A focal length of the optical system in the state where the infinite distance object is in focus is denoted by f A maximum half angle of view in a state where the infinite distance object is in focus is denoted by ωm. A symbol Y is defined as Y=f×tan ωm. Here, tan indicates a tangent. By not allowing the corresponding value of Conditional Expression (1) to be equal to or less than the lower limit thereof, there is an advantage in correcting various aberrations. By not allowing the corresponding value of Conditional Expression (1) to be equal to or greater than the upper limit thereof, there is an advantage in achieving reduction in size of the optical system while ensuring a large image circle. In order to obtain more favorable characteristics, the optical system more preferably satisfies Conditional Expression (1-1), still more preferably satisfies Conditional Expression (1-2), and still more preferably satisfies Conditional Expression (1-3).

$$1 < TL / Y < 6.5 \qquad ( 1 )$$

$$1.5 < TL / Y < 5.7 \qquad ( 1 - 1 )$$

$$2 < TL / Y < 5.2 \qquad ( 1 - 2 )$$

$$3 < TL / Y < 4.8 \qquad ( 1 - 3 )$$

The optical system preferably satisfies Conditional Expression (2). Here, the back focal length of the optical system at the air conversion distance in a state where the infinite distance object is in focus is denoted by Bf. In the present specification, the expression “back focal length of the optical system at the air conversion distance” refers to an air conversion distance on the optical axis from a lens surface of the optical system closest to the image side to the image plane Sim. By not allowing the corresponding value of Conditional Expression (2) to be equal to or less than the lower limit thereof, there is an advantage in ensuring the amount of peripheral light. By not allowing the corresponding value of Conditional Expression (2) to be equal to or greater than the upper limit thereof, there is an advantage in achieving reduction in size. In order to obtain more favorable characteristics, the optical system more preferably satisfies Conditional Expression (2-1), still more preferably satisfies Conditional Expression (2-2), and still more preferably satisfies Conditional Expression (2-3).

$$0.5 < Bf / f < 3 \qquad ( 2 )$$

$$0.53 < Bf / f < 2.5 \qquad ( 2 - 1 )$$

$$0.57 < Bf / f < 2 \qquad ( 2 - 2 )$$

$$0.6 < Bf / f < 1.7 \qquad ( 2 - 3 )$$

In a case where the optical system includes the above-mentioned first cemented lens, it is preferable that the optical system satisfies Conditional Expression (3). Here, an average value of Abbe numbers of all negative lenses included in the first cemented lens based on the d line is denoted by vnc1. An average value of Abbe numbers of all positive lenses included in the first cemented lens based on the d line is denoted by vpc1. By not allowing the corresponding value of Conditional Expression (3) to be equal to or less than the lower limit thereof, there is an advantage in correcting axial chromatic aberration. By not allowing the corresponding value of Conditional Expression (3) to be equal to or greater than the upper limit thereof, it is possible to suppress overcorrection of the axial chromatic aberration. In order to obtain more favorable characteristics, the optical system more preferably satisfies Conditional Expression (3-1) and still more preferably satisfies Conditional Expression (3-2).

$$16 < vnc 1 - vpc 1 < 75 \qquad ( 3 )$$

$$20 < vnc 1 - vpc 1 < 55 \qquad ( 3 - 1 )$$

$$24 < vnc 1 - vpc 1 < 48 \qquad ( 3 - 2 )$$

In a configuration in which the optical system includes, successively in order from the position closest to the object side to the image side, the first lens group G1, the second lens group G2, and the third lens group G3 that has a refractive power, in which spacings that change during focusing are provided as boundaries between the lens groups, and the third lens group G3 includes at least one positive lens and at least one negative lens, it is preferable that the optical system satisfies Conditional Expression (4). Here, an average value of Abbe numbers of all negative lenses included in the third lens group G3 based on the d line is denoted by vn3. An average value of Abbe numbers of all positive lenses included in the third lens group G3 based on the d line is denoted by vp3. By not allowing the corresponding value of Conditional Expression (4) to be equal to or less than the lower limit thereof, it is possible to suppress overcorrection of the lateral chromatic aberration. By not allowing the corresponding value of Conditional Expression (4) to be equal to or greater than the upper limit thereof, it is possible to suppress undercorrection of the lateral chromatic aberration. In order to obtain more favorable characteristics, the optical system more preferably satisfies Conditional Expression (4-1) and still more preferably satisfies Conditional Expression (4-2).

$$- 20 < vn 3 - vp 3 < 20 \qquad ( 4 )$$

$$- 10 < vn 3 - vp 3 < 19 \qquad ( 4 - 1 )$$

$$- 5 < vn 3 - vp 3 < 18 \qquad ( 4 - 2 )$$

In a case where the optical system includes the above-mentioned third cemented lens, it is preferable that the optical system satisfies Conditional Expression (5). Here, an average value of Abbe numbers of all negative lenses included in the third cemented lens based on the d line is denoted by vnc3. An average value of Abbe numbers of all positive lenses included in the third cemented lens based on the d line is denoted by vpc3. By not allowing the corresponding value of Conditional Expression (5) to be equal to or less than the lower limit thereof, it is possible to suppress overcorrection of the lateral chromatic aberration. By not allowing the corresponding value of Conditional Expression (5) to be equal to or greater than the upper limit thereof, it is possible to suppress undercorrection of the lateral chromatic aberration. In order to obtain more favorable characteristics, the optical system more preferably satisfies Conditional Expression (5-1) and still more preferably satisfies Conditional Expression (5-2).

$$- 80 < vnc 3 - vpc 3 < 20 \qquad ( 5 )$$

$$- 70 < vnc 3 - vpc 3 < 6 \qquad ( 5 - 1 )$$

$$- 60 < vnc 3 - vpc 3 < - 38 \qquad ( 5 - 2 )$$

In a case where a distance on the optical axis from the lens surface of the optical system closest to the object side to a paraxial entrance pupil position Penp in a state where the infinite distance object is in focus is denoted by Enp, it is preferable that the optical system according to one aspect of the present disclosure satisfies Conditional Expression (6). By not allowing the corresponding value of Conditional Expression (6) to be equal to or less than the lower limit thereof, the separation between the on-axis rays and the off-axis rays in the lens on the object side is facilitated, so that there is an advantage in correcting various aberrations caused by the off-axis rays. By not allowing the corresponding value of Conditional Expression (6) to be equal to or greater than the upper limit thereof, there is an advantage in achieving reduction in diameter of the optical element on the object side of the optical system. In order to obtain more favorable characteristics, the optical system more preferably satisfies Conditional Expression (6-1) and still more preferably satisfies Conditional Expression (6-2).

$$0.28 < Enp / Y < 1.2 \qquad ( 6 )$$

$$0.34 < Enp / Y < 0.58 \qquad ( 6 - 1 )$$

$$0.38 < Enp / Y < 0.52 \qquad ( 6 - 2 )$$

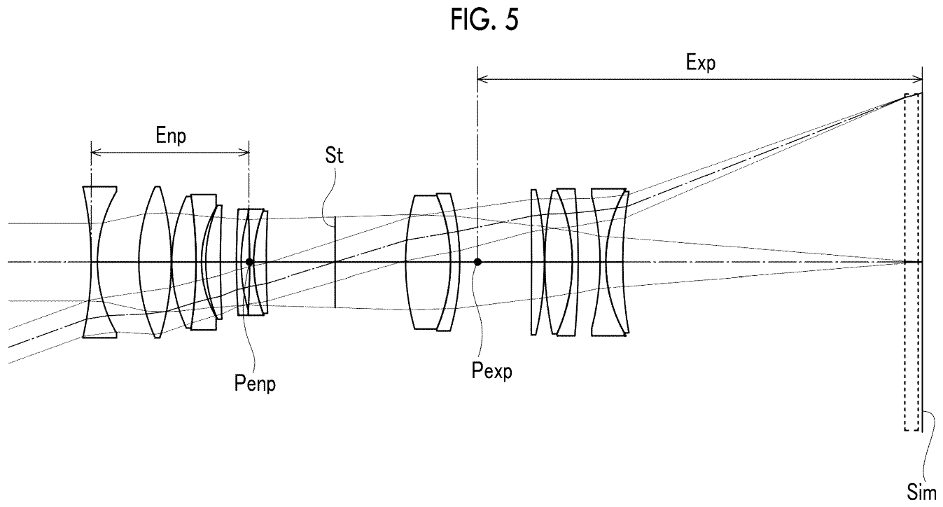

As an example, FIG. 5 shows a paraxial entrance pupil position Penp in an optical system of Example 14 described below and the above-mentioned distance Enp.

It is preferable that the optical system according to another aspect of the present disclosure satisfies Conditional Expression (6-3). By not allowing the corresponding value of Conditional Expression (6-3) to be equal to or less than the lower limit thereof, the separation between the on-axis rays and the off-axis rays in the lens on the object side is facilitated, so that there is an advantage in correcting various aberrations caused by the off-axis rays. By not allowing the corresponding value of Conditional Expression (6-3) to be equal to or greater than the upper limit thereof, there is an advantage in achieving reduction in diameter of the optical element on the object side of the optical system.

$$0.01 < Enp / Y < 0.57 \qquad ( 6 - 3 )$$

It is more preferable that the optical system satisfying Conditional Expression (6-3) also satisfies Conditional Expression (12-1).

In a configuration in which the optical system includes, successively in order from the position closest to the object side to the image side, the first lens group G1 and the second lens group G2, in which a spacing that changes during focusing is provided as a boundary between the lens groups, it is preferable that the optical system satisfies Conditional Expression (7). Here, a negative lens which is second from the object side among the negative lenses included in the first lens group G1 is defined as a second negative lens, and a combined focal length of all optical elements in the first lens group G1 disposed closer to the image side than the second negative lens in a state where the infinite distance object is in focus is denoted by fG1R. By not allowing the corresponding value of Conditional Expression (7) to be equal to or less than the lower limit thereof, it is possible to suppress aberrations occurring in a group consisting of all the optical elements in the first lens group G1 disposed closer to the image side than the second negative lens. By not allowing the corresponding value of Conditional Expression (7) to be equal to or greater than the upper limit thereof, the off-axis rays can be strongly converged, which is advantageous in achieving reduction in size. In order to obtain more favorable characteristics, the optical system more preferably satisfies Conditional Expression (7-1) and still more preferably satisfies Conditional Expression (7-2).

$$0.45 < fG 1 R / f < 3.5 \qquad ( 7 )$$

$$1 < fG 1 R / f < 3.2 \qquad ( 7 - 1 )$$

$$1.5 < fG 1 R / f < 2.8 \qquad ( 7 - 2 )$$

The optical system preferably satisfies Conditional Expression (8). By not allowing the corresponding value of Conditional Expression (8) to be equal to or less than the lower limit thereof, there is an advantage in ensuring the amount of peripheral light. By not allowing the corresponding value of Conditional Expression (8) to be equal to or greater than the upper limit thereof, there is an advantage in reducing the total length of the optical system. In order to obtain more favorable characteristics, the optical system more preferably satisfies Conditional Expression (8-1) and still more preferably satisfies Conditional Expression (8-2).

$$3.6 < {TL}^{2} / ( Y \times f ) < 30 \qquad ( 8 )$$

$$6.5 < {TL}^{2} / ( Y \times f ) < 25 \qquad ( 8 - 1 )$$

$$18 < {TL}^{2} / ( Y \times f ) < 22 \qquad ( 8 - 2 )$$

In a case where a distance on the optical axis from a paraxial exit pupil position Pexp to the image plane Sim in a state where the infinite distance object is in focus is denoted by Exp, it is preferable that the optical system satisfies Conditional Expression (9). In addition, in a case where an optical member having no refractive power is disposed between the image plane Sim and the paraxial exit pupil position Pexp, Exp is calculated using an air conversion distance for the optical member. For example, the optical member PP in the example in FIG. 1 is an optical member that is disposed between the image plane Sim and the paraxial exit pupil position Pexp and that does not have a refractive power. By not allowing the corresponding value of Conditional Expression (9) to be equal to or less than the lower limit thereof, there is an advantage in ensuring the amount of peripheral light. By not allowing the corresponding value of Conditional Expression (9) to be equal to or greater than the upper limit thereof, there is an advantage in reducing the total length of the optical system. In order to obtain more favorable characteristics, the optical system more preferably satisfies Conditional Expression (9-1) and still more preferably satisfies Conditional Expression (9-2).

$$1.2 < Exp / Y < 3.8 \qquad ( 9 )$$

$$1.5 < Exp / Y < 3.5 \qquad ( 9 - 1 )$$

$$1.9 < Exp / Y < 3.1 \qquad ( 9 - 2 )$$

As an example, FIG. 5 shows a paraxial entrance pupil position Penp in an optical system of Example 14 described below. In FIG. 5, an optical member having no refractive power between the paraxial exit pupil position Pexp and the optical member is virtually indicated by a dotted line, and the above-mentioned distance Exp is conceptually shown.

The optical system preferably satisfies Conditional Expression (10). By not allowing the corresponding value of Conditional Expression (10) to be equal to or less than the lower limit thereof, there is an advantage in reducing the total length of the optical system. By not allowing the corresponding value of Conditional Expression (10) to be equal to or greater than the upper limit thereof, there is an advantage in ensuring the amount of peripheral light. In order to obtain more favorable characteristics, the optical system more preferably satisfies Conditional Expression (10-1) and still more preferably satisfies Conditional Expression (10-2).

$$0.3 < Y / Bf < 1.2 \qquad ( 10 )$$

$$0.35 < Y / Bf < 1 \qquad ( 10 - 1 )$$

$$0.44 < Y / Bf < 0. 91 \qquad ( 10 - 2 )$$

The optical system preferably satisfies Conditional Expression (11). By not allowing the corresponding value of Conditional Expression (11) to be equal to or less than the lower limit thereof, the separation between the on-axis rays and the off-axis rays in the lens on the object side is facilitated, so that there is an advantage in correcting various aberrations caused by the off-axis rays. By not allowing the corresponding value of Conditional Expression (11) to be equal to or greater than the upper limit thereof, there is an advantage in achieving reduction in diameter of the optical element on the object side of the optical system. In order to obtain more favorable characteristics, it is more preferable that the optical system satisfies any of Conditional Expressions (11-1), (11-2), (11-3), and (11-4).

$$0.01 < Enp / f < 0.8 \qquad ( 11 )$$

$$0.01 < Enp / f < 0.2 \qquad ( 11 - 1 )$$

$$0.01 < Enp / f < 0.26 \qquad ( 11 - 2 )$$

$$0.05 < Enp / f < 0.4 \qquad ( 11 - 3 )$$

$$0.12 < E n p / f < 0.2 \qquad ( 11 - 4 )$$

The optical system preferably satisfies Conditional Expression (12). By not allowing the corresponding value of Conditional Expression (12) to be equal to or less than the lower limit thereof, it is possible to reduce the space in which the lenses are disposed, which is advantageous in achieving reduction in weight. By not allowing the corresponding value of Conditional Expression (12) to be equal to or greater than the upper limit thereof, it is possible to ensure the space in which the lenses are disposed, which is advantageous in correcting various aberrations. In order to obtain more favorable characteristics, it is more preferable that the optical system satisfies any of Conditional Expressions (12-1), (12-2), and (12-3).

$$0.2 < Bf / TL < 10 \qquad ( 12 )$$

$$0.5 < Bf / TL < 10 \qquad ( 12 - 1 )$$

$$0.24 < Bf / TL < 1 \qquad ( 12 - 2 )$$

$$0.28 < Bf / TL < 0.65 \qquad ( 12 - 3 )$$

It is more preferable that the optical system satisfying Conditional Expression (12-1) also satisfies Conditional Expression (11-2).

In a case where a lateral magnification of the optical system in a state where the nearest object is in focus is denoted by B, it is preferable that the optical system satisfies Conditional Expression (13). By not allowing the corresponding value of Conditional Expression (13) to be equal to or less than the lower limit thereof, it is possible to capture an image of a subject in an enlarged manner. By not allowing the corresponding value of Conditional Expression (13) to be equal to or greater than the upper limit thereof, it is possible to shorten a space for moving the lens during focusing, which is advantageous in achieving reduction in size. In order to obtain more favorable characteristics, the optical system more preferably satisfies Conditional Expression (13-1) and still more preferably satisfies Conditional Expression (13-2).

$$0.2 < \vert B \vert < 1.2 \qquad ( 13 )$$

$$0.3 < \vert B \vert < 1.05 \qquad ( 13 - 1 )$$

$$0.4 < \vert B \vert < 0.7 \qquad ( 13 - 2 )$$

In a case where a maximum radius of the opening of the aperture stop St is denoted by Hstp, it is preferable that the optical system satisfies Conditional Expression (14). By not allowing the corresponding value of Conditional Expression (14) to be equal to or less than the lower limit thereof, there is an advantage in achieving reduction in F number. By not allowing the corresponding value of Conditional Expression (14) to be equal to or greater than the upper limit thereof, there is an advantage in achieving reduction in diameter of the optical system. In order to obtain more favorable characteristics, the optical system more preferably satisfies Conditional Expression (14-1) and still more preferably satisfies Conditional Expression (14-2).

$$0.03 < Hstp / f < 0.4 \qquad ( 14 )$$

$$0.05 < Hstp / f < 0.32 \qquad ( 14 - 1 )$$

$$0.07 < Hstp / f < 0.28 \qquad ( 14 - 2 )$$

The opening of the aperture stop St is generally circular or polygonal close to a circle. In a case where the opening is circular, the expression “maximum radius of the opening of the aperture stop St” refers to a radius of the circular opening in a state where the opening is maximized. In a case where the opening is polygonal, the expression “maximum radius of the opening of the aperture stop St” refers to a circumscribed circle of the polygonal opening in a state where the opening is maximized.

It is preferable that the optical system satisfies Conditional Expression (15). Here, a lateral magnification of the first focusing group in a state where the infinite distance object is in focus is denoted by βFF. A combined lateral magnification of all lenses closer to the image side than the first focusing group in a state where the infinite distance object is in focus is denoted by βR. In a case where there is no lens on the image side with respect to the first focusing group, βR=1. By not allowing the corresponding value of Conditional Expression (15) to be equal to or less than the lower limit thereof, it is possible to suppress the amount of movement of the first focusing group during focusing, which is advantageous in achieving reduction in size. By not allowing the corresponding value of Conditional Expression (15) to be equal to or greater than the upper limit thereof, there is an advantage in suppressing fluctuations in aberration during focusing. In order to obtain more favorable characteristics, the optical system more preferably satisfies Conditional Expression (15-1) and still more preferably satisfies Conditional Expression (15-2).

$$0.3 < \vert ( 1 - β {FF}^{2} ) \times β {R}^{2} \vert < 4 \qquad ( 15 )$$

$$0.6 < \vert ( 1 - β {FF}^{2} ) \times β {R}^{2} \vert < 3.5 \qquad ( 15 - 1 )$$

$$1.6 < \vert ( 1 - β {FF}^{2} ) \times β {R}^{2} \vert < 2.9 \qquad ( 15 - 2 )$$

It is preferable that the optical system satisfies Conditional Expression (16). Here, a paraxial curvature radius of an image side surface of the lens closest to the object side is denoted by R1r. A paraxial curvature radius of an object side surface of a lens which is second from the object side is denoted by R2f By not allowing the corresponding value of Conditional Expression (16) to be equal to or less than the lower limit thereof, there is an advantage in suppressing distortion. By not allowing the corresponding value of Conditional Expression (16) to be equal to or greater than the upper limit thereof, there is an advantage in suppressing astigmatism. In order to obtain more favorable characteristics, the optical system more preferably satisfies Conditional Expression (16-1) and still more preferably satisfies Conditional Expression (16-2).

$$- 1.5 < ( R 1 r - R 2 f ) / ( R 1 r + R 2 f ) < 1.5 \qquad ( 16 )$$

$$- 1 < ( R 1 r - R 2 f ) / ( R 1 r + R 2 f ) < 1 \qquad ( 16 - 1 )$$

$$- 0.6 < ( R 1 r - R 2 f ) / ( R 1 r + R 2 f ) < 0.6 \qquad ( 16 - 2 )$$

It is preferable that the optical system satisfies Conditional Expression (17). Here, a paraxial curvature radius of an object side surface of a lens which is third from the object side is denoted by R3f A paraxial curvature radius of an image side surface of a lens which is third from the object side is denoted by R3r. By not allowing the corresponding value of Conditional Expression (17) to be equal to or less than the lower limit thereof, there is an advantage in suppressing astigmatism. By not allowing the corresponding value of Conditional Expression (17) to be equal to or greater than the upper limit thereof, there is an advantage in suppressing distortion. In order to obtain more favorable characteristics, the optical system more preferably satisfies Conditional Expression (17-1) and still more preferably satisfies Conditional Expression (17-2).

$$- 1 < ( R 3 f + R 3 r ) / ( R 3 f - R 3 r ) < 2.5 \qquad ( 17 )$$

$$0 < ( R 3 f + R 3 r ) / ( R 3 f - R 3 r ) < 2 \qquad ( 17 - 1 )$$

$$0.8 < ( R 3 f + R 3 r ) / ( R 3 f - R 3 r ) < 1.6 \qquad ( 17 - 2 )$$

It is preferable that the optical system satisfies Conditional Expression (18). Here, a spacing on the optical axis between the lens closest to the object side and the lens which is second from the object side is denoted by d12. Then, a symbol h1 is defined as h1=Enp×tan ωm. As an example, FIG. 2 shows the above-described spacing d12. By not allowing the corresponding value of Conditional Expression (18) to be equal to or less than the lower limit thereof, it is possible to sufficiently ensure the spacing between the lens closest to the object side and the lens which is second from the object side, which is advantageous in suppressing ghosts. By not allowing the corresponding value of Conditional Expression (18) to be equal to or greater than the upper limit thereof, there is an advantage in achieving reduction in size. In order to obtain more favorable characteristics, the optical system more preferably satisfies Conditional Expression (18-1) and still more preferably satisfies Conditional Expression (18-2).

$$0.05 < d 12 / h 1 - ( 1 / R 1 r - 1 / R 2 f ) \times h 1 < 0.7 \qquad ( 18 )$$

$$0.1 < d 12 / h 1 - ( 1 / R 1 r - 1 / R 2 f ) \times h 1 < 0.5 \qquad ( 18 - 1 )$$

$$0.15 < d 12 / h 1 - ( 1 / R 1 r - 1 / R 2 f ) \times h 1 < 0.3 \qquad ( 18 - 2 )$$

In a case where a refractive index of a first aspherical lens closest to the object side among the first aspherical lenses included in the optical system at the d line is denoted by Noa, it is preferable that the optical system satisfies Conditional Expression (19). By not allowing the corresponding value of Conditional Expression (19) to be equal to or less than the lower limit thereof, it is possible to increase the effect of correcting the aspherical surface, which is advantageous in suppressing distortion. By not allowing the corresponding value of Conditional Expression (19) to be equal to or greater than the upper limit thereof, there is an advantage in suppressing aberration fluctuation caused by the shape error. In order to obtain more favorable characteristics, the optical system more preferably satisfies Conditional Expression (19-1) and still more preferably satisfies Conditional Expression (19-2).

$$1.45 < Noa < 1.7 \qquad ( 19 )$$

$$1.5 < Noa < 1.68 \qquad ( 19 - 1 )$$

$$1.55 < Noa < 1.63 \qquad ( 19 - 2 )$$

In a case where an Abbe number of a first aspherical lens closest to the object side among the first aspherical lenses included in the optical system based on the d line is denoted by voa, it is preferable that the optical system satisfies Conditional Expression (20). By not allowing the corresponding value of Conditional Expression (20) to be equal to or less than the lower limit thereof, there is an advantage in suppressing lateral chromatic aberration. By not allowing the corresponding value of Conditional Expression (20) to be equal to or greater than the upper limit thereof, it is possible to avoid excessive correction of the lateral chromatic aberration. In order to obtain more favorable characteristics, the optical system more preferably satisfies Conditional Expression (20-1) and still more preferably satisfies Conditional Expression (20-2).

$$45 < voa < 85 \qquad ( 20 )$$

$$50 < voa < 74 \qquad ( 20 - 1 )$$

$$55 < voa < 60 \qquad ( 20 - 2 )$$

In a case where a refractive index of an aspherical lens closest to the image side among the aspherical lenses disposed closer to the image side than the aperture stop St at the d line is denoted by Nia, it is preferable that the optical system satisfies Conditional Expression (21). By not allowing the corresponding value of Conditional Expression (21) to be equal to or less than the lower limit thereof, it is possible to increase the effect of correcting the aspherical surface, which is advantageous in suppressing astigmatism. By not allowing the corresponding value of Conditional Expression (21) to be equal to or greater than the upper limit thereof, there is an advantage in suppressing aberration fluctuation caused by the shape error. In order to obtain more favorable characteristics, the optical system more preferably satisfies Conditional Expression (21-1) and still more preferably satisfies Conditional Expression (21-2).

$$1.45 < Nia < 2 \qquad ( 21 )$$

$$1.55 < Nia < 1.9 \qquad ( 21 - 1 )$$

$$1.68 < Nia < 1.85 \qquad ( 21 - 2 )$$

In a case where an Abbe number of the aspherical lens closest to the image side among the aspherical lenses disposed closer to the image side than the aperture stop St based on the d line is denoted by via, it is preferable that the optical system satisfies Conditional Expression (22). By not allowing the corresponding value of Conditional Expression (22) to be equal to or less than the lower limit thereof, there is an advantage in suppressing lateral chromatic aberration. By not allowing the corresponding value of Conditional Expression (22) to be equal to or greater than the upper limit thereof, it is possible to avoid excessive correction of the lateral chromatic aberration. In order to obtain more favorable characteristics, the optical system more preferably satisfies Conditional Expression (22-1) and still more preferably satisfies Conditional Expression (22-2).

$$38 < via < 100 \qquad ( 22 )$$

$$50 < via < 90 \qquad ( 22 - 1 )$$

$$70 < via < 80 \qquad ( 22 - 2 )$$

It is preferable that the optical system satisfies Conditional Expression (23). Here, an effective radius of an image side surface of a lens closest to the image side in the first focusing group is denoted by hLfi. A paraxial curvature radius of the image side surface of the lens closest to the image side in the first focusing group is denoted by RLfi. A thickness on the optical axis of the lens closest to the image side in the first focusing group is denoted by DLfi. As an example, FIG. 2 shows the thickness DLfi. By not allowing the corresponding value of Conditional Expression (23) to be equal to or less than the lower limit thereof, it is possible to suppress the volume of the lens, which is advantageous in achieving reduction in weight of the first focusing group. By not allowing the corresponding value of Conditional Expression (23) to be equal to or greater than the upper limit thereof, there is an advantage in suppressing fluctuation in spherical aberration during focusing. In order to obtain more favorable characteristics, the optical system more preferably satisfies Conditional Expression (23-1) and still more preferably satisfies Conditional Expression (23-2).

$$0.3 < hLfi \times ( 1 / RLfi + 1 / DLfi ) < 5 \qquad ( 23 )$$

$$0.5 < hLfi \times ( 1 / RLfi + 1 / DLfi ) < 3.9 \qquad ( 23 - 1 )$$

$$0.72 < hLfi \times ( 1 / RLfi + 1 / DLfi ) < 2.2 \qquad ( 23 - 2 )$$

It is preferable that the optical system includes at least one concave surface that is concave toward the image side and that is in contact with air. Among the concave surfaces in contact with air, which is included in the optical system and is concave toward the image side, a concave surface closest to the image side will be referred to as an image side concave surface. In the example of FIG. 1, an image side surface of the lens L32 corresponds to the image side concave surface. With regard to the image side concave surface, it is preferable that the optical system satisfies Conditional Expression (24). Here, a paraxial curvature radius of the image side concave surface is denoted by Rne. A combined focal length of all optical elements in the optical system disposed closer to the image side than the image side concave surface is denoted by fe. In a case where there is no optical element on the image side with respect to the image side concave surface, it is assumed that fe takes an infinite value. By not allowing the corresponding value of Conditional Expression (24) to be equal to or less than the lower limit thereof, there is an advantage in correcting astigmatism. By not allowing the corresponding value of Conditional Expression (24) to be equal to or greater than the upper limit thereof, it is possible to suppress the focusing of ghost light that is reflected by the imaging surface of the imaging element disposed on the image plane Sim, is reflected by the image side concave surface, and returns to the imaging surface, among light beams traveling from the optical system toward the image plane Sim. In order to obtain more favorable characteristics, the optical system more preferably satisfies Conditional Expression (24-1) and still more preferably satisfies Conditional Expression (24-2).

$$- 8 < Rne \times ( 1 / fe - 1 / Bf ) < - 0.1 \qquad ( 24 )$$

$$- 7 < Rne \times ( 1 / fe - 1 / Bf ) < - 0.3 \qquad ( 24 - 1 )$$

$$- 5.7 < Rne \times ( 1 / fe - 1 / Bf ) < - 1 \qquad ( 24 - 2 )$$

In a configuration in which the optical system includes, successively in order from the position closest to the object side to the image side, the first lens group G1 and the second lens group G2, in which a spacing that changes during focusing is provided as a boundary between the lens groups, it is preferable that the optical system satisfies Conditional Expression (25). Here, a focal length of the first lens group G1 is denoted by f1. By not allowing the corresponding value of Conditional Expression (25) to be equal to or less than the lower limit thereof, it is possible to suppress divergence of rays in the first lens group G1, which is advantageous in achieving reduction in size of the lens on the image side. By not allowing the corresponding value of Conditional Expression (25) to be equal to or greater than the upper limit thereof, there is an advantage in achieving a wide angle. In order to obtain more favorable characteristics, the optical system more preferably satisfies Conditional Expression (25-1) and still more preferably satisfies Conditional Expression (25-2).

$$- 2 < f / f 1 < 3 \qquad ( 25 )$$

$$- 1.5 < f / f 1 < 2.5 \qquad ( 25 - 1 )$$

$$- 0.85 < f / f 1 < 1.8 \qquad ( 25 - 2 )$$

In a configuration in which the optical system includes, successively in order from the position closest to the object side to the image side, the first lens group G1 and the second lens group G2, in which a spacing that changes during focusing is provided as a boundary between the lens groups, it is preferable that the optical system satisfies Conditional Expression (26). Here, a focal length of the second lens group G2 is denoted by f2. By not allowing the corresponding value of Conditional Expression (26) to be equal to or less than the lower limit thereof, there is an advantage in achieving reduction in size. By not allowing the corresponding value of Conditional Expression (26) to be equal to or greater than the upper limit thereof, there is an advantage in suppressing fluctuation in spherical aberration caused by the occurrence of the eccentricity error. In order to obtain more favorable characteristics, the optical system more preferably satisfies Conditional Expression (26-1) and still more preferably satisfies Conditional Expression (26-2).

$$- 2.5 < f / f 2 < 2 \qquad ( 26 )$$

$$- 2 < f / f 2 < 1.5 \qquad ( 26 - 1 )$$

$$- 1.6 < f / f 2 < 1.3 \qquad ( 26 - 2 )$$

In a configuration in which the optical system includes, successively in order from the position closest to the object side to the image side, the first lens group G1, the second lens group G2, and the third lens group G3, in which spacings that change during focusing are provided as a boundary between the lens groups, it is preferable that the optical system satisfies Conditional Expression (27). Here, a focal length of the third lens group G3 is denoted by f3. By not allowing the corresponding value of Conditional Expression (27) to be equal to or less than the lower limit thereof, there is an advantage in achieving reduction in size. By not allowing the corresponding value of Conditional Expression (27) to be equal to or greater than the upper limit thereof, there is an advantage in suppressing astigmatism. In order to obtain more favorable characteristics, the optical system more preferably satisfies Conditional Expression (27-1) and still more preferably satisfies Conditional Expression (27-2).

$$- 0.35 < f / f 3 < 1.8 \qquad ( 27 )$$

$$- 0.1 \; 5 < f / f 3 < 1.6 \qquad ( 27 - 1 )$$

$$- 0. 7 < f / f 3 < 1.49 \qquad ( 27 - 2 )$$

In a configuration in which the optical system includes, successively in order from the position closest to the object side to the image side, the first lens group G1 and the second lens group G2, in which a spacing that changes during focusing is provided as a boundary between the lens groups, it is preferable that the optical system satisfies Conditional Expression (29). By not allowing the corresponding value of Conditional Expression (29) to be equal to or less than the lower limit thereof, it is possible to suppress divergence of rays in the first lens group G1, which is advantageous in achieving reduction in size of the lens on the image side. By not allowing the corresponding value of Conditional Expression (29) to be equal to or greater than the upper limit thereof, there is an advantage in achieving reduction in size. In order to obtain more favorable characteristics, the optical system more preferably satisfies Conditional Expression (29-1) and still more preferably satisfies Conditional Expression (29-2).

$$- 7 < f 2 / f 1 < 0.5 \qquad ( 29 )$$

$$- 5 < f 2 / f 1 < 0.2 \qquad ( 29 - 1 )$$

$$- 3.2 < f 2 / f 1 < 0.05 \qquad ( 29 - 2 )$$

In a configuration in which the optical system includes, successively in order from the position closest to the object side to the image side, the first lens group G1, the second lens group G2, and the third lens group G3, in which spacings that change during focusing are provided as a boundary between the lens groups, it is preferable that the optical system satisfies Conditional Expression (30). Here, a focal length of the second lens group G2 is denoted by f2. By not allowing the corresponding value of Conditional Expression (30) to be equal to or less than the lower limit thereof, there is an advantage in suppressing fluctuation in spherical aberration caused by the occurrence of the eccentricity error. By not allowing the corresponding value of Conditional Expression (30) to be equal to or greater than the upper limit thereof, there is an advantage in suppressing astigmatism. In order to obtain more favorable characteristics, the optical system more preferably satisfies Conditional Expression (30-1) and still more preferably satisfies Conditional Expression (30-2).

$$- 2.5 < f 2 / f 3 < 1.5 \qquad ( 30 )$$

$$- 1.5 < f 2 / f 3 < 1.2 \qquad ( 30 - 1 )$$

$$- 1 < f 2 / f 3 < 0.9 \qquad ( 30 - 2 )$$

In a case where a combined focal length of all optical elements in the optical system disposed closer to the image side than the aperture stop St is denoted by fsR, it is preferable that the optical system satisfies Conditional Expression (31). By not allowing the corresponding value of Conditional Expression (30) to be equal to or less than the lower limit thereof, there is an advantage in achieving reduction in F number while maintaining the reduction in size. By not allowing the corresponding value of Conditional Expression (31) to be equal to or greater than the upper limit thereof, there is an advantage in suppressing spherical aberration. In order to obtain more favorable characteristics, the optical system more preferably satisfies Conditional Expression (31-1) and still more preferably satisfies Conditional Expression (31-2).

$$- 0.2 < Y / fsR < 1.1 \qquad ( 31 )$$

$$- 0.1 < Y / fsR < 0.9 \qquad ( 31 - 1 )$$

$$- 0. 6 < Y / fsR < 0.73 \qquad ( 31 - 2 )$$

The example shown in FIG. 1 is merely an example, and various modifications can be made without departing from the gist of the technology of the present disclosure. For example, the number of lens groups included in the optical system, the number of lenses included in each lens group, the number of focusing groups included in the optical system, and the number of lenses included in the focusing group may be different from the numbers in the example in FIG. 1. In addition, configurations of lenses included in each lens group may be different from the configurations in the example in FIG. 1.

For example, the optical system of the present disclosure may be configured to include, successively in order from a position closest to the object side to the image side, a first lens group, a second lens group, a third lens group, and a fourth lens group, in which spacings that change during focusing are provided as boundaries between the lens groups. In such a case, there is an advantage in suppressing fluctuations in aberration by performing focusing by changing a spacing between adjacent groups for at least four groups having different degrees of separation between the on-axis luminous flux and the off-axis luminous flux.

In a configuration in which the optical system includes, successively in order from the position closest to the object side to the image side, the first lens group, the second lens group, the third lens group, and the fourth lens group, in which spacings that change during focusing are provided as a boundary between the lens groups, it is preferable that the optical system satisfies Conditional Expression (28). Here, a focal length of the fourth lens group is denoted by f4. By not allowing the corresponding value of Conditional Expression (28) to be equal to or less than the lower limit thereof, there is an advantage in achieving reduction in size. By not allowing the corresponding value of Conditional Expression (28) to be equal to or greater than the upper limit thereof, there is an advantage in suppressing distortion. In order to obtain more favorable characteristics, the optical system more preferably satisfies Conditional Expression (28-1) and still more preferably satisfies Conditional Expression (28-2).

$$0.6 < f / f 4 < 1.6 \qquad ( 28 )$$

$$0.8 < f / f 4 < 1.4 \qquad ( 28 - 1 )$$

$$0.95 < f / f 4 < 1.2 \qquad ( 28 - 2 )$$

The optical system of the present disclosure may be configured to include, successively in order from a position closest to the object side to the image side, a first lens group, a second lens group, a third lens group, a fourth lens group, and a fifth lens group, in which spacings that change during focusing are provided as boundaries between the lens groups. In such a case, there is an advantage in suppressing fluctuations in aberration by performing focusing by changing a spacing between adjacent groups for at least five groups having different degrees of separation between the on-axis luminous flux and the off-axis luminous flux.

The optical system of the present disclosure may be configured to consist of, in order from the object side to the image side, a first lens group and a second lens group, in which a spacing that changes during focusing is provided as boundaries between the lens groups. In such a case, there is an advantage in suppressing fluctuations in aberration by performing focusing by changing a mutual spacing between two groups having different degrees of separation between the on-axis luminous flux and the off-axis luminous flux. In addition, in such a case, there is an advantage in achieving reduction in size.

The optical system of the present disclosure may be configured so that a negative meniscus lens, a negative meniscus lens, and a negative lens are disposed successively in order from the position closest to the object side to the image side. In such a case, there is an advantage in achieving a wide angle while suppressing occurrence of various off-axis aberrations. In addition, the optical system of the present disclosure may be configured so that a plano-concave lens whose image side surface is concave, a negative meniscus lens, and a negative lens are disposed successively in order from the position closest to the object side to the image side. In such a case as well, there is an advantage in achieving a wide angle while suppressing occurrence of various off-axis aberrations.

The optical system of the present disclosure may be configured so that at least one cemented lens is included, in which a cemented lens closest to the image side among the cemented lenses included in the optical system has a cemented surface convex toward the object side. In such a case, there is an advantage in suppressing a difference in astigmatism for each color.

The optical system of the present disclosure may be configured so that a cemented lens is disposed closest to the image side, and the cemented lens disposed closest to the image side has a cemented surface convex toward the object side. In such a case, there is an advantage in suppressing a difference in astigmatism for each color.

The optical system of the present disclosure may be configured so that a negative lens and a positive lens are disposed successively in order from the position closest to the image side to the object side. In such a case, there is an advantage in suppressing lateral chromatic aberration while maintaining the reduction in size.

The optical system of the present disclosure may be configured so that a negative lens, a negative lens, a positive lens are disposed successively in order from the position closest to the image side to the object side. In such a case, there is an advantage in suppressing lateral chromatic aberration and distortion while maintaining the reduction in size.

The optical system of the present disclosure may be configured so that the aperture stop St is disposed between a lens surface of the first focusing group closest to the object side and a lens surface of the first focusing group closest to the image side. In such a case, there is an advantage in suppressing fluctuations in various aberrations caused by off-axis luminous flux during focusing.

The above-described preferred configurations and available configurations including the configurations related to the conditional expressions can be combined in any manner and are preferably selectively adopted, as appropriate, in accordance with required specifications. The conditional expressions that are preferably satisfied by the optical system of the present disclosure are not limited to the conditional expressions described in expression forms and include all conditional expressions obtained by arbitrarily combining lower limits and upper limits in any manner from among conditional expressions that are designated as preferable, more preferable, still more preferable, and even still more preferable.

As an example, one of the preferred aspects of the present disclosure is an optical system including an aperture stop St that has a variable opening diameter and that determines an F number of the optical system, in which at least one positive lens and at least one negative lens are disposed closer to an object side than the aperture stop St, at least one positive lens and at least one negative lens are disposed closer to an image side than the aperture stop St, an image side surface of at least one negative lens among the negative lenses disposed closer to the object side than the aperture stop St has a concave shape, and Conditional Expression (1) is satisfied.

Next, examples of the optical system of the present disclosure will be described with reference to the accompanying drawings. Reference numerals provided to the lenses in the cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

Since a cross-sectional view of a configuration of an optical system of Example 1 is shown in FIG. 1, and its illustration method and configuration are the same as described above, the duplicate descriptions will be partially omitted. The optical system of Example 1 consists of, in order from the object side to the image side, a first lens group G1 that has a negative refractive power, a second lens group G2 that has a positive refractive power, and a third lens group G3 that has a negative refractive power. During focusing from the infinite distance object to the nearest object, the first lens group G1 and the third lens group G3 do not move with respect to the image plane Sim, and the second lens group G2 moves toward the object side.

For the optical system of Example 1, basic lens data is shown in Table 1, specifications and variable surface spacings are shown in Table 2, and aspherical coefficients are shown in Table 3.

The table of the basic lens data is described as below. The column of “Sn” indicates surface numbers in a case where the number is increased by one at a time toward the image side from a surface closest to the object side as a first surface. The column of “R” indicates a curvature radius of each surface. The column of “D” indicates a surface spacing on the optical axis between each surface and its adjacent surface on the image side. The column of “Nd” indicates a refractive index of each constituent at the d line. The column of “vd” indicates an Abbe number of each constituent based on the d line. The column of “θgF” indicates a partial dispersion ratio of each constituent between a g line and an F line. The column of “ED” indicates an effective diameter of each surface.

In a case where refractive indexes of a certain lens with respect to the g line, the F line, and a C line are denoted by Ng, NF, and NC, respectively, and a partial dispersion ratio of the lens between the g line and the F line is denoted by θgF, θgF is defined as the following expression.

$$θ gF = ( Ng - NF ) / ( NF - NC )$$

The terms “d line”, “C line”, “F line”, and “g line” described in the present specification mean emission lines, in which a wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

In the table of the basic lens data, a sign of a curvature radius of a surface convex toward the object side is defined as positive, and a sign of a curvature radius of a surface convex toward the image side is defined as negative. The field of the surface number of the surface corresponding to the aperture stop St have the surface number and the word (St). The table of the basic lens data also shows the optical member PP. A value in the lowermost field of the column of D in the table indicates a spacing between a surface closest to the image side in the table and the image plane Sim. A symbol DD[ ] is used for the variable surface spacing during focusing, and a surface number on the object side of the spacing is provided in [ ] in the column of the surface spacing.

Table 2 shows the lateral magnification, the focal length, the open F-number, the maximum full angle of view, and the variable surface spacings based on the d line. In the field of the maximum full angle of view, [°] indicates that the unit is degrees. In Table 2, the column of “infinite distance” shows values in a state where the infinite distance object is in focus, and the column of “nearest” shows values in a state where the nearest object is in focus.

In the basic lens data, a surface number of the aspherical surface is marked with *, and a field of the curvature radius of the aspherical surface shows a numerical value of a paraxial curvature radius. In Table 3, the line of Sn shows the surface number of the aspherical surface, and the lines of KA and Am show a numerical value of the aspherical coefficient for each aspherical surface. In this example, m of Am is an even number greater than or equal to 4 and less than or equal to 20 (m=4, 6, 8, . . . , 20). The “E±n” (n: integer) in numerical values of the aspherical coefficients in Table 3 indicates “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

Here,
Zd: a depth of the aspherical surface (a length of a perpendicular line drawn from a point on the aspherical surface at a height h to a plane that is in contact with an aspherical surface apex and that is perpendicular to the optical axis Z),
h: a height (a distance from the optical axis Z to the lens surface),
C: a reciprocal of the paraxial curvature radius,
KA and Am: aspherical coefficients, and
Σ in the aspheric equation means a sum related to m.

In data of each table, a degree is used as a unit of an angle, and mm (millimeter) is used as a unit of a length, but appropriate different units may be used since the optical system can be used even in a case where the system is enlarged or reduced in proportion. In addition, the numerical values rounded to predetermined digits are described in each table shown below.

TABLE 1
Example 1

| Sn | R | D | Nd | νd | θgF | ED |
|---|---|---|---|---|---|---|
| *1 | ∞ | 4.0681 | 1.58313 | 59.38 | 0.54237 | 48.716 |
| *2 | 41.7586 | 5.0655 | | | | 37.085 |
| 3 | 40.3226 | 1.3002 | 1.77250 | 49.60 | 0.55212 | 34.463 |
| 4 | 19.2309 | 7.1648 | | | | 28.566 |
| 5 | −252.5305 | 1.3051 | 1.49700 | 81.54 | 0.53748 | 28.082 |
| 6 | 23.0910 | 1.6170 | | | | 24.632 |
| 7 | 30.4072 | 9.2718 | 1.67300 | 38.26 | 0.57580 | 24.396 |
| 8 | −18.7327 | 7.0945 | 1.84666 | 23.78 | 0.61923 | 22.735 |
| 9 | −152.7485 | 1.4564 | | | | 19.322 |
| 10 | −39.2540 | 1.0147 | 1.57099 | 50.80 | 0.55887 | 18.868 |
| 11 | 178.4552 | 8.9339 | 2.00069 | 25.46 | 0.61364 | 18.504 |
| 12 | −39.9271 | DD[12] | | | | 17.500 |
| 13(St) | ∞ | 1.4114 | | | | 12.464 |
| 14 | 37.9945 | 12.6424 | 1.80518 | 25.46 | 0.61572 | 13.406 |
| 15 | −183.2825 | 0.4157 | | | | 14.614 |
| 16 | −1200.4315 | 0.7531 | 1.90110 | 27.06 | 0.60718 | 14.728 |
| 17 | 18.3337 | 7.0319 | 1.43700 | 95.10 | 0.53364 | 15.480 |
| 18 | −17.9165 | 0.3551 | | | | 17.857 |
| *19 | −16.6274 | 1.7502 | 1.80610 | 40.73 | 0.56940 | 18.063 |
| *20 | −60.3741 | 0.9398 | | | | 21.310 |
| 21 | 93.6402 | 8.3666 | 1.49700 | 81.54 | 0.53748 | 25.405 |
| 22 | −19.8666 | DD[22] | | | | 27.156 |
| 23 | 179.3207 | 9.6388 | 1.73800 | 32.33 | 0.59005 | 30.530 |
| 24 | −21.8347 | 1.6581 | 1.88300 | 40.76 | 0.56679 | 31.016 |
| 25 | 60.9771 | 4.4717 | | | | 34.401 |
| 26 | −90.1905 | 4.6739 | 1.65160 | 58.54 | 0.53901 | 34.860 |
| 27 | −35.3536 | 46.9922 | | | | 36.254 |
| 28 | ∞ | 3.2000 | 1.51680 | 64.20 | 0.53430 | 83.292 |
| 29 | ∞ | 1.0064 | | | | 85.120 |

TABLE 2
Example 1

| | Infinite | |
|---|---|---|
| | distance | Nearest |
| Lateral | 0.0 | −0.2083 |
| magnification | | |
| Focal length | 30.8972 | 30.8113 |
| Open F-number | 5.77 | 6.03 |
| Maximum full | 109.1 | 105.2 |
| angle of view [°] | | |
| DD[12] | 7.1408 | 3.1253 |
| DD[22] | 2.2889 | 6.3044 |

TABLE 3
Example 1

| Sn | 1 | 2 | 19 | 20 |
|---|---|---|---|---|
| KA | 1.0000000000E+00 | 1.0000000000E+00 | 1.0000000000E+00 | 1.0000000000E+00 |
| A4 | 6.3023275497E−05 | 7.1444509949E−05 | 1.0596764770E−04 | 1.0049368781E−04 |
| A6 | −2.7036705204E−07 | −2.2883345766E−07 | −1.9509867497E−06 | −1.6949024828E−06 |
| A8 | 9.8697223334E−10 | −2.7515128983E−10 | 3.0418382152E−08 | 2.6380289903E−08 |
| A10 | −2.6149585068E−12 | 1.1129424366E−11 | −3.3373315704E−10 | −3.7706056838E−10 |
| A12 | 4.6882124490E−15 | −7.8230506187E−14 | −2.6635041160E−13 | 4.1366925737E−12 |
| A14 | −5.3633658691E−18 | 2.8940273930E−16 | 6.7654510188E−14 | −3.1059436689E−14 |
| A16 | 3.5718801233E−21 | −6.1270163085E−19 | −9.1497229815E−16 | 1.4796647406E−16 |
| A18 | −1.1486166977E−24 | 6.9398418324E−22 | 5.2266998796E−18 | −4.0218438897E−19 |
| A20 | 1.0290402717E−28 | −3.2252386647E−25 | −1.1087871338E−20 | 4.7821470262E−22 |

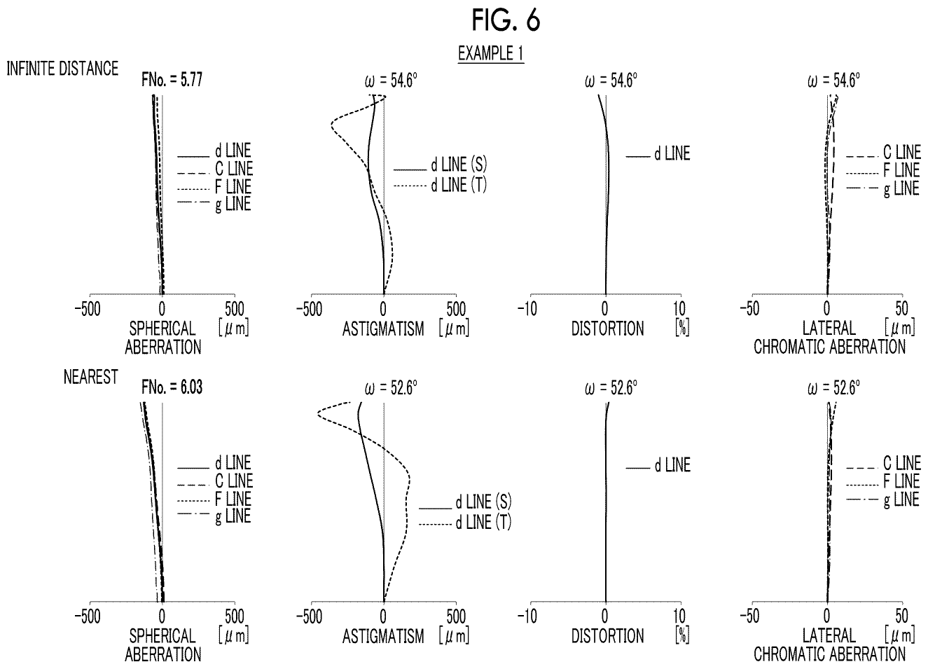

FIG. 6 shows a diagram of aberrations of the optical system of Example 1. In FIG. 6, each aberration diagram in a state where the infinite distance object is in focus is shown in an upper part labeled “infinite distance”, and each aberration diagram in a state where the nearest object is in focus is shown in a lower part labeled “nearest object”. FIG. 6 shows spherical aberration, astigmatism, distortion, and lateral chromatic aberration in order from the left side. In the spherical aberration diagram, the aberrations at the d line, the C line, the F line, and the g line are indicated by a solid line, a long broken line, a short broken line, and a dot-dashed line, respectively. In the astigmatism diagram, the aberration at the d line in a sagittal direction is indicated by a solid line, and the aberration on the d line in a tangential direction is indicated by a short broken line. In the distortion diagram, the aberration at the d line is indicated by a solid line. In the lateral chromatic aberration diagram, the aberrations at the C line, the F line, and the g line are indicated by a long broken line, a short broken line, and a dot-dashed line, respectively. In the spherical aberration diagram, a value of the open F-number in each state is shown after “FNo.=”. In other aberration diagrams, a value of the maximum half angle of view in each state is shown after “ω=”.

Symbols, meanings, description methods, and illustration methods of each data related to Example 1 are basically the same for the following examples unless otherwise noted, and thus the duplicate descriptions thereof will be omitted below.

### Example 2

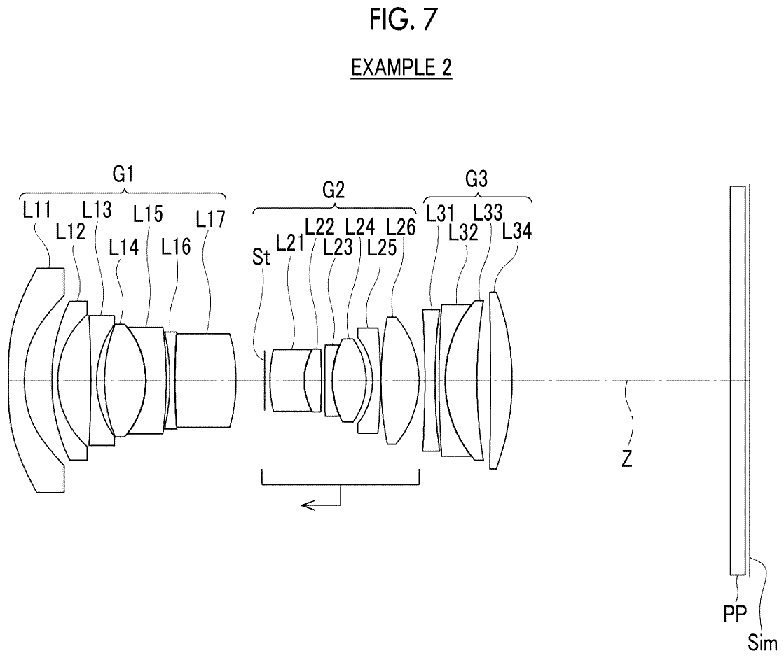

A cross-sectional view of a configuration of an optical system of Example 2 is shown in FIG. 7. The optical system of Example 2 consists of, in order from the object side to the image side, a first lens group G1 that has a negative refractive power, a second lens group G2 that has a positive refractive power, and a third lens group G3 that has a negative refractive power. During focusing from the infinite distance object to the nearest object, the first lens group G1 and the third lens group G3 do not move with respect to the image plane Sim, and the second lens group G2 moves toward the object side.

The first lens group G1 consists of, in order from the object side to the image side, seven lenses including lenses L11 to L17. The second lens group G2 consists of, in order from the object side to the image side, an aperture stop St, and six lenses including lenses L21 to L26. The third lens group G3 consists of, in order from the object side to the image side, four lenses including lenses L31 to L34.

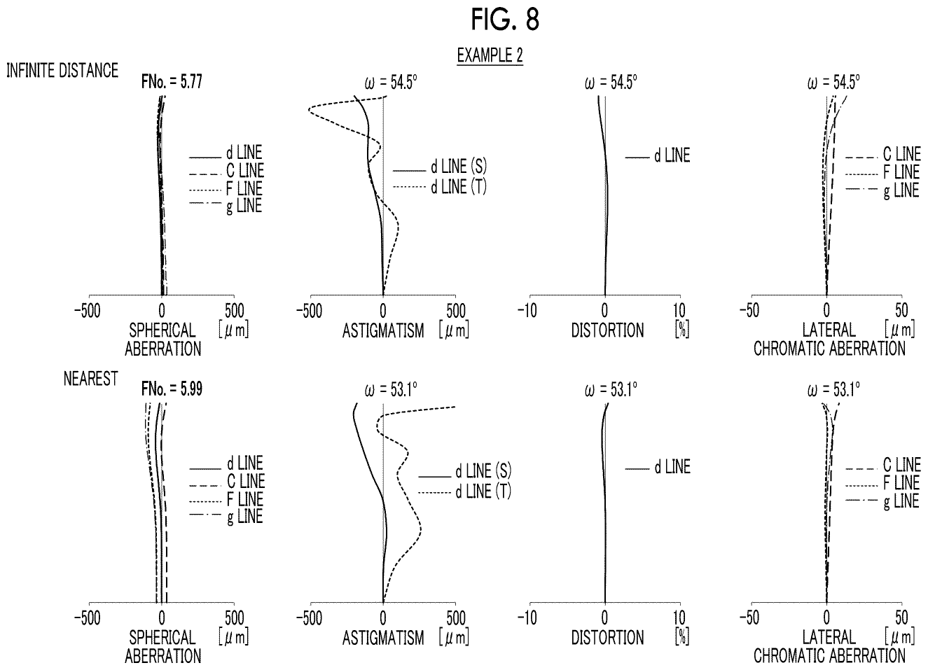

For the optical system of Example 2, basic lens data is shown in Table 4, specifications and variable surface spacings are shown in Table 5, aspherical coefficients are shown in Table 6, and each aberration diagram is shown in FIG. 8.

TABLE 4
Example 2

| Sn | R | D | Nd | νd | θgF | ED |
|---|---|---|---|---|---|---|
| *1 | 299.9643 | 3.5205 | 1.58313 | 59.38 | 0.54237 | 49.031 |
| *2 | 31.2787 | 6.0027 | | | | 37.147 |
| 3 | 40.3446 | 1.3009 | 1.65160 | 58.54 | 0.53901 | 34.711 |
| 4 | 19.2309 | 7.2956 | | | | 28.779 |
| 5 | −250.0236 | 1.3002 | 1.49700 | 81.54 | 0.53748 | 28.285 |
| 6 | 21.3388 | 1.7276 | | | | 24.578 |
| 7 | 33.6841 | 9.0738 | 1.65412 | 39.68 | 0.57378 | 24.530 |
| 8 | −18.4385 | 4.4875 | 1.84666 | 23.78 | 0.61923 | 23.179 |
| 9 | −92.0803 | 0.8357 | | | | 21.302 |
| 10 | −46.4725 | 1.0702 | 1.48749 | 70.44 | 0.53062 | 21.142 |
| 11 | 124.1279 | 13.3059 | 1.90110 | 27.06 | 0.60718 | 20.417 |
| 12 | −39.3821 | DD[12] | | | | 17.500 |
| 13(St) | ∞ | 1.2000 | | | | 12.879 |
| 14 | 29.9502 | 7.5449 | 1.74100 | 52.77 | 0.54714 | 13.462 |
| 15 | 14.0725 | 3.7567 | 1.57957 | 53.74 | 0.55195 | 13.349 |
| 16 | −150.9614 | 0.7867 | | | | 13.656 |
| 17 | 569.3605 | 1.6301 | 1.91082 | 35.25 | 0.58224 | 14.354 |
| 18 | 19.1943 | 7.4520 | 1.43700 | 95.10 | 0.53364 | 15.454 |
| 19 | −15.6384 | 1.3931 | | | | 18.023 |
| *20 | −14.0737 | 1.7502 | 1.58313 | 59.38 | 0.54237 | 18.698 |
| *21 | −72.5295 | 0.1202 | | | | 22.990 |
| 22 | 70.7269 | 8.3669 | 1.49700 | 81.54 | 0.53748 | 26.185 |
| 23 | −21.4188 | DD[23] | | | | 27.718 |
| *24 | −222.7298 | 2.2396 | 1.69350 | 53.20 | 0.54661 | 29.734 |
| *25 | 148.3457 | 0.8883 | | | | 30.878 |
| 26 | 233.8119 | 1.3537 | 1.88300 | 40.85 | 0.56772 | 31.167 |
| 27 | 26.6088 | 7.0045 | 1.65412 | 39.68 | 0.57378 | 33.139 |
| 28 | 111.1910 | 2.9652 | | | | 34.791 |
| 29 | −978.6294 | 4.7504 | 1.70154 | 41.15 | 0.57704 | 37.118 |
| 30 | −54.6258 | 47.9476 | | | | 38.317 |
| 31 | ∞ | 3.2000 | 1.51680 | 64.20 | 0.53430 | 83.384 |
| 32 | ∞ | 0.9939 | | | | 85.137 |

TABLE 5
Example 2

| | Infinite | |
|---|---|---|
| | distance | Nearest |
| Lateral | 0.0 | −0.2047 |
| magnification | | |
| Focal length | 30.9029 | 30.3574 |
| Open F-number | 5.77 | 5.99 |
| Maximum full | 109.1 | 106.2 |
| angle of view [°] | | |
| DD[12] | 6.2806 | 3.1145 |
| DD[23] | 1.2702 | 4.4363 |

TABLE 6
Example 2

| Sn | 1 | 2 | 20 | 21 |
|---|---|---|---|---|
| KA | 1.0000000000E+00 | 1.0000000000E+00 | 1.0000000000E+00 | 1.0000000000E+00 |
| A4 | 6.9744356403E−05 | 7.8331291747E−05 | 1.2631552875E−04 | 1.1421445298E−04 |
| A6 | −3.6183824320E−07 | −2.9740272830E−07 | −2.5639918413E−06 | −2.4224278151E−06 |
| A8 | 1.4477689421E−09 | −3.2636422547E−10 | 4.9153905929E−08 | 4.1683095015E−08 |
| A10 | −4.2462344710E−12 | 1.2889807818E−11 | −9.4715325947E−10 | −6.1461664583E−10 |
| A12 | 8.7898606055E−15 | −8.6581728419E−14 | 1.5762638432E−11 | 7.0697499347E−12 |
| A14 | −1.2449062192E−17 | 3.0677267414E−16 | −1.8458995284E−13 | −5.8089742103E−14 |
| A16 | 1.1503184992E−20 | −6.2392428867E−19 | 1.3186424875E−15 | 3.1231374255E−16 |
| A18 | −6.2921304850E−24 | 6.8198126144E−22 | −4.8876266525E−18 | −9.7135059928E−19 |
| A20 | 1.5633529191E−27 | −3.0655673436E−25 | 6.4993542935E−21 | 1.3148927550E−21 |

| Sn | 24 | 25 |
|---|---|---|
| KA | 1.0000000000E+00 | 1.0000000000E+00 |
| A4 | 7.8412826772E−06 | 7.5645417585E−06 |
| A6 | −3.2114277757E−07 | −2.6563366777E−07 |
| A8 | 8.1220184872E−09 | 6.5336546646E−09 |
| A10 | −1.1347713569E−10 | −8.5616777628E−11 |
| A12 | 9.9278835000E−13 | 7.0313490256E−13 |
| A14 | −5.5504696286E−15 | −3.7006190550E−15 |
| A16 | 1.9045867583E−17 | 1.1999032311E−17 |
| A18 | −3.6355843943E−20 | −2.1738597571E−20 |
| A20 | 2.9393398553E−23 | 1.6781399617E−23 |

### Example 3

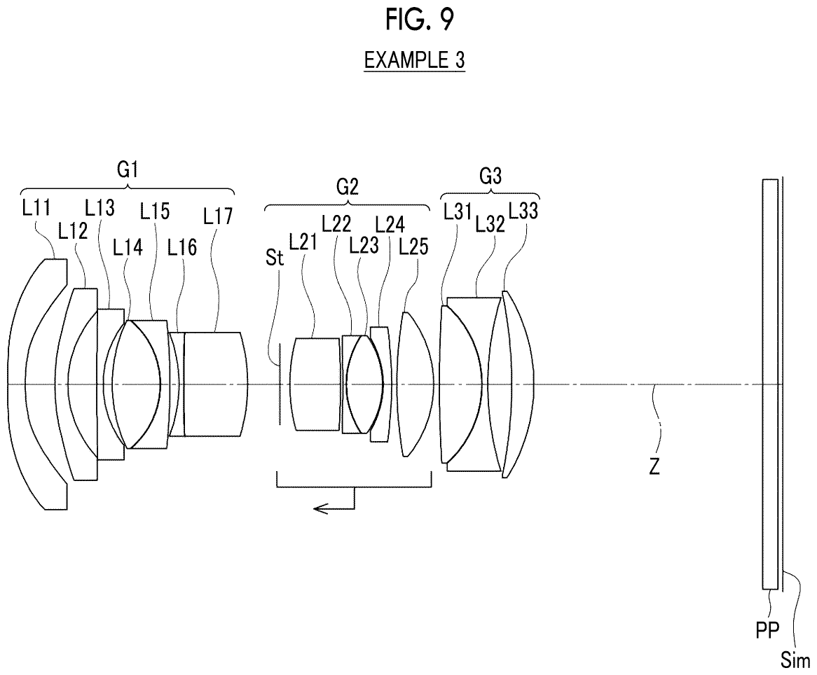

A cross-sectional view of a configuration of an optical system of Example 3 is shown in FIG. 9. The optical system of Example 3 consists of, in order from the object side to the image side, a first lens group G1 that has a negative refractive power, a second lens group G2 that has a positive refractive power, and a third lens group G3 that has a negative refractive power. During focusing from the infinite distance object to the nearest object, the first lens group G1 and the third lens group G3 do not move with respect to the image plane Sim, and the second lens group G2 moves toward the object side.

The first lens group G1 consists of, in order from the object side to the image side, seven lenses including lenses L11 to L17. The second lens group G2 consists of, in order from the object side to the image side, an aperture stop St, and five lenses including lenses L21 to L25. The third lens group G3 consists of, in order from the object side to the image side, three lenses including lenses L31 to L33.

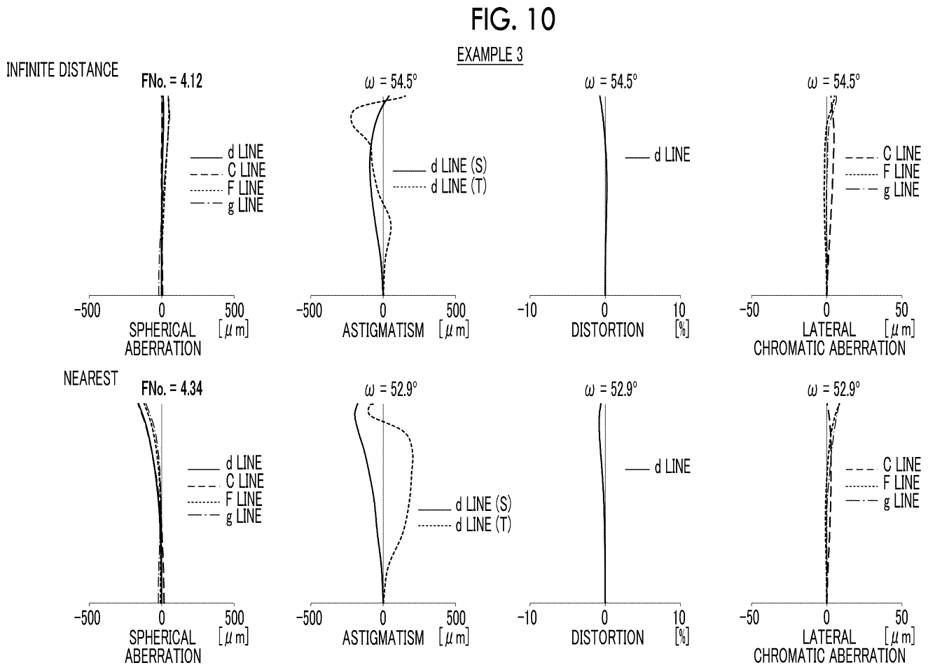

For the optical system of Example 3, basic lens data is shown in Table 7, specifications and variable surface spacings are shown in Table 8, aspherical coefficients are shown in Table 9, and each aberration diagram is shown in FIG. 10.

TABLE 7
Example 3

| Sn | R | D | Nd | νd | θgF | ED |
|---|---|---|---|---|---|---|
| *1 | ∞ | 3.6401 | 1.58313 | 59.38 | 0.54237 | 52.214 |
| *2 | 44.3846 | 6.1983 | | | | 41.495 |
| *3 | 49.4565 | 2.7001 | 1.77250 | 49.50 | 0.55193 | 38.009 |
| *4 | 22.5250 | 6.0594 | | | | 29.977 |
| 5 | 971.5908 | 1.3002 | 1.49700 | 81.54 | 0.53748 | 29.556 |
| 6 | 20.9758 | 1.8958 | | | | 25.005 |
| 7 | 30.7887 | 10.0449 | 1.67300 | 38.26 | 0.57580 | 24.791 |
| 8 | −17.4915 | 1.9976 | 1.84666 | 23.78 | 0.61923 | 22.428 |
| 9 | −128.9374 | 1.8784 | | | | 20.216 |
| 10 | −30.0940 | 1.0100 | 1.48749 | 70.44 | 0.53062 | 19.620 |
| 11 | 301.6060 | 13.2065 | 2.00069 | 25.46 | 0.61364 | 19.157 |
| 12 | −37.6671 | DD[12] | | | | 17.636 |
| 13(St) | ∞ | 2.1602 | | | | 16.977 |
| 14 | 37.2742 | 10.5327 | 1.80518 | 25.46 | 0.61572 | 17.090 |
| 15 | −175.0901 | 0.5104 | | | | 15.308 |
| 16 | −227.4614 | 0.7502 | 1.90110 | 27.06 | 0.60718 | 15.073 |
| 17 | 18.2993 | 7.5370 | 1.43700 | 95.10 | 0.53364 | 15.787 |
| 18 | −17.4310 | 0.1443 | | | | 18.436 |
| *19 | −16.9746 | 1.7791 | 1.80610 | 40.73 | 0.56940 | 18.643 |
| *20 | −53.2748 | 1.0914 | | | | 21.871 |
| 21 | 88.0872 | 7.6650 | 1.55032 | 75.50 | 0.54001 | 26.544 |
| 22 | −23.4531 | DD[22] | | | | 28.017 |
| 23 | 279.7858 | 8.9040 | 1.73800 | 32.33 | 0.59005 | 30.297 |
| 24 | −22.0495 | 1.2000 | 1.88300 | 40.76 | 0.56679 | 30.771 |
| 25 | 60.9770 | 5.0013 | | | | 34.058 |
| 26 | −91.7462 | 4.6158 | 1.72916 | 54.68 | 0.54451 | 35.417 |
| 27 | −36.4573 | 47.6437 | | | | 36.781 |
| 28 | ∞ | 3.2000 | 1.51680 | 64.20 | 0.53430 | 83.352 |
| 29 | ∞ | 1.0054 | | | | 85.121 |

TABLE 8
Example 3

| | Infinite | |
|---|---|---|
| | distance | Nearest |
| Lateral | 0.0 | −0.2025 |
| magnification | | |
| Focal length | 30.9015 | 30.5809 |
| Open F-number | 4.12 | 4.34 |
| Maximum full | 109.0 | 105.8 |
| angle of view [°] | | |
| DD[12] | 6.6616 | 3.1227 |
| DD[22] | 1.2000 | 4.7389 |

TABLE 9
Example 3

| Sn | 1 | 2 | 3 | 4 |
|---|---|---|---|---|
| KA | 1.0000000000E+00 | 1.0000000000E+00 | 1.0000000000E+00 | 1.0000000000E+00 |
| A4 | 5.6604788587E−05 | 6.1472598874E−05 | 3.7285210522E−06 | 4.5673196902E−06 |
| A6 | −1.6712789755E−07 | −5.8846243396E−08 | 6.7088274266E−07 | 8.6726830889E−07 |
| A8 | 3.0036071427E−10 | 2.2406695570E−10 | −1.1872303190E−08 | −1.9419838570E−08 |
| A10 | −4.1579045185E−13 | −1.0155149318E−11 | 9.1198267762E−11 | 1.8726515459E−10 |
| A12 | 9.6371896948E−16 | 6.9592950624E−14 | −4.0128240039E−13 | −1.0116159831E−12 |
| A14 | −2.3273967557E−18 | −2.1748150231E−16 | 1.0848405126E−15 | 3.3155350175E−15 |
| A16 | 3.3470589525E−21 | 3.6221647778E−19 | −1.7898022665E−18 | −6.8000267821E−18 |
| A18 | −2.4883245100E−24 | −3.1463574451E−22 | 1.6609467289E−21 | 8.7627399149E−21 |
| A20 | 7.4727962815E−28 | 1.1313299823E−25 | −6.6654037985E−25 | −5.9545706125E−24 |

| Sn | 19 | 20 |
|---|---|---|
| KA | 1.0000000000E+00 | 1.0000000000E+00 |
| A4 | 9.9125394089E−05 | 9.0999435516E−05 |
| A6 | −1.4738090544E−06 | −1.2926387361E−06 |
| A8 | 2.0503390074E−08 | 1.5912579975E−08 |
| A10 | −3.0148099049E−10 | −1.8155378057E−10 |
| A12 | 4.1533457325E−12 | 1.6693747738E−12 |
| A14 | −4.7656866316E−14 | −1.1005341081E−14 |
| A16 | 3.9695496481E−16 | 4.7365369668E−17 |
| A18 | −2.0235376013E−18 | −1.1826632106E−19 |
| A20 | 4.5988816295E−21 | 1.3008255364E−22 |

### Example 4

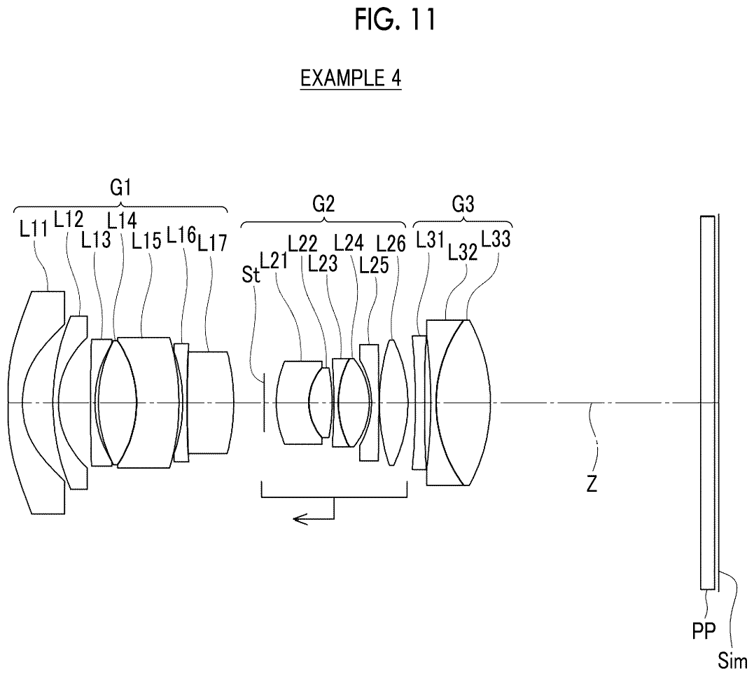

A cross-sectional view of a configuration of an optical system of Example 4 is shown in FIG. 11. The optical system of Example 4 consists of, in order from the object side to the image side, a first lens group G1 that has a negative refractive power, a second lens group G2 that has a positive refractive power, and a third lens group G3 that has a negative refractive power. During focusing from the infinite distance object to the nearest object, the first lens group G1 and the third lens group G3 do not move with respect to the image plane Sim, and the second lens group G2 moves toward the object side.

The first lens group G1 consists of, in order from the object side to the image side, seven lenses including lenses L11 to L17. The second lens group G2 consists of, in order from the object side to the image side, an aperture stop St, and six lenses including lenses L21 to L26. The third lens group G3 consists of, in order from the object side to the image side, three lenses including lenses L31 to L33.

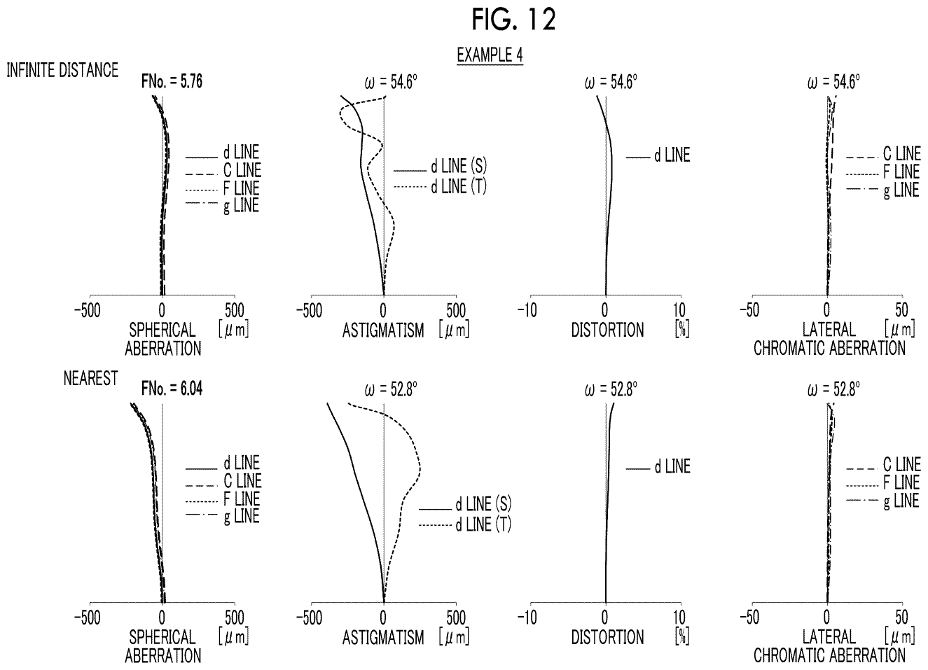

For the optical system of Example 4, basic lens data is shown in Table 10, specifications and variable surface spacings are shown in Table 11, aspherical coefficients are shown in Table 12, and each aberration diagram is shown in FIG. 12.

TABLE 10
Example 4

| Sn | R | D | Nd | νd | θgF | ED |
|---|---|---|---|---|---|---|
| *1 | 247.1074 | 3.3100 | 1.58480 | 58.71 | 0.54116 | 48.495 |
| *2 | 23.0054 | 7.0200 | | | | 35.233 |
| 3 | 50.3300 | 1.2300 | 1.69680 | 55.53 | 0.54420 | 34.090 |
| 4 | 20.0711 | 7.4000 | | | | 28.839 |
| 5 | 438.6617 | 1.0000 | 1.49700 | 81.60 | 0.53774 | 27.740 |
| 6 | 25.3736 | 0.7976 | | | | 25.932 |
| 7 | 31.0189 | 8.7700 | 1.65412 | 39.68 | 0.57378 | 25.928 |
| 8 | −25.1959 | 9.7400 | 1.84666 | 23.84 | 0.62012 | 24.900 |
| 9 | −52.7669 | 0.8400 | | | | 22.428 |
| 10 | −35.4528 | 1.0300 | 1.48749 | 70.44 | 0.52933 | 22.203 |
| 11 | 278.3370 | 10.5500 | 1.90043 | 37.37 | 0.57668 | 21.344 |
| 12 | −45.9945 | DD[12] | | | | 19.140 |
| 13(St) | ∞ | 2.8300 | | | | 13.242 |
| 14 | 24.2230 | 7.4900 | 1.72916 | 54.54 | 0.54535 | 14.318 |
| 15 | 12.2052 | 5.3300 | 1.48749 | 70.44 | 0.53062 | 13.473 |
| 16 | −44.2557 | 0.4300 | | | | 13.980 |
| 17 | −112.1941 | 1.0000 | 1.87070 | 40.73 | 0.56825 | 14.488 |
| 18 | 21.3658 | 7.1300 | 1.43700 | 95.10 | 0.53364 | 15.609 |
| 19 | −16.0840 | 0.5000 | | | | 18.131 |
| *20 | −17.8071 | 1.6700 | 1.58480 | 58.71 | 0.54116 | 18.719 |
| *21 | −256.0233 | 0.1200 | | | | 22.286 |
| 22 | 46.0954 | 6.5600 | 1.49700 | 81.61 | 0.53804 | 25.510 |
| 23 | −32.9055 | DD[23] | | | | 26.703 |
| *24 | −207.1480 | 2.0900 | 1.58480 | 58.71 | 0.54116 | 28.610 |
| *25 | 300.0012 | 1.4763 | | | | 29.861 |
| 26 | −118.6089 | 1.2200 | 1.80420 | 46.50 | 0.55727 | 29.943 |
| 27 | 31.4600 | 12.4400 | 1.56732 | 42.81 | 0.57567 | 33.617 |
| 28 | −39.5818 | 48.1062 | | | | 36.500 |
| 29 | ∞ | 3.2000 | 1.51680 | 64.20 | 0.53430 | 83.326 |
| 30 | ∞ | 1.0097 | | | | 85.114 |

TABLE 11
Example 4

| | Infinite | |
|---|---|---|
| | distance | Nearest |
| Lateral | 0.0 | −0.2081 |
| magnification | | |
| Focal length | 30.9009 | 30.5348 |
| Open F-number | 5.76 | 6.04 |
| Maximum full | 109.2 | 105.6 |
| angle of view [°] | | |
| DD[12] | 6.9392 | 3.1340 |
| DD[23] | 1.7130 | 5.5182 |

TABLE 12
Example 4

| Sn | 1 | 2 | 20 | 21 |
|---|---|---|---|---|
| KA | 1.0000000000E+00 | 1.0000000000E+00 | 1.0000000000E+00 | 1.0000000000E+00 |
| A4 | 6.9985344643E−05 | 7.6550363079E−05 | 6.1678852804E−05 | 5.3993444492E−05 |
| A6 | −4.1495389193E−07 | −3.3491710638E−07 | −8.4841307548E−07 | −5.0416682403E−07 |
| A8 | 1.8127148594E−09 | −2.7399958288E−10 | 7.6462639090E−09 | −9.4576806090E−09 |
| A10 | −5.8599042972E−12 | 1.2545646179E−11 | −2.9599710350E−10 | 3.8678271124E−10 |
| A12 | 1.3470869216E−14 | −8.0607014985E−14 | 1.3288149284E−11 | −6.2436651308E−12 |
| A14 | −2.1314614675E−17 | 2.4215876253E−16 | −2.8944039384E−13 | 5.7606868156E−14 |
| A16 | 2.2080152847E−20 | −3.3104037407E−19 | 3.3363191421E−15 | −3.1357356948E−16 |
| A18 | −1.3496507867E−23 | 8.0932158617E−23 | −1.9816711281E−17 | 9.3413221693E−19 |
| A20 | 3.6928847772E−27 | 1.6192649507E−25 | 4.8075539380E−20 | −1.1708545673E−21 |

| Sn | 24 | 25 |
|---|---|---|
| KA | 1.0000000000E+00 | 1.0000000000E+00 |
| A4 | −2.4949150879E−05 | −1.8702781078E−05 |
| A6 | 5.2212783180E−07 | 3.9581240194E−07 |
| A8 | −6.6653304201E−09 | −4.3496626904E−09 |
| A10 | 4.8408534779E−11 | 2.8266869200E−11 |
| A12 | −1.4338770350E−13 | −7.7553545138E−14 |
| A14 | −4.6860526964E−16 | −1.9756770448E−16 |
| A16 | 5.3281133753E−18 | 2.1633657764E−18 |
| A18 | −1.6673252809E−20 | −6.1808006045E−21 |
| A20 | 1.8662654469E−23 | 6.2841218553E−24 |

### Example 5

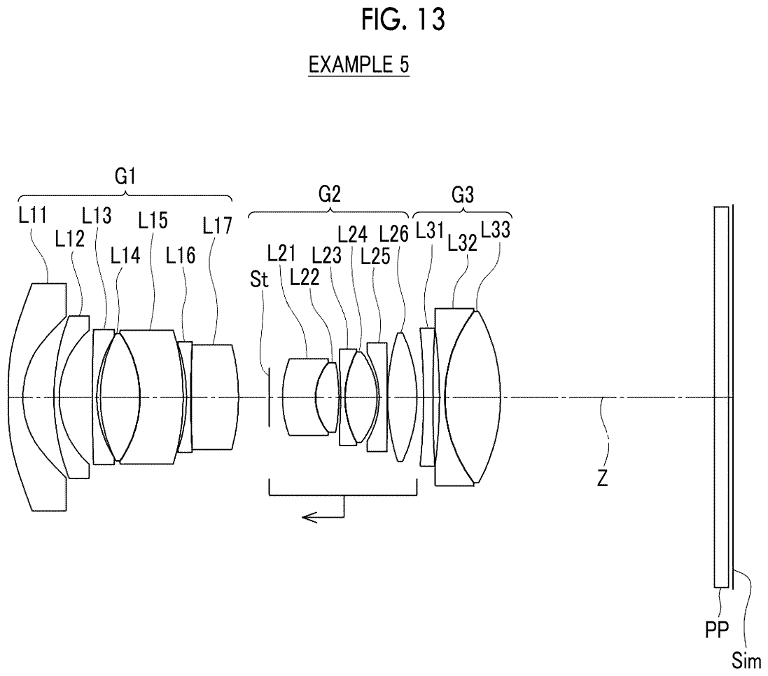

A cross-sectional view of a configuration of an optical system of Example 5 is shown in FIG. 13. The optical system of Example 5 consists of, in order from the object side to the image side, a first lens group G1 that has a positive refractive power, a second lens group G2 that has a positive refractive power, and a third lens group G3 that has a negative refractive power. During focusing from the infinite distance object to the nearest object, the first lens group G1 and the third lens group G3 do not move with respect to the image plane Sim, and the second lens group G2 moves toward the object side.

The first lens group G1 consists of, in order from the object side to the image side, seven lenses including lenses L11 to L17. The second lens group G2 consists of, in order from the object side to the image side, an aperture stop St, and six lenses including lenses L21 to L26. The third lens group G3 consists of, in order from the object side to the image side, three lenses including lenses L31 to L33.

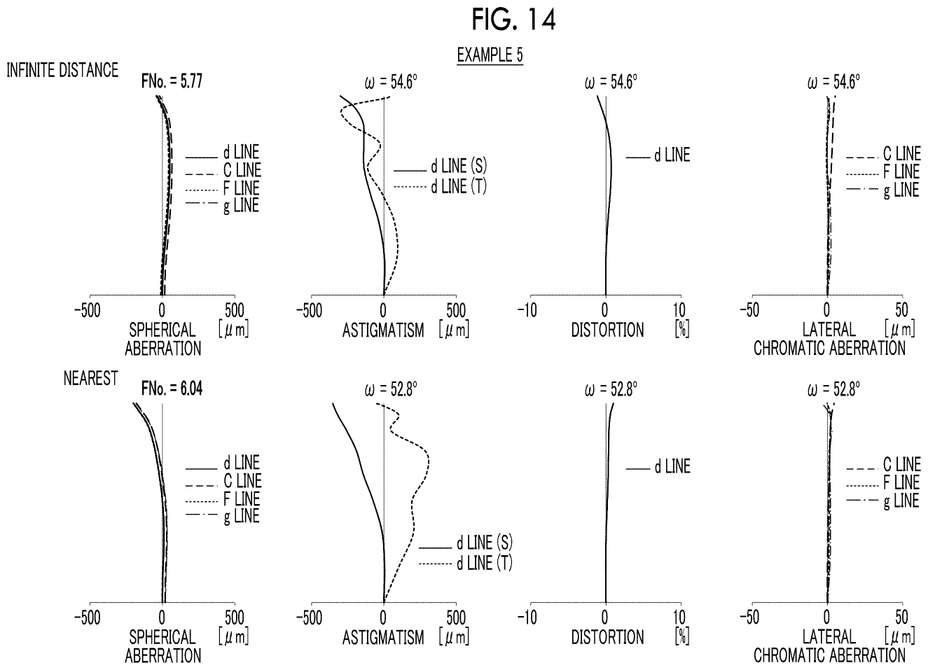

For the optical system of Example 5, basic lens data is shown in Table 13, specifications and variable surface spacings are shown in Table 14, aspherical coefficients are shown in Table 15, and each aberration diagram is shown in FIG. 14.

TABLE 13
Example 5

| Sn | R | D | Nd | νd | θgF | ED |
|---|---|---|---|---|---|---|
| *1 | 256.7587 | 3.3100 | 1.58480 | 58.71 | 0.54116 | 48.400 |
| *2 | 23.0885 | 6.9821 | | | | 35.388 |
| 3 | 49.9108 | 1.1968 | 1.69680 | 55.53 | 0.54420 | 34.335 |
| 4 | 19.9828 | 7.4523 | | | | 29.121 |
| 5 | 440.0001 | 1.0043 | 1.49700 | 81.60 | 0.53774 | 28.218 |
| 6 | 25.2483 | 0.8001 | | | | 26.227 |
| 7 | 30.8368 | 8.8809 | 1.65412 | 39.68 | 0.57378 | 26.222 |
| 8 | −24.8365 | 9.7169 | 1.84666 | 23.84 | 0.62012 | 25.183 |
| 9 | −52.1107 | 0.7911 | | | | 22.561 |
| 10 | −36.0080 | 1.0101 | 1.48749 | 70.44 | 0.53062 | 22.336 |
| 11 | 282.0169 | 10.6853 | 1.90043 | 37.37 | 0.57668 | 21.429 |
| 12 | −45.9577 | DD[12] | | | | 19.140 |
| 13(St) | ∞ | 2.9592 | | | | 13.227 |
| 14 | 24.3452 | 7.4773 | 1.72916 | 54.54 | 0.54535 | 14.321 |
| 15 | 12.2211 | 5.2100 | 1.48749 | 70.44 | 0.53062 | 13.499 |
| 16 | −44.3064 | 0.4215 | | | | 13.980 |
| 17 | −112.0792 | 1.0000 | 1.87070 | 40.73 | 0.56825 | 14.481 |
| 18 | 21.2562 | 7.1811 | 1.43700 | 95.10 | 0.53364 | 15.606 |
| 19 | −16.0399 | 0.5002 | | | | 18.157 |
| *20 | −17.8077 | 1.6101 | 1.58480 | 58.71 | 0.54116 | 18.753 |
| *21 | −260.5214 | 0.1200 | | | | 22.335 |
| 22 | 46.0730 | 6.5829 | 1.49700 | 81.61 | 0.53887 | 25.573 |
| 23 | −33.0441 | DD[23] | | | | 26.770 |
| *24 | −209.4805 | 2.1321 | 1.58480 | 58.71 | 0.54116 | 28.567 |
| *25 | 300.0011 | 1.4718 | | | | 29.825 |
| 26 | −118.1569 | 1.2276 | 1.80420 | 46.50 | 0.55727 | 29.907 |
| 27 | 31.3136 | 12.4970 | 1.56732 | 42.81 | 0.57567 | 33.586 |
| 28 | −39.5259 | 48.1292 | | | | 36.500 |
| 29 | ∞ | 3.2000 | 1.51680 | 64.20 | 0.53430 | 83.330 |
| 30 | ∞ | 1.0113 | | | | 85.121 |

TABLE 14
Example 5

| | Infinite | |
|---|---|---|
| | distance | Nearest |
| Lateral | 0.0 | −0.2079 |
| magnification | | |
| Focal length | 30.9009 | 30.5013 |
| Open F-number | 5.77 | 6.04 |
| Maximum full | 109.2 | 105.6 |
| angle of view [°] | | |
| DD[12] | 6.9212 | 3.1274 |
| DD[23] | 1.4874 | 5.2812 |

TABLE 15
Example 5

| Sn | 1 | 2 | 20 | 21 |
|---|---|---|---|---|
| KA | 1.0000000000E+00 | 1.0000000000E+00 | 1.0000000000E+00 | 1.0000000000E+00 |
| A4 | 6.9453128169E−05 | 7.7801652955E−05 | 6.6274254678E−05 | 6.3483281436E−05 |
| A6 | −4.0410587509E−07 | −3.8965477777E−07 | −1.0472185935E−06 | −1.0981586309E−06 |
| A8 | 1.7250431308E−09 | 9.1331861642E−10 | 7.5876667415E−09 | 9.7247469825E−09 |
| A10 | −5.4722538357E−12 | −1.1889040349E−12 | −7.7073617002E−11 | −7.9387789234E−12 |
| A12 | 1.2436002217E−14 | 1.1723962109E−14 | 5.7104214405E−12 | −8.7399913855E−13 |
| A14 | −1.9577741520E−17 | −1.3154699542E−16 | −1.5687742220E−13 | 9.7872157270E−15 |
| A16 | 2.0261029282E−20 | 5.6997823181E−19 | 2.0044654593E−15 | −4.6762904911E−17 |
| A18 | −1.2392619889E−23 | −1.1130098397E−21 | −1.2511629478E−17 | 9.0819966274E−20 |
| A20 | 3.3914734211E−27 | 8.3116976903E−25 | 3.1108265961E−20 | −2.1403222569E−23 |

| Sn | 24 | 25 |
|---|---|---|
| KA | 1.0000000000E+00 | 1.0000000000E+00 |
| A4 | −1.5462263287E−05 | −1.2540508469E−05 |
| A6 | 5.7375741462E−08 | 9.9342968249E−08 |
| A8 | 4.2548267131E−09 | 2.1396218989E−09 |
| A10 | −1.0664672453E−10 | −5.6825724823E−11 |
| A12 | 1.2595062826E−12 | 6.3252233067E−13 |
| A14 | −8.5725761707E−15 | −3.9787013578E−15 |
| A16 | 3.4218740314E−17 | 1.4581783374E−17 |
| A18 | −7.4571852033E−20 | −2.9096446711E−20 |
| A20 | 6.8577917334E−23 | 2.4468890510E−23 |

### Example 6

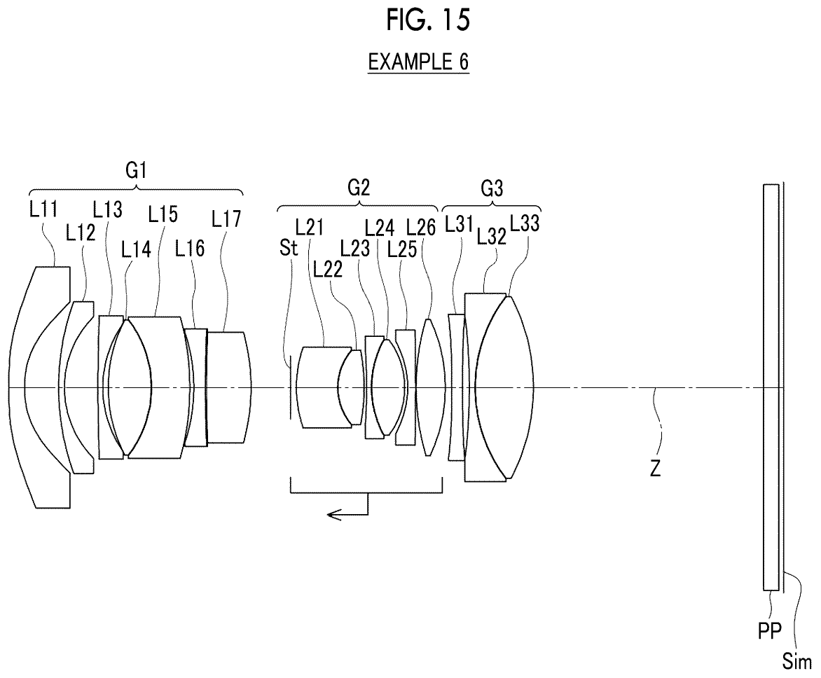

A cross-sectional view of a configuration of an optical system of Example 6 is shown in FIG. 15. The optical system of Example 6 consists of, in order from the object side to the image side, a first lens group G1 that has a positive refractive power, a second lens group G2 that has a positive refractive power, and a third lens group G3 that has a positive refractive power. During focusing from the infinite distance object to the nearest object, the first lens group G1 and the third lens group G3 do not move with respect to the image plane Sim, and the second lens group G2 moves toward the object side.

The first lens group G1 consists of, in order from the object side to the image side, seven lenses including lenses L11 to L17. The second lens group G2 consists of, in order from the object side to the image side, an aperture stop St, and six lenses including lenses L21 to L26. The third lens group G3 consists of, in order from the object side to the image side, three lenses including lenses L31 to L33.

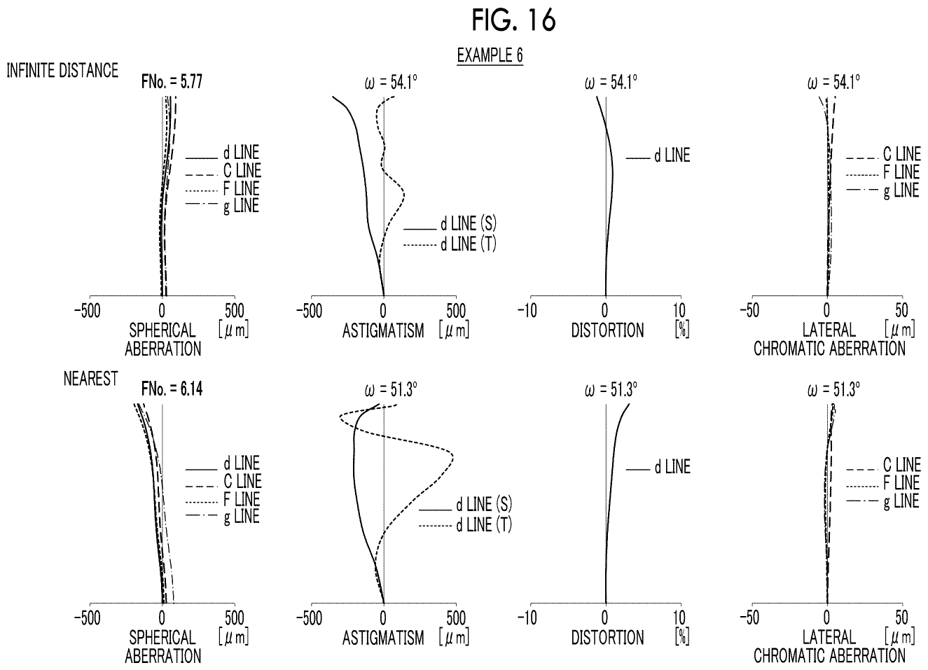

For the optical system of Example 6, basic lens data is shown in Table 16, specifications and variable surface spacings are shown in Table 17, aspherical coefficients are shown in Table 18, and each aberration diagram is shown in FIG. 16.

TABLE 16
Example 6

| Sn | R | D | Nd | νd | θgF | ED |
|---|---|---|---|---|---|---|
| *1 | 178.9427 | 3.3100 | 1.58480 | 58.71 | 0.54116 | 48.400 |
| *2 | 23.2884 | 7.2045 | | | | 35.607 |
| 3 | 53.3983 | 1.2035 | 1.69680 | 55.53 | 0.54420 | 34.507 |
| 4 | 21.1478 | 7.0848 | | | | 29.462 |
| 5 | 439.9737 | 1.0128 | 1.49700 | 81.60 | 0.53774 | 28.477 |
| 6 | 23.4357 | 1.1538 | | | | 26.113 |
| 7 | 30.8992 | 9.1026 | 1.65412 | 39.68 | 0.57378 | 26.105 |
| 8 | −23.3361 | 8.0880 | 1.84666 | 23.84 | 0.62012 | 25.002 |
| 9 | −56.4131 | 0.8584 | | | | 22.649 |
| 10 | −36.6488 | 2.4892 | 1.48749 | 70.44 | 0.53062 | 22.436 |
| 11 | 308.5902 | 9.4292 | 1.90043 | 37.37 | 0.57668 | 21.135 |
| 12 | −43.3685 | DD[12] | | | | 19.140 |
| 13(St) | ∞ | 1.2000 | | | | 13.364 |
| 14 | 26.2770 | 8.7460 | 1.80103 | 47.90 | 0.55252 | 13.943 |
| 15 | 12.1379 | 5.5174 | 1.54898 | 57.36 | 0.54907 | 13.462 |
| 16 | −44.7598 | 0.5566 | | | | 13.980 |
| 17 | −115.3069 | 1.0388 | 1.87070 | 40.73 | 0.56825 | 14.569 |
| 18 | 20.7120 | 6.9792 | 1.43700 | 95.10 | 0.53364 | 15.727 |
| 19 | −16.7575 | 0.6659 | | | | 18.193 |
| *20 | −17.9934 | 1.6284 | 1.61545 | 51.40 | 0.55795 | 18.900 |
| *21 | −267.8188 | 0.1200 | | | | 22.214 |
| 22 | 50.4210 | 6.1469 | 1.49700 | 81.61 | 0.53887 | 24.833 |
| 23 | −33.9864 | DD[23] | | | | 26.148 |
| *24 | −276.4505 | 2.2318 | 1.55032 | 75.50 | 0.54001 | 28.763 |
| *25 | 287.3031 | 1.4593 | | | | 30.061 |
| 26 | −122.7711 | 1.2276 | 1.85809 | 42.19 | 0.56336 | 30.122 |
| 27 | 31.4318 | 12.2978 | 1.64327 | 41.81 | 0.57451 | 33.671 |
| 28 | −40.7449 | 48.4357 | | | | 36.500 |
| 29 | ∞ | 3.2000 | 1.51680 | 64.20 | 0.53430 | 83.344 |
| 30 | ∞ | 1.0058 | | | | 85.170 |

TABLE 17
Example 6

| | Infinite | |
|---|---|---|
| | distance | Nearest |
| Lateral | 0.0 | −0.2151 |
| magnification | | |
| Focal length | 31.4626 | 31.4991 |
| Open F-number | 5.77 | 6.14 |
| Maximum full | 108.3 | 102.6 |
| angle of view [°] | | |
| DD[12] | 8.3735 | 3.1408 |
| DD[23] | 1.4000 | 6.6327 |

TABLE 18
Example 6

| Sn | 1 | 2 | 20 | 21 |
|---|---|---|---|---|
| KA | 1.0000000000E+00 | 1.0000000000E+00 | 1.0000000000E+00 | 1.0000000000E+00 |
| A4 | 6.7576267444E−05 | 7.6061366468E−05 | 7.6393458822E−05 | 6.4157293549E−05 |
| A6 | −3.6321228375E−07 | −3.2101890187E−07 | −1.4072659104E−06 | −1.1743636447E−06 |
| A8 | 1.3598729770E−09 | 3.9054081539E−10 | 3.0031994861E−08 | 1.5197723134E−08 |
| A10 | −3.8197860663E−12 | −1.3813113246E−12 | −7.1486919677E−10 | −1.9590531864E−10 |
| A12 | 7.9697214806E−15 | 2.8183082930E−14 | 1.4234655756E−11 | 2.3749531376E−12 |
| A14 | −1.1971129693E−17 | −1.9908738783E−16 | −1.8774494863E−13 | −2.1738228749E−14 |
| A16 | 1.2193406513E−20 | 6.6097017941E−19 | 1.5197187047E−15 | 1.2754459062E−16 |
| A18 | −7.4975415539E−24 | −1.0878143159E−21 | −6.8174474414E−18 | −4.1942353827E−19 |
| A20 | 2.0881502572E−27 | 7.1937100774E−25 | 1.3073338462E−20 | 5.8647001498E−22 |

| Sn | 24 | 25 |
|---|---|---|
| KA | 1.0000000000E+00 | 1.0000000000E+00 |
| A4 | −1.0306405940E−05 | −6.0883144012E−06 |
| A6 | 4.8685966648E−08 | 9.0539119318E−08 |
| A8 | 3.9208005127E−10 | −7.6990440735E−10 |
| A10 | −1.9922171073E−11 | 2.7340769306E−12 |
| A12 | 2.7624964846E−13 | 2.3834982505E−14 |
| A14 | −1.8931029070E−15 | −2.6872987247E−16 |
| A16 | 6.9388927413E−18 | 9.9742329443E−19 |
| A18 | −1.3004574724E−20 | −1.5794891624E−21 |
| A20 | 9.6495734787E−24 | 7.9144837292E−25 |

### Example 7

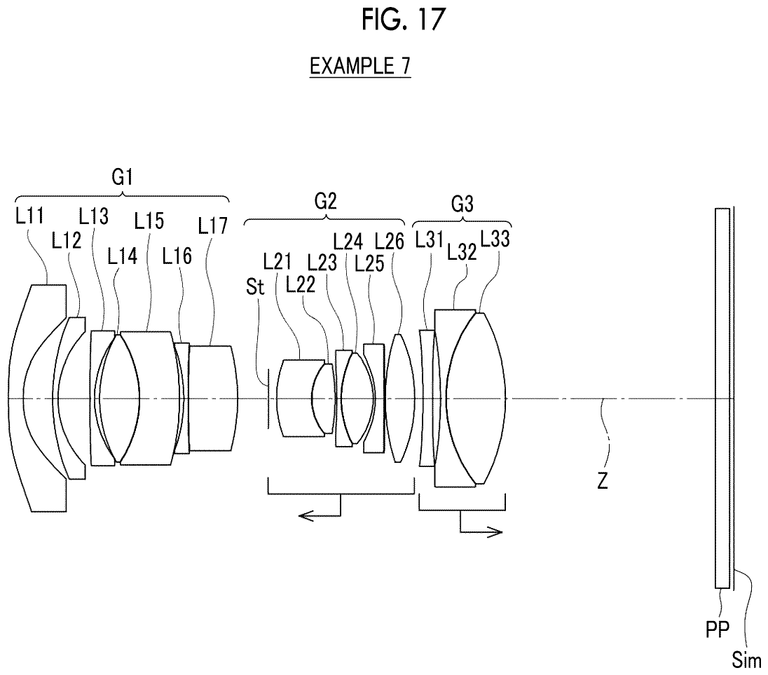

A cross-sectional view of a configuration of an optical system of Example 7 is shown in FIG. 17. The optical system of Example 7 consists of, in order from the object side to the image side, a first lens group G1 that has a positive refractive power, a second lens group G2 that has a positive refractive power, and a third lens group G3 that has a negative refractive power. During focusing from the infinite distance object to the nearest object, the first lens group G1 does not move with respect to the image plane Sim, the second lens group G2 moves toward the object side, and the third lens group G3 moves toward the image side.

The first lens group G1 consists of, in order from the object side to the image side, seven lenses including lenses L11 to L17. The second lens group G2 consists of, in order from the object side to the image side, an aperture stop St, and six lenses including lenses L21 to L26. The third lens group G3 consists of, in order from the object side to the image side, three lenses including lenses L31 to L33.

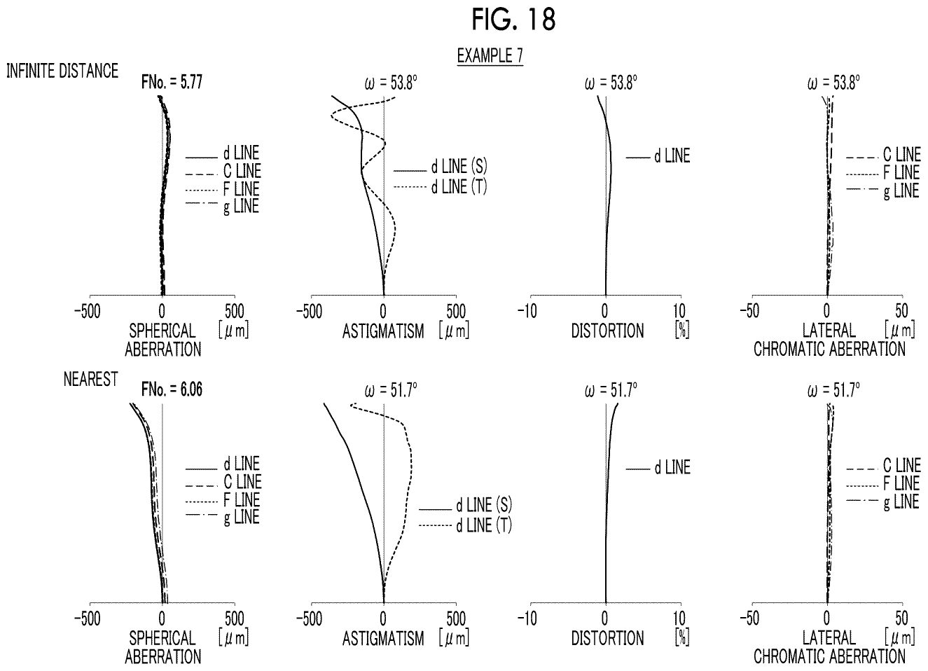

For the optical system of Example 7, basic lens data is shown in Table 19, specifications and variable surface spacings are shown in Table 20, aspherical coefficients are shown in Table 21, and each aberration diagram is shown in FIG. 18.

TABLE 19
Example 7

| Sn | R | D | Nd | νd | θgF | ED |
|---|---|---|---|---|---|---|
| *1 | 280.8712 | 3.3100 | 1.58480 | 58.71 | 0.54116 | 48.400 |
| *2 | 23.0512 | 6.6417 | | | | 35.411 |
| 3 | 45.6122 | 1.1969 | 1.69680 | 55.53 | 0.54420 | 34.416 |
| 4 | 21.2054 | 7.1990 | | | | 29.750 |
| 5 | 439.9329 | 1.0215 | 1.49700 | 81.60 | 0.53774 | 28.739 |
| 6 | 22.3657 | 1.1515 | | | | 26.184 |
| 7 | 28.7301 | 8.9620 | 1.65412 | 39.68 | 0.57378 | 26.178 |
| 8 | −25.4443 | 9.0244 | 1.84666 | 23.84 | 0.62012 | 25.062 |
| 9 | −55.3058 | 0.9562 | | | | 22.212 |
| 10 | −33.9436 | 1.0101 | 1.48749 | 70.44 | 0.53062 | 21.971 |
| 11 | 290.3257 | 11.1106 | 1.90043 | 37.37 | 0.57668 | 21.015 |
| 12 | −44.6483 | DD[12] | | | | 18.406 |
| 13(St) | ∞ | 1.8200 | | | | 13.340 |
| 14 | 24.7582 | 7.8995 | 1.74100 | 52.77 | 0.54714 | 14.298 |
| 15 | 12.2377 | 5.2254 | 1.48749 | 70.39 | 0.53005 | 13.647 |
| 16 | −44.6044 | 0.4213 | | | | 14.029 |
| 17 | −112.8416 | 1.0000 | 1.87070 | 40.73 | 0.56825 | 14.570 |
| 18 | 21.8054 | 7.1503 | 1.43700 | 95.10 | 0.53364 | 15.726 |
| 19 | −15.9289 | 0.5001 | | | | 18.320 |
| *20 | −18.0043 | 1.9611 | 1.58480 | 58.71 | 0.54116 | 19.018 |
| *21 | −247.6080 | 0.1202 | | | | 22.876 |
| 22 | 46.3414 | 6.6637 | 1.49700 | 81.61 | 0.53887 | 26.144 |
| 23 | −33.3740 | DD[23] | | | | 27.255 |
| *24 | −219.4325 | 2.1487 | 1.55836 | 54.01 | 0.54188 | 29.084 |
| *25 | 271.8478 | 1.7784 | | | | 30.357 |
| 26 | −93.2693 | 1.2638 | 1.73400 | 51.01 | 0.54585 | 30.423 |
| 27 | 30.8310 | 13.3638 | 1.54814 | 45.51 | 0.56846 | 34.720 |
| 28 | −39.9742 | DD[28] | | | | 37.668 |
| 29 | ∞ | 3.2000 | 1.51680 | 64.20 | 0.53430 | 83.364 |
| 30 | ∞ | 1.0084 | | | | 85.134 |

TABLE 20
Example 7

| | Infinite | |
|---|---|---|
| | distance | Nearest |
| Lateral | 0.0 | −0.2163 |
| magnification | | |
| Focal length | 31.8313 | 31.3904 |
| Open F-number | 5.77 | 6.06 |
| Maximum full | 107.6 | 103.4 |
| angle of view [°] | | |
| DD[12] | 6.9742 | 3.1292 |
| DD[23] | 1.8475 | 6.0488 |
| DD[28] | 47.2257 | 46.8695 |

TABLE 21
Example 7

| Sn | 1 | 2 | 20 | 21 |
|---|---|---|---|---|
| KA | 1.0000000000E+00 | 1.0000000000E+00 | 1.0000000000E+00 | 1.0000000000E+00 |
| A4 | 6.8460549315E−05 | 7.4515334323E−05 | 6.9388510286E−05 | 6.1659795914E−05 |
| A6 | −3.9421132103E−07 | −3.0939131741E−07 | −1.3077513240E−06 | −9.7390578631E−07 |
| A8 | 1.6766476712E−09 | −3.3064797262E−10 | 1.9103896647E−08 | 4.7346588647E−09 |
| A10 | −5.3110219267E−12 | 1.1728698833E−11 | −3.6119331246E−10 | 1.2497633255E−10 |
| A12 | 1.2010983332E−14 | −7.4049099169E−14 | 9.5231873704E−12 | −3.1914636585E−12 |
| A14 | −1.8731166968E−17 | 2.2374487684E−16 | −1.8137272262E−13 | 3.5298126419E−14 |
| A16 | 1.9139716806E−20 | −3.2031158754E−19 | 2.0224122445E−15 | −2.1621206560E−16 |
| A18 | −1.1542979943E−23 | 1.2417911394E−22 | −1.1909226621E−17 | 7.0966043023E−19 |
| A20 | 3.1163806909E−27 | 9.8766109176E−26 | 2.8829210428E−20 | −9.7555978671E−22 |

| Sn | 24 | 25 |
|---|---|---|
| KA | 1.0000000000E+00 | 1.0000000000E+00 |
| A4 | −2.8715994972E−05 | −2.3909873133E−05 |
| A6 | 4.6535345484E−07 | 4.0040021091E−07 |
| A8 | −5.0739485576E−09 | −3.8687620271E−09 |
| A10 | 3.7156300433E−11 | 2.7687176382E−11 |
| A12 | −1.5328203524E−13 | −1.3426015417E−13 |
| A14 | 1.4745823346E−16 | 3.9696289664E−16 |
| A16 | 1.4375073655E−18 | −6.0847754073E−19 |
| A18 | −5.9481619036E−21 | 2.2006594695E−22 |
| A20 | 7.2059198054E−24 | 3.3812121838E−25 |

### Example 8

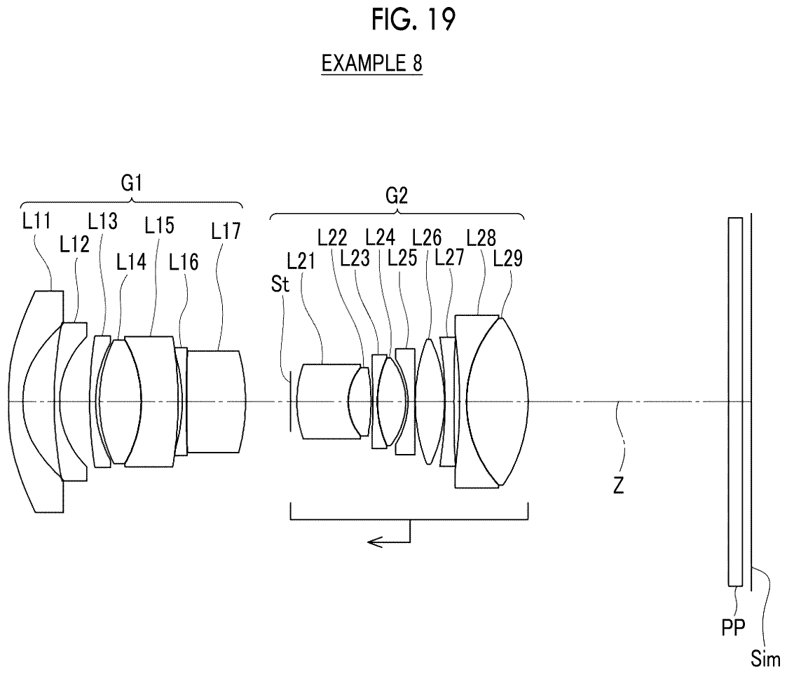

A cross-sectional view of a configuration of an optical system of Example 8 is shown in FIG. 19. The optical system of Example 8 consists of, in order from the object side to the image side, a first lens group G1 that has a negative refractive power and a second lens group G2 that has a positive refractive power. During focusing from the infinite distance object to the nearest object, the first lens group G1 does not move with respect to the image plane Sim, and the second lens group G2 moves toward the object side.

The first lens group G1 consists of, in order from the object side to the image side, seven lenses including lenses L11 to L17. The second lens group G2 consists of, in order from the object side to the image side, an aperture stop St, and nine lenses including lenses L21 to L29.

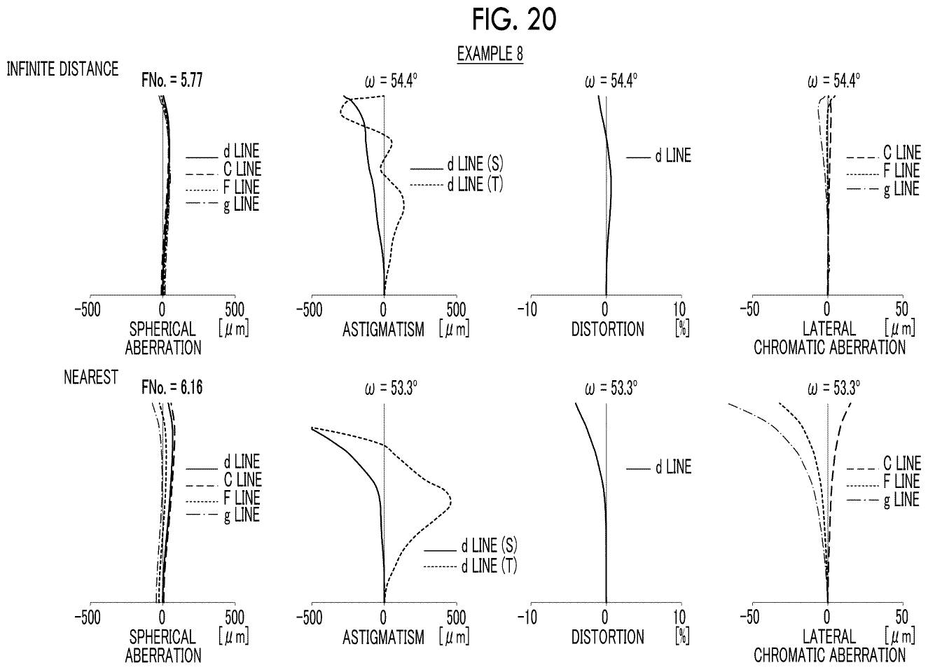

For the optical system of Example 8, basic lens data is shown in Table 22, specifications and variable surface spacings are shown in Table 23, aspherical coefficients are shown in Table 24, and each aberration diagram is shown in FIG. 20.

TABLE 22
Example 8

| Sn | R | D | Nd | νd | θgF | ED |
|---|---|---|---|---|---|---|
| *1 | 158.6206 | 3.3100 | 1.58480 | 58.71 | 0.54116 | 48.353 |
| *2 | 24.0865 | 7.2093 | | | | 35.726 |
| 3 | 93.5312 | 1.2249 | 1.69680 | 55.53 | 0.54420 | 36.068 |
| 4 | 20.9271 | 6.9346 | | | | 29.840 |
| 5 | 96.6366 | 1.3462 | 1.49700 | 81.60 | 0.53774 | 28.852 |
| 6 | 28.3100 | 0.8782 | | | | 27.100 |
| 7 | 32.2676 | 9.6405 | 1.65412 | 39.68 | 0.57378 | 27.043 |
| 8 | −28.4307 | 8.4466 | 1.84666 | 23.84 | 0.62012 | 25.412 |
| 9 | −90.7840 | 0.9329 | | | | 22.515 |
| 10 | −38.7448 | 1.0102 | 1.48749 | 70.44 | 0.53062 | 22.548 |
| 11 | 439.9463 | 13.4052 | 1.90043 | 37.37 | 0.57668 | 21.800 |
| 12 | −44.4126 | DD[12] | | | | 19.140 |
| 13(St) | ∞ | 1.4567 | | | | 13.765 |
| 14 | 25.7717 | 11.7826 | 1.72916 | 54.09 | 0.54490 | 14.489 |
| 15 | 12.1392 | 5.2592 | 1.49700 | 81.54 | 0.53748 | 13.585 |
| 16 | −42.9905 | 0.4637 | | | | 13.980 |
| 17 | −111.6349 | 1.0000 | 1.75500 | 52.32 | 0.54758 | 14.620 |
| 18 | 24.5546 | 6.5141 | 1.43700 | 95.10 | 0.53364 | 15.899 |
| 19 | −16.1529 | 0.5275 | | | | 17.950 |
| *20 | −17.3999 | 1.5560 | 1.69679 | 56.18 | 0.53954 | 18.438 |
| *21 | −239.5563 | 0.1294 | | | | 21.776 |
| 22 | 40.4270 | 6.6890 | 1.49700 | 81.61 | 0.53887 | 25.551 |
| 23 | −34.2084 | 0.1200 | | | | 26.664 |
| *24 | −103.8047 | 2.0523 | 1.53775 | 74.70 | 0.53936 | 27.490 |
| *25 | 289.8878 | 1.3178 | | | | 28.896 |
| 26 | −120.7112 | 1.6020 | 1.83481 | 42.72 | 0.56514 | 28.948 |
| 27 | 28.5939 | 14.1379 | 1.58272 | 46.64 | 0.56688 | 32.792 |
| 28 | −34.6726 | DD[28] | | | | 36.500 |
| 29 | ∞ | 3.2000 | 1.51680 | 64.20 | 0.53430 | 82.680 |
| 30 | ∞ | 0.9989 | | | | 84.370 |

TABLE 23
Example 8

| | Infinite | |
|---|---|---|
| | distance | Nearest |
| Lateral | 0.0 | −0.2272 |
| magnification | | |
| Focal length | 31.1079 | 31.4906 |
| Open F-number | 5.77 | 6.16 |
| Maximum full | 108.8 | 106.6 |
| angle of view [°] | | |
| DD[12] | 10.3530 | 3.1435 |
| DD[28] | 45.9429 | 53.1524 |

TABLE 24
Example 8

| Sn | 1 | 2 | 20 | 21 |
|---|---|---|---|---|
| KA | 1.0000000000E+00 | 1.0000000000E+00 | 1.0000000000E+00 | 1.0000000000E+00 |
| A4 | 6.7316851212E−05 | 7.5811744180E−05 | 9.1147050212E−05 | 9.4521297123E−05 |
| A6 | −3.6228571178E−07 | −3.2474247682E−07 | −2.3383162033E−06 | −2.2087957789E−06 |
| A8 | 1.2754114448E−09 | 2.4226725454E−10 | 2.8088642874E−08 | 2.0437238319E−08 |
| A10 | −3.0384586070E−12 | −2.2479137964E−12 | 1.0602959280E−11 | 2.0530695809E−10 |
| A12 | 4.8850117564E−15 | 6.3169736692E−14 | −3.7689169991E−12 | −8.3778350297E−12 |
| A14 | −5.3319099886E−18 | −4.5961123731E−16 | 1.6967308078E−14 | 1.0973831199E−13 |
| A16 | 4.0572613845E−21 | 1.5600397047E−18 | 4.5795446864E−16 | −7.6439552608E−16 |
| A18 | −2.1746641758E−24 | −2.6212284115E−21 | −5.9690358567E−18 | 2.8173907638E−18 |
| A20 | 6.5203601802E−28 | 1.7670693257E−24 | 2.2040189337E−20 | −4.3043664622E−21 |

| Sn | 24 | 25 |
|---|---|---|
| KA | 1.0000000000E+00 | 1.0000000000E+00 |
| A4 | −8.2523219670E−06 | −1.1689369043E−05 |
| A6 | 4.0720652829E−07 | 3.9154844300E−07 |
| A8 | −2.2526871608E−08 | −1.4836119775E−08 |
| A10 | 4.8758596297E−10 | 2.8148027313E−10 |
| A12 | −5.5800668375E−12 | −2.9144611991E−12 |
| A14 | 3.7942911107E−14 | 1.8008708497E−14 |
| A16 | −1.5480728876E−16 | −6.6722875466E−17 |
| A18 | 3.4997188552E−19 | 1.3679168498E−19 |
| A20 | −3.3641096995E−22 | −1.1916197492E−22 |

### Example 9

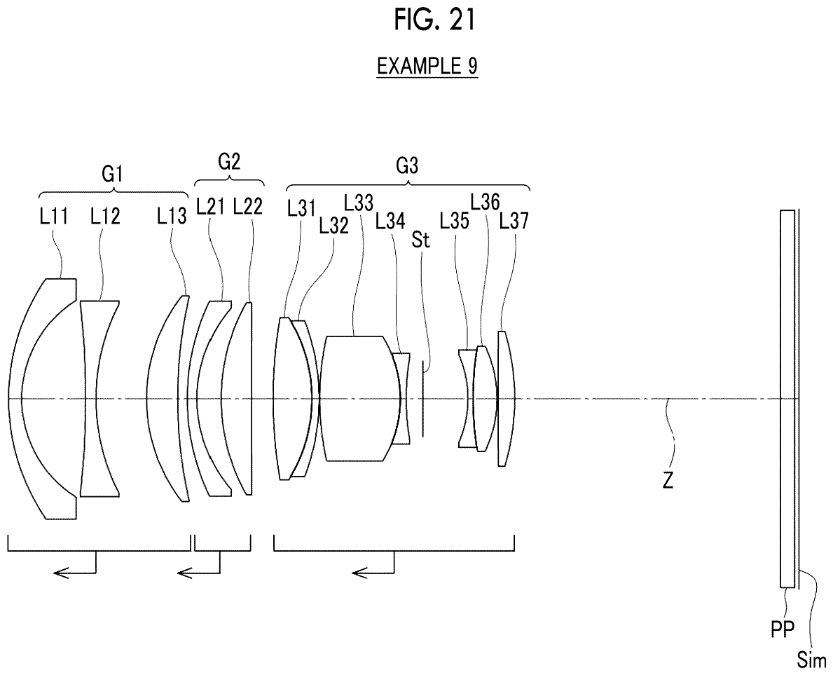

A cross-sectional view of a configuration of an optical system of Example 9 is shown in FIG. 21. The optical system of Example 9 consists of, in order from the object side to the image side, a first lens group G1 that has a negative refractive power, a second lens group G2 that has a positive refractive power, and a third lens group G3 that has a positive refractive power. During focusing from the infinite distance object to the nearest object, the first lens group G1, the second lens group G2, and the third lens group G3 move toward the object side by changing the spacings between the adjacent lens groups.

The first lens group G1 consists of, in order from the object side to the image side, three lenses including lenses L11 to L13. The second lens group G2 consists of, in order from the object side to the image side, two lenses including lenses L21 and L22. The third lens group G3 consists of, in order from the object side to the image side, lenses L31 to L34, an aperture stop St, and lenses L35 to L37.

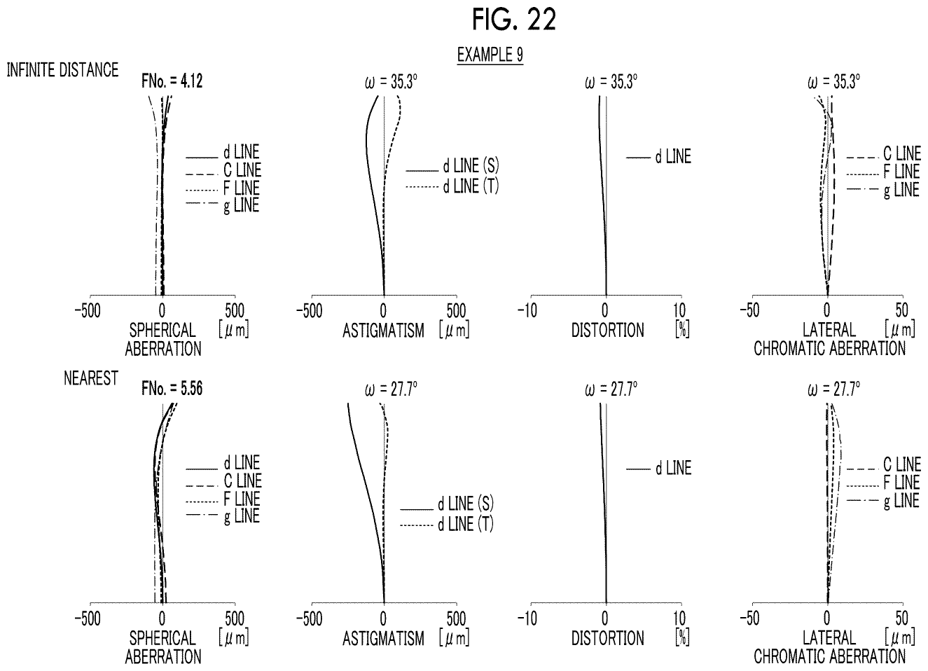

For the optical system of Example 9, basic lens data is shown in Table 25, specifications and variable surface spacings are shown in Table 26, and each aberration diagram is shown in FIG. 22.

TABLE 25
Example 9

| Sn | R | D | Nd | νd | θgF | ED |
|---|---|---|---|---|---|---|
| 1 | 48.4932 | 3.0000 | 1.88300 | 40.76 | 0.56679 | 54.733 |
| 2 | 26.5785 | 14.6660 | | | | 45.013 |
| 3 | −196.4717 | 2.4000 | 1.48749 | 70.24 | 0.53007 | 44.668 |
| 4 | 47.2583 | 11.5761 | | | | 43.217 |
| 5 | 38.0331 | 7.1649 | 1.59522 | 67.73 | 0.54426 | 47.096 |
| 6 | 104.7665 | DD[6] | | | | 46.440 |
| 7 | 51.4023 | 2.2000 | 1.89286 | 20.36 | 0.63944 | 44.648 |
| 8 | 31.7166 | 5.4172 | | | | 41.514 |
| 9 | 44.4751 | 6.9668 | 1.85896 | 22.73 | 0.62844 | 42.250 |
| 10 | 3679.3164 | DD[10] | | | | 41.635 |
| 11 | 108.7660 | 8.8968 | 1.49700 | 81.54 | 0.53748 | 37.090 |
| 12 | −34.9342 | 1.6500 | 1.88300 | 40.76 | 0.56679 | 35.706 |
| 13 | −49.4704 | 0.1500 | | | | 35.166 |
| 14 | 65.0105 | 18.4907 | 1.59522 | 67.73 | 0.54426 | 28.600 |
| 15 | −27.1687 | 1.3600 | 1.67270 | 32.10 | 0.59891 | 20.701 |
| 16 | 57.2303 | 3.8353 | | | | 18.847 |
| 17(St) | ∞ | 10.3228 | | | | 17.267 |
| 18 | −25.1772 | 1.2000 | 1.95375 | 32.32 | 0.59056 | 19.851 |
| 19 | 73.5726 | 5.4857 | 1.49700 | 81.54 | 0.53748 | 22.245 |
| 20 | −27.6977 | 0.2000 | | | | 24.000 |
| 21 | 917.6813 | 3.8686 | 1.96300 | 24.11 | 0.62126 | 29.819 |
| 22 | −53.2481 | DD[22] | | | | 30.876 |
| 23 | ∞ | 3.2000 | 1.51680 | 64.20 | 0.53430 | 84.892 |
| 24 | ∞ | 1.0034 | | | | 86.114 |

TABLE 26
Example 9

| | Infinite | |
|---|---|---|
| | distance | Nearest |
| Lateral | 0.0 | −0.5000 |
| magnification | | |
| Focal length | 61.8299 | 61.4913 |
| Open F-number | 4.12 | 5.56 |
| Maximum full | 70.6 | 55.4 |
| angle of view [°] | | |
| DD[6] | 2.2003 | 2.2665 |
| DD[10] | 4.9692 | 1.2976 |
| DD[22] | 60.8841 | 91.6651 |

### Example 10

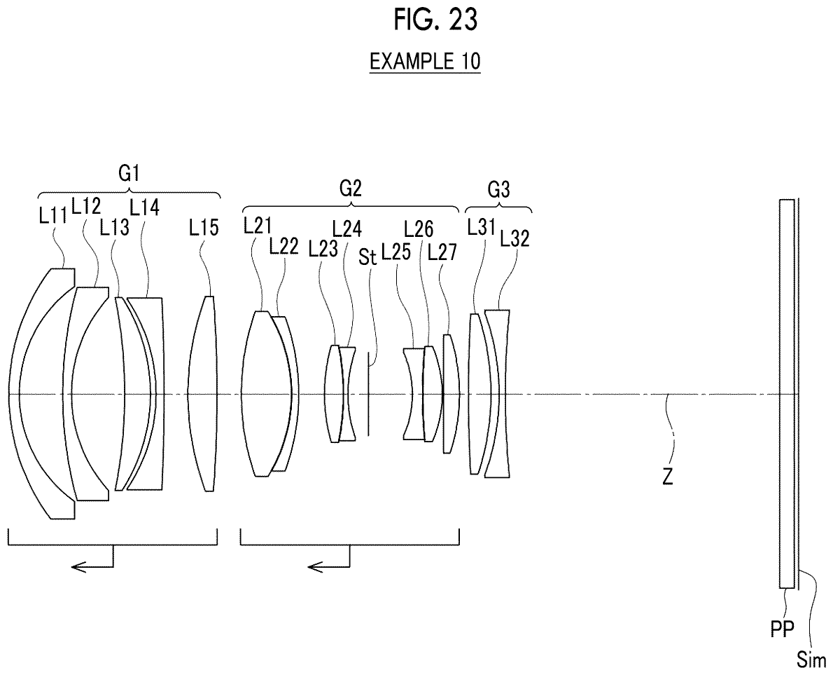

A cross-sectional view of a configuration of an optical system of Example 10 is shown in FIG. 23. The optical system of Example 10 consists of, in order from the object side to the image side, a first lens group G1 that has a negative refractive power, a second lens group G2 that has a positive refractive power, and a third lens group G3 that has a negative refractive power. During focusing from the infinite distance object to the nearest object, the first lens group G1 and the second lens group G2 move toward the object side by changing the mutual spacing therebetween, and the third lens group G3 does not move with respect to the image plane Sim.

The first lens group G1 consists of, in order from the object side to the image side, five lenses including lenses L11 to L15. The second lens group G2 consists of, in order from the object side to the image side, lenses L21 to L24, an aperture stop St, and lenses L25 to L27. The third lens group G3 consists of, in order from the object side to the image side, two lenses including lenses L31 and L32.

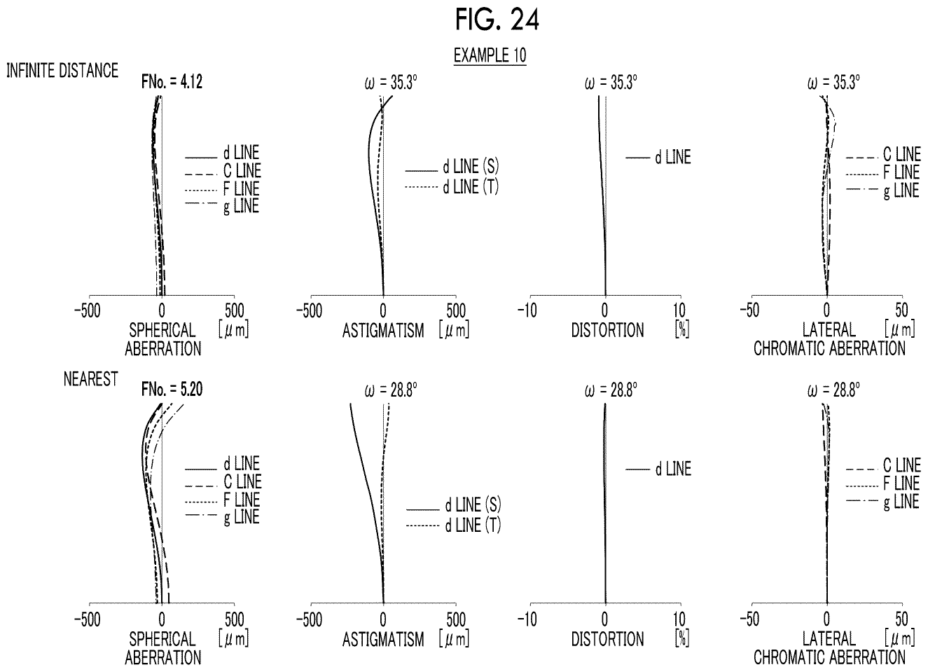

For the optical system of Example 10, basic lens data is shown in Table 27, specifications and variable surface spacings are shown in Table 28, and each aberration diagram is shown in FIG. 24.

TABLE 27
Example 10

| Sn | R | D | Nd | νd | θgF | ED |
|---|---|---|---|---|---|---|
| 1 | 45.7317 | 2.3000 | 1.85013 | 30.06 | 0.60009 | 55.197 |
| 2 | 29.0724 | 9.6716 | | | | 47.451 |
| 3 | 88.3986 | 1.9500 | 1.49782 | 82.57 | 0.53862 | 47.057 |
| 4 | 31.7441 | 11.8632 | | | | 42.658 |
| 5 | −106.5711 | 5.7059 | 1.50805 | 61.04 | 0.53683 | 42.485 |
| 6 | −39.0984 | 1.2620 | | | | 42.579 |
| 7 | −37.2119 | 1.8000 | 1.49700 | 81.61 | 0.53804 | 41.815 |
| 8 | −453.4303 | 5.3137 | | | | 42.380 |
| 9 | 60.9721 | 6.4726 | 1.76182 | 26.53 | 0.61224 | 42.993 |
| 10 | −290.5546 | DD[10] | | | | 42.482 |
| 11 | 55.3665 | 11.1743 | 1.49700 | 81.61 | 0.53804 | 36.433 |
| 12 | −34.1350 | 1.6000 | 1.90366 | 31.32 | 0.59538 | 34.075 |
| 13 | −49.1860 | 5.7504 | | | | 33.400 |
| 14 | 38.7437 | 4.2224 | 1.55032 | 75.50 | 0.54001 | 21.298 |
| 15 | −52.0564 | 1.0000 | 1.62004 | 36.27 | 0.58248 | 20.511 |
| 16 | 29.2860 | 4.5678 | | | | 19.012 |
| 17(St) | ∞ | 9.7776 | | | | 18.285 |
| 18 | −22.3529 | 2.1509 | 1.91650 | 31.60 | 0.59117 | 18.148 |
| 19 | 115.0773 | 4.3387 | 1.49700 | 81.61 | 0.53804 | 19.998 |
| 20 | −26.1947 | 0.2532 | | | | 21.000 |
| 21 | 6867.2572 | 3.5738 | 2.00100 | 29.13 | 0.59952 | 25.186 |
| 22 | −42.2487 | DD[22] | | | | 26.192 |
| 23 | 310.2256 | 5.0324 | 1.80610 | 33.27 | 0.59233 | 34.900 |
| 24 | −55.2948 | 1.8022 | | | | 35.353 |
| 25 | −51.3998 | 1.4000 | 1.83400 | 37.18 | 0.57780 | 35.290 |
| 26 | 188.9578 | 61.0984 | | | | 36.956 |
| 27 | ∞ | 3.2000 | 1.51680 | 64.20 | 0.53430 | 84.323 |
| 28 | ∞ | 1.0010 | | | | 85.929 |

TABLE 28
Example 10

| | Infinite | |
|---|---|---|
| | distance | Nearest |
| Lateral | 0.0 | −0.5001 |
| magnification | | |
| Focal length | 61.8119 | 57.6858 |
| Open F-number | 4.12 | 5.20 |
| Maximum full | 70.6 | 57.6 |
| angle of view [°] | | |
| DD[10] | 5.4107 | 2.0334 |
| DD[22] | 2.0000 | 25.9294 |

### Example 11

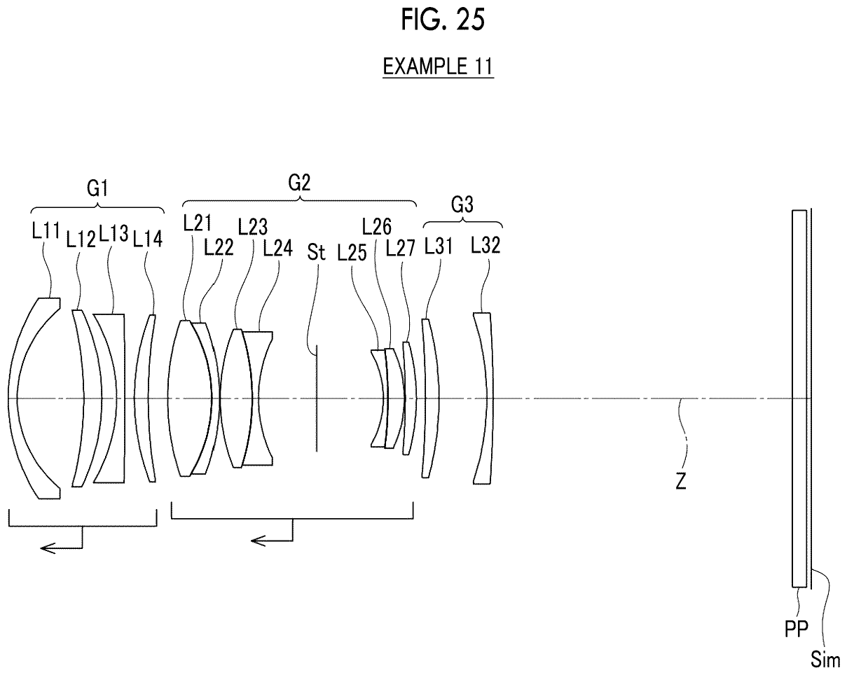

A cross-sectional view of a configuration of an optical system of Example 11 is shown in FIG. 25. The optical system of Example 11 consists of, in order from the object side to the image side, a first lens group G1 that has a negative refractive power, a second lens group G2 that has a positive refractive power, and a third lens group G3 that has a negative refractive power. During focusing from the infinite distance object to the nearest object, the first lens group G1 and the second lens group G2 move toward the object side by changing the mutual spacing therebetween, and the third lens group G3 does not move with respect to the image plane Sim.

The first lens group G1 consists of, in order from the object side to the image side, four lenses including lenses L11 to L14. The second lens group G2 consists of, in order from the object side to the image side, lenses L21 to L24, an aperture stop St, and lenses L25 to L27. The third lens group G3 consists of, in order from the object side to the image side, two lenses including lenses L31 and L32.

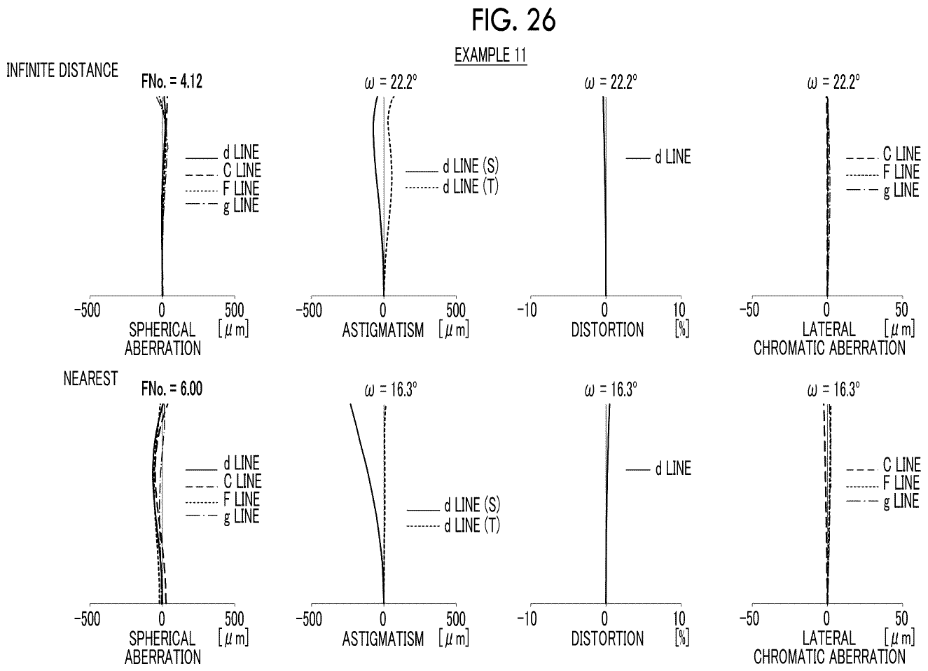

For the optical system of Example 11, basic lens data is shown in Table 29, specifications and variable surface spacings are shown in Table 30, and each aberration diagram is shown in FIG. 26.

TABLE 29
Example 11

| Sn | R | D | Nd | νd | θgF | ED |
|---|---|---|---|---|---|---|
| 1 | 42.4548 | 2.0000 | 1.61339 | 44.12 | 0.56352 | 45.848 |
| 2 | 27.1138 | 14.7226 | | | | 41.174 |
| 3 | −78.9837 | 4.0000 | 1.72916 | 54.68 | 0.54484 | 40.254 |
| 4 | −48.1710 | 3.2563 | | | | 40.319 |
| 5 | −38.5852 | 1.8000 | 1.49700 | 81.61 | 0.53804 | 38.491 |
| 6 | −1335.3675 | 2.1404 | | | | 38.326 |
| 7 | 54.8714 | 3.0652 | 1.80000 | 29.84 | 0.60178 | 38.038 |
| 8 | 111.7042 | DD[8] | | | | 37.596 |
| 9 | 58.0613 | 9.7341 | 1.49700 | 81.61 | 0.53804 | 35.608 |
| 10 | −34.8981 | 1.6000 | 1.78799 | 47.47 | 0.55346 | 34.536 |
| 11 | −51.2168 | 0.1500 | | | | 34.000 |
| 12 | 44.8552 | 7.0742 | 1.52841 | 76.45 | 0.53954 | 31.582 |
| 13 | −53.3336 | 1.3700 | 1.54072 | 47.23 | 0.56556 | 30.545 |
| 14 | 31.5435 | 12.9304 | | | | 27.130 |
| 15(St) | ∞ | 14.7186 | | | | 24.287 |
| 16 | −21.9553 | 1.0000 | 1.73800 | 32.26 | 0.58963 | 21.158 |
| 17 | −95.7084 | 3.6403 | 1.49700 | 81.61 | 0.53804 | 22.134 |
| 18 | −27.3713 | 0.2000 | | | | 22.728 |
| 19 | −150.1905 | 2.4674 | 2.00100 | 29.13 | 0.59935 | 24.953 |
| 20 | −48.6884 | DD[20] | | | | 25.668 |
| 21 | −210.1766 | 3.0000 | 1.60342 | 38.01 | 0.58283 | 35.798 |
| 22 | −71.9110 | 10.5813 | | | | 36.213 |
| 23 | −61.6967 | 1.4000 | 1.76801 | 49.24 | 0.55280 | 37.688 |
| 24 | −273.0283 | 66.0440 | | | | 39.000 |
| 25 | ∞ | 3.2000 | 1.51680 | 64.20 | 0.53430 | 84.622 |
| 26 | ∞ | 0.9975 | | | | 86.017 |

TABLE 30
Example 11

| | Infinite | |
|---|---|---|
| | distance | Nearest |
| Lateral | 0.0 | −0.5001 |
| magnification | | |
| Focal length | 106.7003 | 92.8225 |
| Open F-number | 4.12 | 6.00 |
| Maximum full | 44.4 | 32.6 |
| angle of view [°] | | |
| DD[8] | 4.3031 | 3.1059 |
| DD[20] | 2.0000 | 39.9472 |

### Example 12

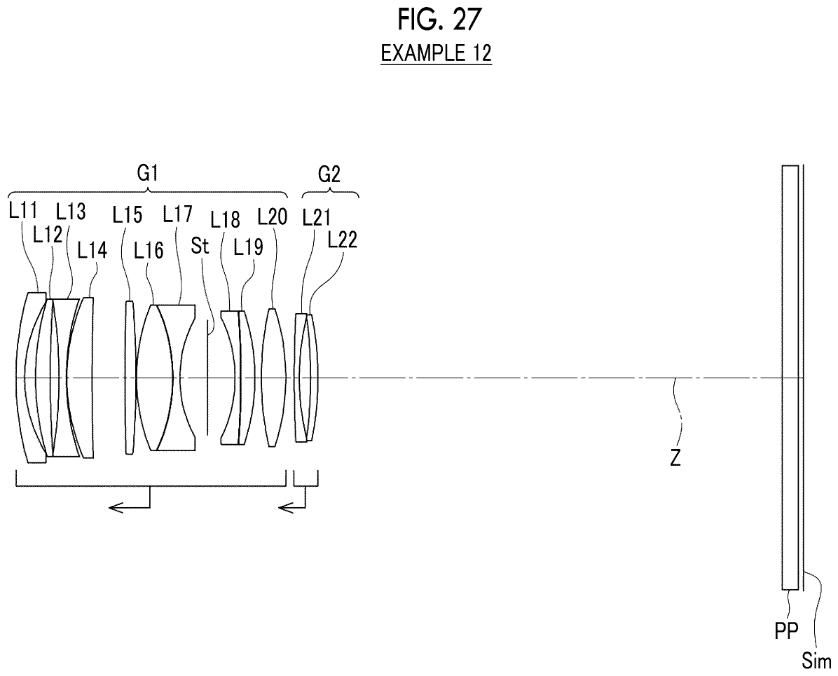

A cross-sectional view of a configuration of an optical system of Example 12 is shown in FIG. 27. The optical system of Example 12 consists of, in order from the object side to the image side, a first lens group G1 that has a positive refractive power and a second lens group G2 that has a negative refractive power. During focusing from the infinite distance object to the nearest object, the first lens group G1 and the second lens group G2 move toward the object side by changing the mutual spacing therebetween.

The first lens group G1 consists of, in order from the object side to the image side, lenses L11 to L17, an aperture stop St, and lenses L18 to L20. The second lens group G2 consists of, in order from the object side to the image side, two lenses including lenses L21 and L22.

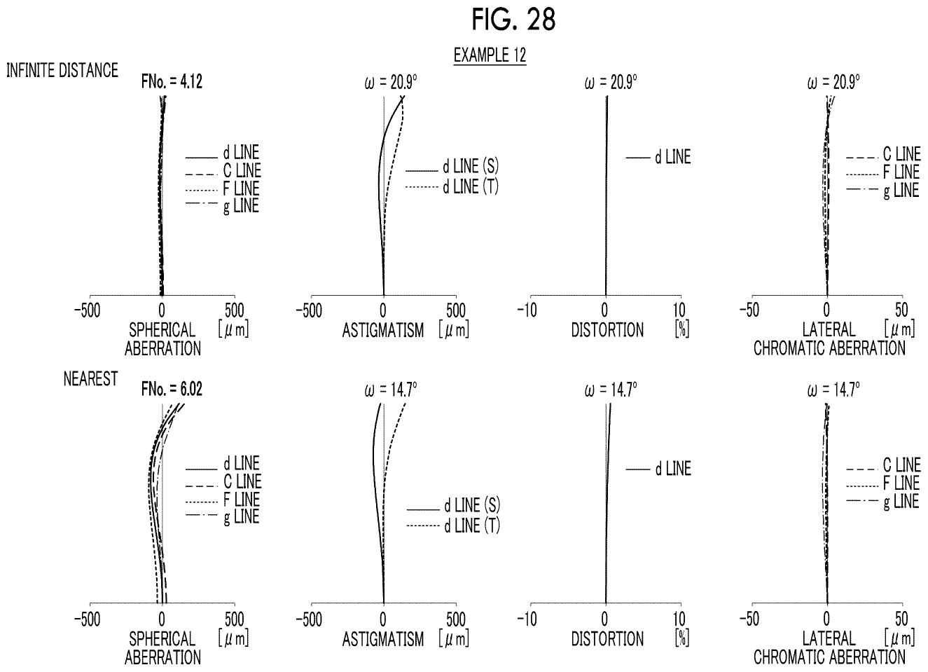

For the optical system of Example 12, basic lens data is shown in Table 31, specifications and variable surface spacings are shown in Table 32, and each aberration diagram is shown in FIG. 28.

TABLE 31
Example 12

| Sn | R | D | Nd | νd | θgF | ED |
|---|---|---|---|---|---|---|
| 1 | 65.3621 | 1.7000 | 1.54793 | 46.01 | 0.56815 | 32.496 |
| 2 | 30.1051 | 2.1545 | | | | 30.035 |
| 3 | 56.9515 | 2.9082 | 1.73308 | 54.69 | 0.54435 | 29.971 |
| 4 | 245.9414 | 1.7280 | | | | 29.844 |
| 5 | −98.1753 | 1.4500 | 1.68049 | 31.39 | 0.60065 | 29.835 |
| 6 | 51.5932 | 0.1000 | | | | 30.233 |
| 7 | 41.7092 | 5.0000 | 2.00069 | 25.46 | 0.61364 | 30.699 |
| 8 | 626.5689 | 6.4591 | | | | 30.422 |
| 9 | 552.8109 | 2.1879 | 1.90366 | 31.32 | 0.59394 | 29.158 |
| 10 | −189.0878 | 0.1000 | | | | 28.977 |
| 11 | 40.3237 | 7.1558 | 1.57230 | 71.62 | 0.54243 | 27.764 |
| 12 | −35.9447 | 1.4000 | 1.63815 | 34.80 | 0.59171 | 26.677 |
| 13 | 25.9928 | 5.4850 | | | | 23.627 |
| 14(St) | ∞ | 5.4345 | | | | 23.357 |
| 15 | −28.1832 | 1.1100 | 1.51599 | 55.23 | 0.55147 | 23.517 |
| 16 | −199.5573 | 2.7982 | 1.64058 | 59.47 | 0.54298 | 24.744 |
| 17 | −43.8068 | 1.2698 | | | | 25.234 |
| 18 | 66.2206 | 4.8260 | 1.53886 | 75.18 | 0.53981 | 26.229 |
| 19 | −46.2735 | DD[19] | | | | 26.232 |
| 20 | 304.4169 | 1.0000 | 1.71210 | 55.89 | 0.54369 | 23.923 |
| 21 | 52.8571 | 2.2258 | | | | 23.365 |
| 22 | −95.4745 | 1.4520 | 1.90000 | 22.35 | 0.63109 | 23.337 |
| 23 | −66.3044 | DD[23] | | | | 23.388 |
| 24 | ∞ | 3.2000 | 1.51680 | 64.20 | 0.53430 | 85.300 |
| 25 | ∞ | 1.0085 | | | | 86.238 |

TABLE 32
Example 12

| | Infinite | |
|---|---|---|
| | distance | Nearest |
| Lateral | 0.0 | −0.5001 |
| magnification | | |
| Focal length | 113.3109 | 108.8706 |
| Open F-number | 4.12 | 6.02 |
| Maximum full | 41.8 | 29.4 |
| angle of view [°] | | |
| DD[19] | 1.6676 | 5.3400 |
| DD[23] | 91.5056 | 136.1175 |

### Example 13

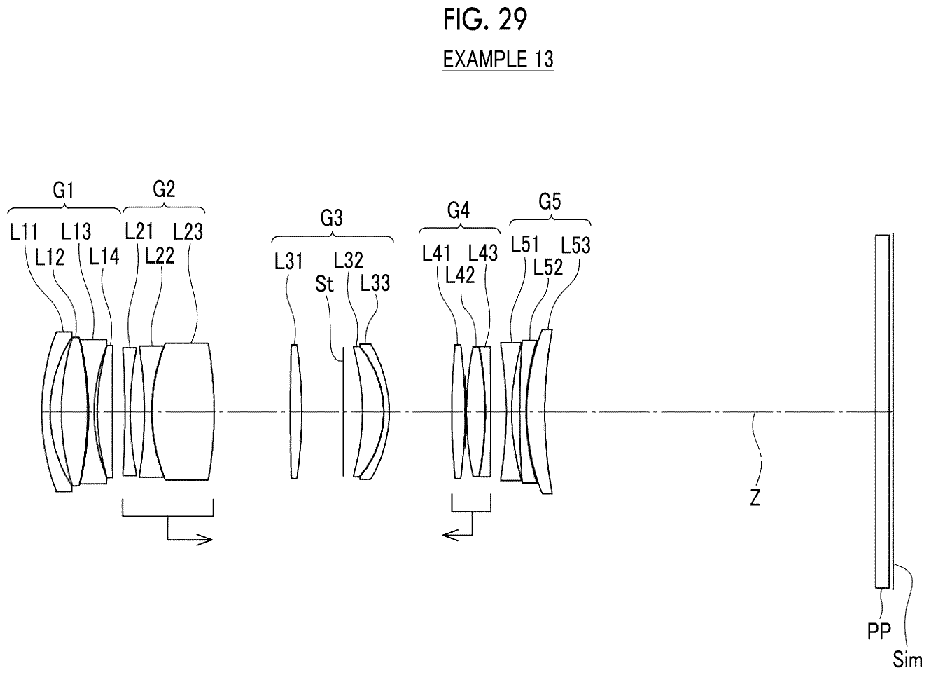

A cross-sectional view of a configuration of an optical system of Example 13 is shown in FIG. 29. The optical system of Example 13 consists of, in order from the object side to the image side, a first lens group G1 that has a positive refractive power, a second lens group G2 that has a negative refractive power, a third lens group G3 that has a positive refractive power, a fourth lens group G4 that has a positive refractive power, and a fifth lens group G5 that has a negative refractive power. During focusing from the infinite distance object to the nearest object, the first lens group G1, the third lens group G3, and the fifth lens group G5 do not move with respect to the image plane Sim, the second lens group G2 moves toward the image side, and the fourth lens group G4 moves toward the object side.

The first lens group G1 consists of, in order from the object side to the image side, four lenses including lenses L11 to L14. The second lens group G2 consists of, in order from the object side to the image side, three lenses including lenses L21 to L23. The third lens group G3 consists of, in order from the object side to the image side, a lens L31, an aperture stop St, and lenses L32 and L33. The fourth lens group G4 consists of, in order from the object side to the image side, three lenses including lenses L41 to L43. The fifth lens group G5 consists of, in order from the object side to the image side, three lenses including lenses L51 to L53.

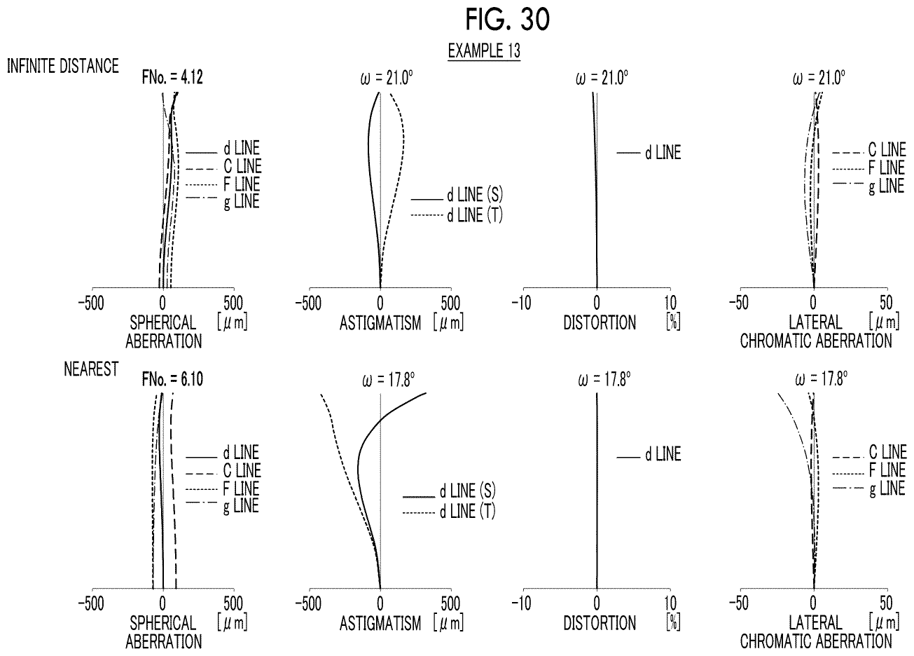

For the optical system of Example 13, basic lens data is shown in Table 33, specifications and variable surface spacings are shown in Table 34, and each aberration diagram is shown in FIG. 30.

TABLE 33
Example 13

| Sn | R | D | Nd | νd | θgF | ED |
|---|---|---|---|---|---|---|
| 1 | 56.1192 | 2.0000 | 1.74950 | 35.33 | 0.58189 | 38.901 |
| 2 | 34.7988 | 2.6415 | | | | 36.183 |
| 3 | 63.5073 | 6.2120 | 1.56907 | 71.30 | 0.54432 | 36.100 |
| 4 | −81.4757 | 0.2597 | | | | 35.275 |
| 5 | −75.5421 | 1.3000 | 1.56732 | 42.82 | 0.57309 | 35.123 |
| 6 | 44.6045 | 0.7539 | | | | 32.075 |
| 7 | 56.5619 | 3.5406 | 1.91082 | 35.28 | 0.58342 | 32.047 |
| 8 | 1446.5581 | DD[8] | | | | 31.460 |
| 9 | −257.2730 | 1.3000 | 1.60801 | 46.20 | 0.56807 | 30.965 |
| 10 | 81.2723 | 3.3420 | | | | 30.707 |
| 11 | −102.6852 | 1.7640 | 1.74950 | 35.33 | 0.58189 | 30.784 |
| 12 | 44.9099 | 14.7767 | 1.85026 | 32.30 | 0.59311 | 31.903 |
| 13 | −98.6566 | DD[13] | | | | 33.330 |
| 14 | 512.9031 | 2.6987 | 1.49700 | 81.61 | 0.53804 | 32.563 |
| 15 | −111.4263 | 9.8978 | | | | 32.555 |
| 16(St) | ∞ | 4.5030 | | | | 31.244 |
| 17 | −56.9828 | 5.0453 | 1.53172 | 48.84 | 0.56623 | 31.301 |
| 18 | −24.7785 | 1.3000 | 1.87070 | 40.73 | 0.56825 | 31.628 |
| 19 | −32.6075 | DD[19] | | | | 32.796 |
| 20 | 166.1857 | 3.1680 | 1.61800 | 63.34 | 0.54111 | 32.494 |
| 21 | −122.1801 | 0.1500 | | | | 32.386 |
| 22 | 81.4883 | 4.4297 | 1.49700 | 81.61 | 0.53804 | 31.536 |
| 23 | −85.9301 | 1.3000 | 1.84666 | 23.83 | 0.61603 | 31.526 |
| 24 | −1299.9000 | DD[24] | | | | 31.703 |
| 25 | −101.0631 | 1.3000 | 1.59551 | 38.77 | 0.57699 | 32.575 |
| 26 | 61.1155 | 1.8814 | | | | 33.449 |
| 27 | 248.7335 | 1.5000 | 1.64769 | 33.79 | 0.59393 | 33.528 |
| 28 | 60.1381 | 0.1500 | | | | 34.723 |
| 29 | 55.7882 | 4.3089 | 1.94595 | 17.99 | 0.65565 | 35.254 |
| 30 | 114.9925 | 78.4157 | | | | 35.681 |
| 31 | ∞ | 3.2000 | 1.51680 | 64.20 | 0.53430 | 84.772 |
| 32 | ∞ | 0.9866 | | | | 86.083 |

TABLE 34
Example 13

| | Infinite | |
|---|---|---|
| | distance | Nearest |
| Lateral | 0.0 | −0.5001 |
| magnification | | |
| Focal length | 113.2913 | 83.4817 |
| Open F-number | 4.12 | 6.10 |
| Maximum full | 42.1 | 35.6 |
| angle of view [°] | | |
| DD[8] | 2.9838 | 19.0588 |
| DD[13] | 18.0561 | 1.9811 |
| DD[19] | 14.8318 | 1.9128 |
| DD[24] | 3.6865 | 16.6055 |

### Example 14

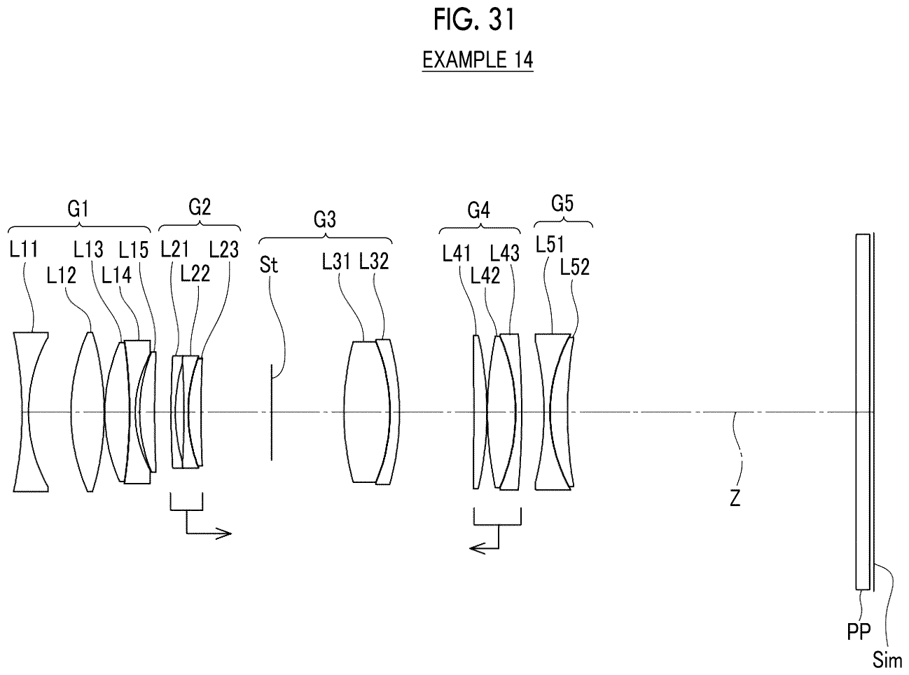

A cross-sectional view of a configuration of an optical system of Example 14 is shown in FIG. 31. The optical system of Example 14 consists of, in order from the object side to the image side, a first lens group G1 that has a positive refractive power, a second lens group G2 that has a negative refractive power, a third lens group G3 that has a positive refractive power, a fourth lens group G4 that has a positive refractive power, and a fifth lens group G5 that has a negative refractive power. During focusing from the infinite distance object to the nearest object, the first lens group G1, the third lens group G3, and the fifth lens group G5 do not move with respect to the image plane Sim, the second lens group G2 moves toward the image side, and the fourth lens group G4 moves toward the object side.

The first lens group G1 consists of, in order from the object side to the image side, five lenses including lenses L11 to L15. The second lens group G2 consists of, in order from the object side to the image side, three lenses including lenses L21 to L23. The third lens group G3 consists of, in order from the object side to the image side, an aperture stop St, and two lenses including lenses L31 and L32. The fourth lens group G4 consists of, in order from the object side to the image side, three lenses including lenses L41 to L43. The fifth lens group G5 consists of, in order from the object side to the image side, two lenses including lenses L51 and L52.

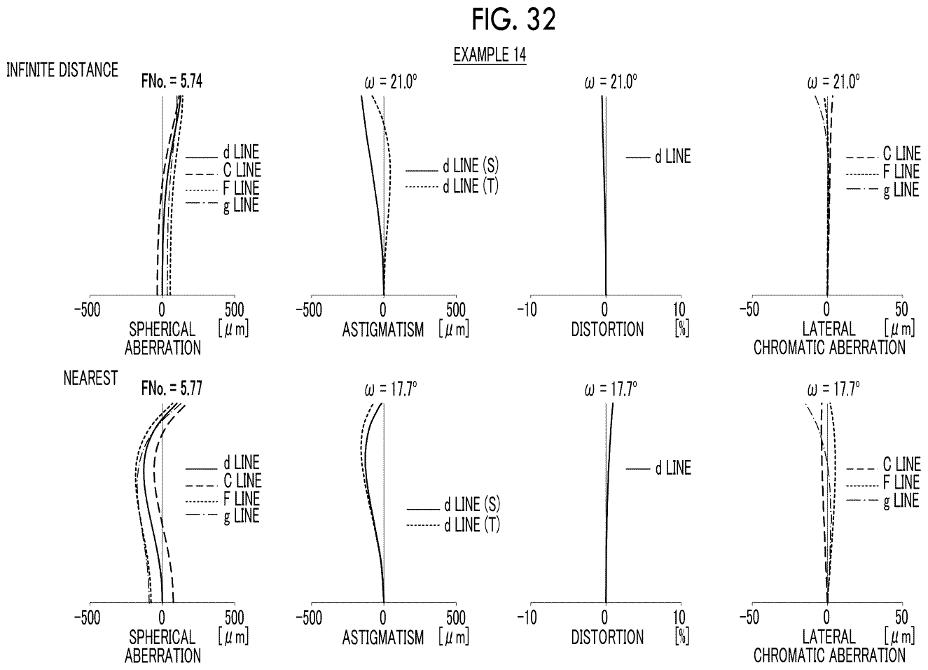

For the optical system of Example 14, basic lens data is shown in Table 35, specifications and variable surface spacings are shown in Table 36, and each aberration diagram is shown in FIG. 32.

TABLE 35
Example 14

| Sn | R | D | Nd | νd | θgF | ED |
|---|---|---|---|---|---|---|
| 1 | −93.6078 | 1.5000 | 1.57402 | 59.60 | 0.54328 | 37.758 |
| 2 | 37.7298 | 10.0000 | | | | 35.443 |
| 3 | 49.3466 | 7.8069 | 1.59283 | 68.63 | 0.54286 | 36.702 |
| 4 | −69.1142 | 0.1500 | | | | 36.314 |
| 5 | 42.2202 | 5.8359 | 1.49700 | 81.54 | 0.53748 | 32.114 |
| 6 | −121.0809 | 1.3000 | 1.65412 | 39.68 | 0.57378 | 30.839 |
| 7 | 29.4332 | 1.0485 | | | | 27.207 |
| 8 | 39.0353 | 3.5262 | 1.78126 | 49.87 | 0.54943 | 27.146 |
| 9 | 303.6085 | DD[9] | | | | 26.388 |
| 10 | 239.1755 | 1.0000 | 1.89398 | 35.30 | 0.58326 | 24.581 |
| 11 | 45.0989 | 2.0280 | | | | 23.998 |
| 12 | −245.1254 | 1.0100 | 1.49700 | 81.54 | 0.53748 | 23.999 |
| 13 | 38.7442 | 3.0163 | 1.77906 | 26.05 | 0.61477 | 24.132 |
| 14 | 283.6087 | DD[14] | | | | 24.037 |
| 15(St) | ∞ | 17.0000 | | | | 23.060 |
| 16 | 67.4204 | 10.8625 | 1.49700 | 81.54 | 0.53748 | 30.600 |
| 17 | −44.8796 | 2.2000 | 1.66573 | 58.21 | 0.54266 | 32.225 |
| 18 | −67.7657 | DD[18] | | | | 33.212 |
| 19 | −2347.7341 | 3.0575 | 1.73000 | 55.00 | 0.54409 | 34.975 |
| 20 | −84.6296 | 0.1500 | | | | 35.124 |
| 21 | 92.8954 | 6.6312 | 1.49700 | 81.54 | 0.53748 | 34.726 |
| 22 | −46.8475 | 1.4000 | 1.90000 | 34.16 | 0.58639 | 34.383 |
| 23 | −217.4239 | DD[23] | | | | 34.448 |
| 24 | −72.0375 | 1.4155 | 1.88326 | 39.67 | 0.57132 | 33.043 |
| 25 | 38.8499 | 4.0670 | 1.90000 | 26.08 | 0.61299 | 34.196 |
| 26 | 110.0953 | 67.9144 | | | | 34.407 |
| 27 | ∞ | 3.2000 | 1.51680 | 64.20 | 0.53430 | 84.426 |
| 28 | ∞ | 0.9439 | | | | 85.949 |

TABLE 36
Example 14

| | Infinite | |
|---|---|---|
| | distance | Nearest |
| Lateral | 0.0 | −0.5001 |
| magnification | | |
| Focal length | 113.2744 | 82.1566 |
| Open F-number | 5.74 | 5.77 |
| Maximum full | 42.1 | 35.4 |
| angle of view [°] | | |
| DD[9] | 3.8823 | 15.2816 |
| DD[14] | 16.5997 | 5.2004 |
| DD[18] | 17.3329 | 7.2142 |
| DD[23] | 5.2765 | 15.3952 |

### Example 15

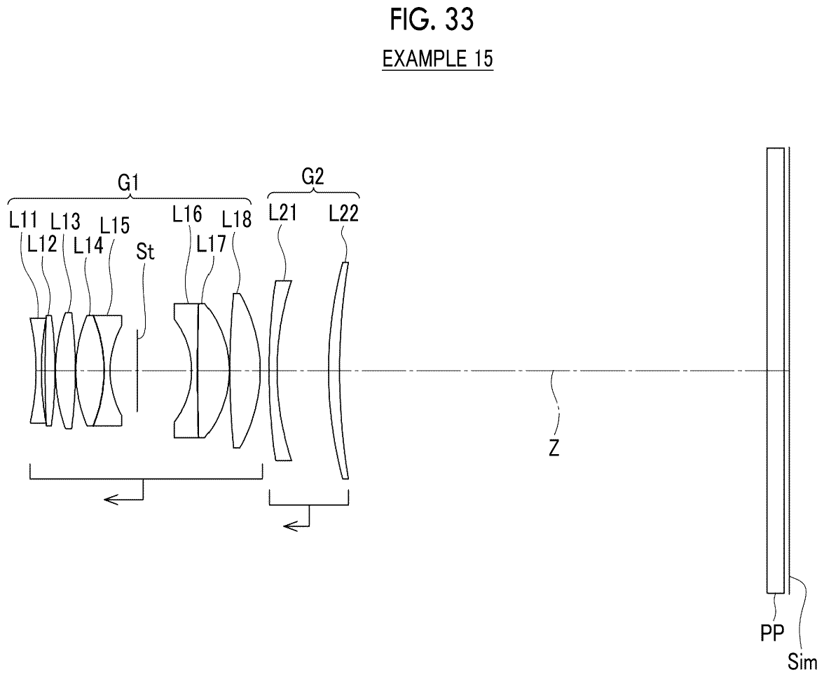

A cross-sectional view of a configuration of an optical system of Example 15 is shown in FIG. 33. The optical system of Example 15 consists of, in order from the object side to the image side, a first lens group G1 that has a positive refractive power and a second lens group G2 that has a negative refractive power. During focusing from the infinite distance object to the nearest object, the first lens group G1 and the second lens group G2 move toward the object side by changing the mutual spacing therebetween.

The first lens group G1 consists of, in order from the object side to the image side, lenses L11 to L15, an aperture stop St, and lenses L16 to L18. The second lens group G2 consists of, in order from the object side to the image side, two lenses including lenses L21 and L22.

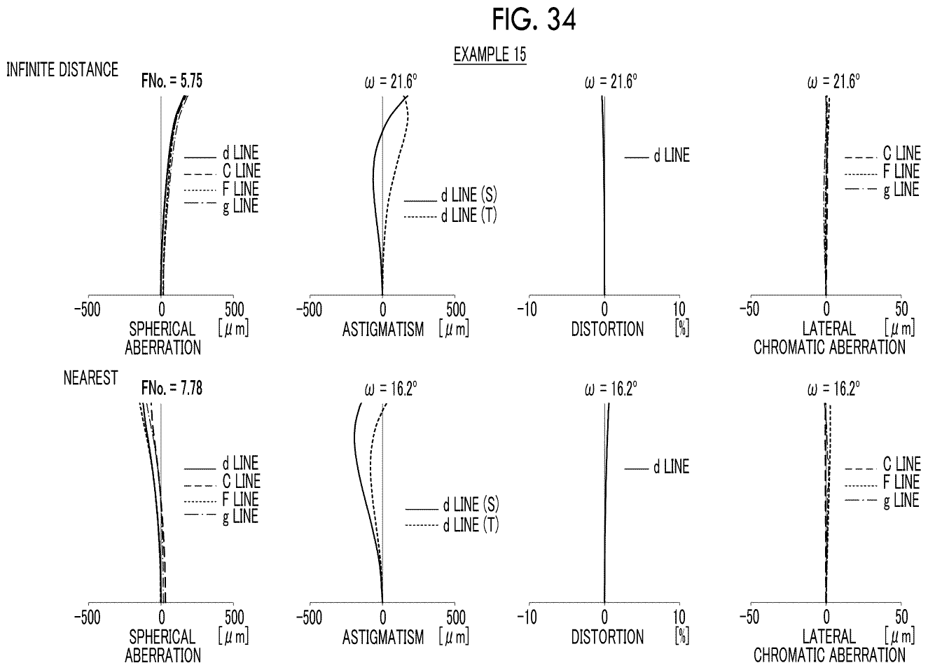

For the optical system of Example 15, basic lens data is shown in Table 37, specifications and variable surface spacings are shown in Table 38, and each aberration diagram is shown in FIG. 34.

TABLE 37
Example 15

| Sn | R | D | Nd | νd | θgF | ED |
|---|---|---|---|---|---|---|
| 1 | −46.0266 | 1.0000 | 1.84666 | 23.77 | 0.62370 | 19.083 |
| 2 | 58.8412 | 0.7116 | | | | 19.631 |
| 3 | 284.9218 | 1.8563 | 1.86966 | 20.02 | 0.64349 | 19.671 |
| 4 | −83.2385 | 0.1000 | | | | 20.022 |
| 5 | 34.9948 | 3.7275 | 1.90366 | 31.34 | 0.59636 | 20.937 |
| 6 | −90.9469 | 0.1000 | | | | 20.784 |
| 7 | 28.4488 | 5.3129 | 1.52855 | 76.97 | 0.54015 | 19.761 |
| 8 | −29.0940 | 1.1392 | 1.58271 | 46.51 | 0.56776 | 18.708 |
| 9 | 18.5559 | 5.1003 | | | | 16.513 |
| 10(St) | ∞ | 10.2716 | | | | 15.913 |
| 11 | −16.8652 | 1.1000 | 1.85025 | 32.17 | 0.59346 | 18.925 |
| 12 | 470.2250 | 5.8491 | 1.59270 | 35.27 | 0.59363 | 22.312 |
| 13 | −20.8894 | 0.1000 | | | | 24.155 |
| 14 | 155.0364 | 5.7251 | 1.49700 | 81.61 | 0.53804 | 27.677 |
| 15 | −31.2503 | DD[15] | | | | 28.400 |
| 16 | 123.9454 | 1.5000 | 1.83501 | 43.13 | 0.56293 | 33.700 |
| 17 | 57.3319 | 9.7031 | | | | 33.791 |
| 18 | 83.8363 | 2.0885 | 1.84666 | 23.77 | 0.62370 | 39.907 |
| 19 | 134.9085 | DD[19] | | | | 40.027 |
| 20 | ∞ | 3.2000 | 1.51680 | 64.20 | 0.53430 | 85.343 |
| 21 | ∞ | 1.0023 | | | | 86.249 |

TABLE 38
Example 15

| | Infinite | |
|---|---|---|
| | distance | Nearest |
| Lateral | 0.0 | −0.5000 |
| magnification | | |
| Focal length | 109.6859 | 102.1591 |
| Open F-number | 5.75 | 7.78 |
| Maximum full | 43.3 | 32.4 |
| angle of view [°] | | |
| DD[15] | 1.6666 | 16.4703 |
| DD[19] | 80.3806 | 105.5929 |

### Example 16

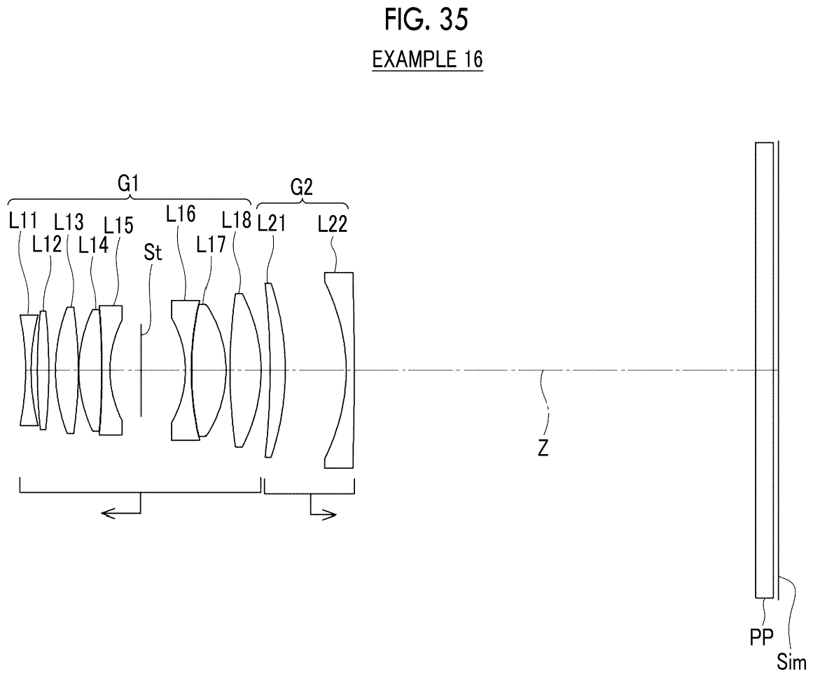

A cross-sectional view of a configuration of an optical system of Example 16 is shown in FIG. 35. The optical system of Example 16 consists of, in order from the object side to the image side, a first lens group G1 that has a positive refractive power and a second lens group G2 that has a negative refractive power. During focusing from the infinite distance object to the nearest object, the first lens group G1 moves toward the object side, and the second lens group G2 moves toward the image side.

The first lens group G1 consists of, in order from the object side to the image side, lenses L11 to L15, an aperture stop St, and lenses L16 to L18. The second lens group G2 consists of, in order from the object side to the image side, two lenses including lenses L21 and L22.

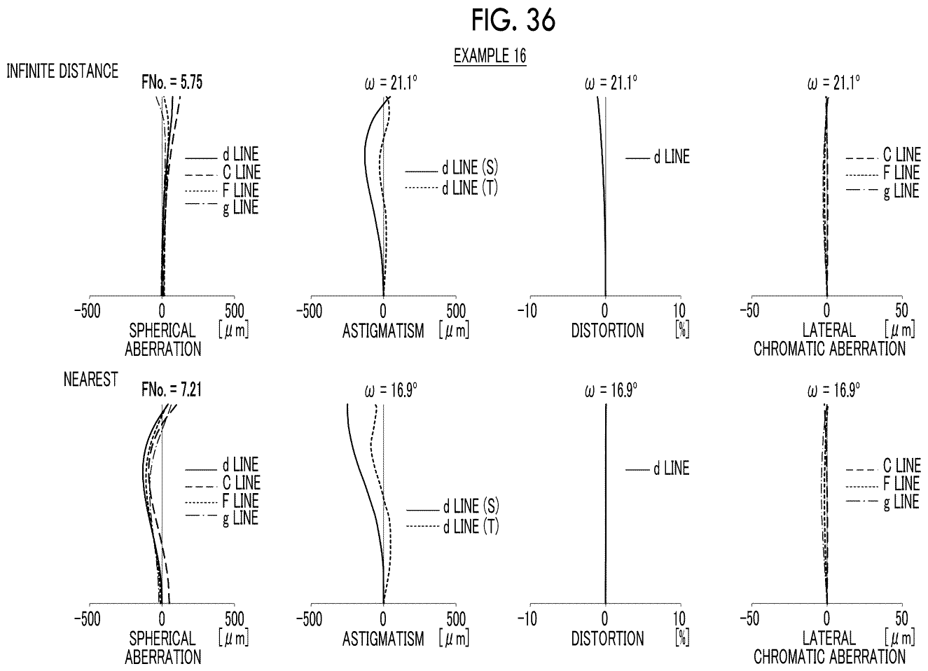

For the optical system of Example 16, basic lens data is shown in Table 39, specifications and variable surface spacings are shown in Table 40, aspherical coefficients are shown in Table 41, and each aberration diagram is shown in FIG. 36.

TABLE 39
Example 16

| Sn | R | D | Nd | νd | θgF | ED |
|---|---|---|---|---|---|---|
| 1 | −52.3100 | 1.0000 | 1.79999 | 25.00 | 0.61743 | 19.717 |
| 2 | 43.4597 | 1.1514 | | | | 20.251 |
| 3 | 114.4880 | 2.1013 | 1.86966 | 20.02 | 0.64349 | 20.576 |
| 4 | −116.7591 | 1.2344 | | | | 20.926 |
| 5 | 34.7756 | 4.1878 | 1.78341 | 33.13 | 0.59266 | 22.369 |
| 6 | −84.7291 | 0.1000 | | | | 22.234 |
| 7 | 27.2911 | 4.2159 | 1.53166 | 77.74 | 0.54039 | 21.140 |
| 8 | −161.5734 | 1.5000 | 1.62288 | 35.71 | 0.58939 | 20.206 |
| 9 | 21.4961 | 5.6852 | | | | 18.322 |
| 10(St) | ∞ | 8.1915 | | | | 17.528 |
| 11 | −20.5177 | 1.1000 | 1.83684 | 44.32 | 0.56160 | 19.058 |
| 12 | 58.8810 | 6.2402 | 1.52529 | 50.26 | 0.56053 | 21.770 |
| 13 | −23.2300 | 0.7294 | | | | 23.502 |
| 14 | 105.0855 | 5.7058 | 1.49700 | 81.61 | 0.53804 | 26.867 |
| 15 | −32.2766 | DD[15] | | | | 27.500 |
| 16 | −148.2041 | 2.8013 | 1.58449 | 41.25 | 0.57669 | 30.993 |
| 17 | −53.0668 | 11.1645 | | | | 31.200 |
| *18 | −36.3123 | 1.5000 | 1.58313 | 59.38 | 0.54237 | 32.769 |
| *19 | −541.2882 | DD[19] | | | | 34.958 |
| 20 | ∞ | 3.2000 | 1.51680 | 64.20 | 0.53430 | 84.666 |
| 21 | ∞ | 0.9894 | | | | 86.031 |

TABLE 40
Example 16

| | Infinite | |
|---|---|---|
| | distance | Nearest |
| Lateral | 0.0 | −0.5001 |
| magnification | | |
| Focal length | 113.3012 | 88.8019 |
| Open F-number | 5.75 | 7.21 |
| Maximum full | 42.3 | 33.8 |
| angle of view [°] | | |
| DD[15] | 1.6617 | 29.8710 |
| DD[19] | 73.6645 | 71.4769 |

TABLE 41
Example 16

| Sn | 18 | 19 |
|---|---|---|
| KA | 1.0000000000E+00 | 1.0000000000E+00 |
| A4 | 1.4463209188E−06 | 4.7660794140E−07 |
| A6 | 3.4193490912E−09 | 3.2020011422E−12 |
| A8 | −8.1043366088E−12 | 1.1071804077E−11 |
| A10 | 6.3966566424E−14 | −2.8278646726E−14 |
| A12 | −1.1325104188E−16 | −5.8241036668E−17 |
| A14 | −9.5612485219E−19 | 2.7581152422E−19 |
| A16 | 1.6094473375E−21 | −6.0961606535E−22 |
| A18 | 1.1697007503E−23 | 2.3557105818E−24 |
| A20 | −2.7204398724E−26 | −3.8250419247E−27 |

### Example 17

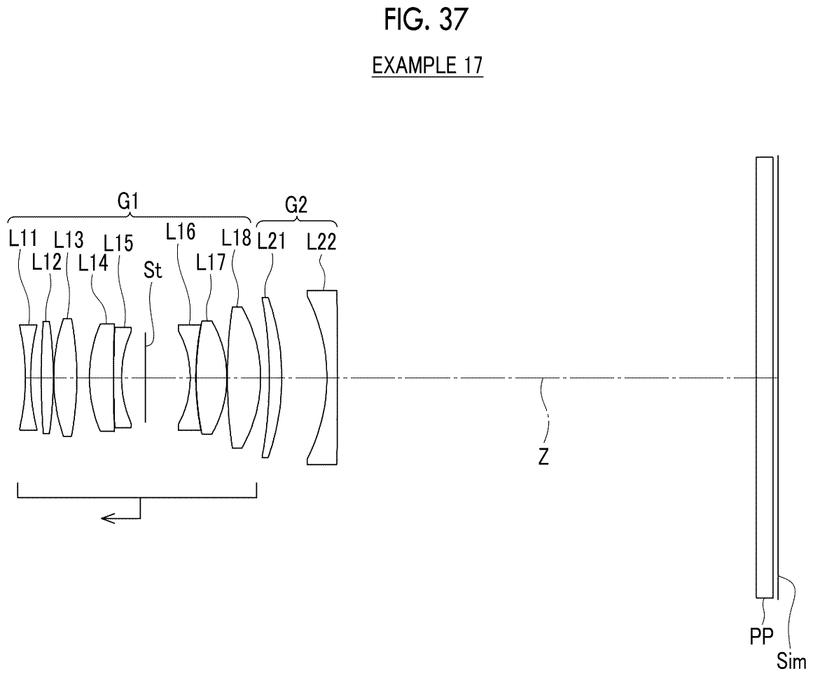

A cross-sectional view of a configuration of an optical system of Example 17 is shown in FIG. 37. The optical system of Example 17 consists of, in order from the object side to the image side, a first lens group G1 that has a positive refractive power and a second lens group G2 that has a negative refractive power. During focusing from the infinite distance object to the nearest object, the first lens group G1 moves toward the object side, and the second lens group G2 does not move with respect to the image plane Sim.

The first lens group G1 consists of, in order from the object side to the image side, lenses L11 to L15, an aperture stop St, and lenses L16 to L18. The second lens group G2 consists of, in order from the object side to the image side, two lenses including lenses L21 and L22.

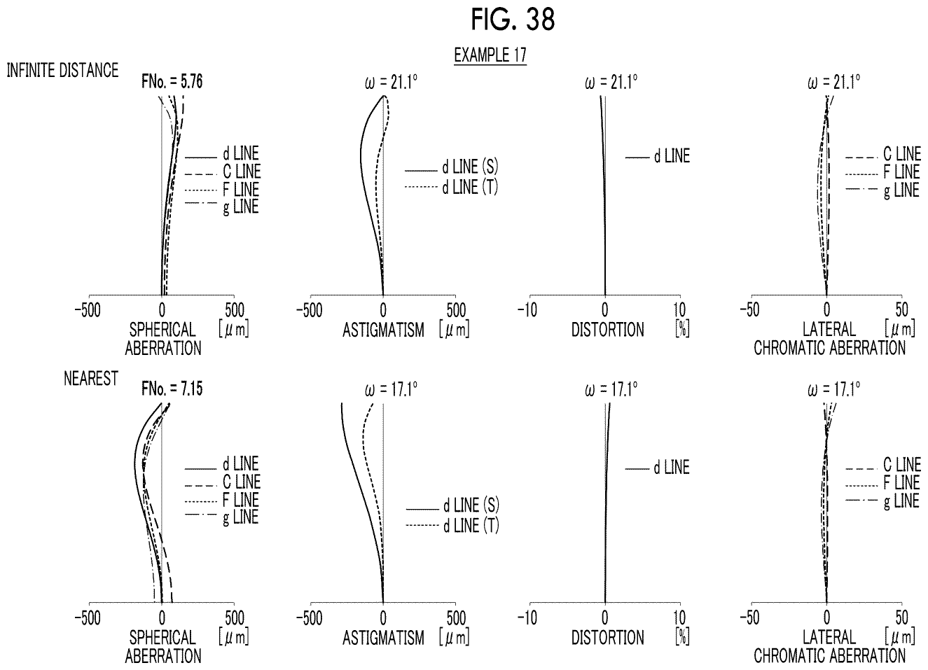

For the optical system of Example 17, basic lens data is shown in Table 42, specifications and variable surface spacings are shown in Table 43, aspherical coefficients are shown in Table 44, and each aberration diagram is shown in FIG. 38.

TABLE 42
Example 17

| Sn | R | D | Nd | νd | θgF | ED |
|---|---|---|---|---|---|---|
| 1 | −45.0166 | 1.0000 | 1.80518 | 25.46 | 0.61572 | 19.853 |
| 2 | 44.6975 | 2.0092 | | | | 20.453 |
| 3 | 157.0442 | 2.2680 | 1.86966 | 20.02 | 0.64349 | 21.412 |
| 4 | −81.8034 | 0.1000 | | | | 21.805 |
| 5 | 37.1731 | 4.3835 | 1.72341 | 37.99 | 0.58377 | 22.881 |
| 6 | −63.5295 | 2.3595 | | | | 22.809 |
| 7 | 27.3842 | 4.5926 | 1.49700 | 81.61 | 0.53804 | 20.865 |
| 8 | 266.1243 | 1.5000 | 1.64769 | 33.89 | 0.59390 | 19.493 |
| 9 | 22.7508 | 4.4866 | | | | 18.015 |
| 10(St) | ∞ | 8.5437 | | | | 17.440 |
| 11 | −19.4822 | 1.1000 | 1.88100 | 40.13 | 0.56945 | 18.150 |
| 12 | 56.0939 | 5.8296 | 1.56732 | 42.84 | 0.57436 | 20.467 |
| 13 | −22.6275 | 0.1000 | | | | 22.000 |
| 14 | 99.9338 | 6.2946 | 1.49700 | 81.61 | 0.53804 | 26.396 |
| 15 | −28.3874 | DD[15] | | | | 27.500 |
| 16 | −87.2095 | 2.3504 | 1.85150 | 40.76 | 0.56920 | 30.904 |
| 17 | −48.1174 | 8.5658 | | | | 31.200 |
| *18 | −34.4101 | 2.0000 | 1.58313 | 59.38 | 0.54237 | 31.772 |
| *19 | −703.0178 | 79.2145 | | | | 33.977 |
| 20 | ∞ | 3.2000 | 1.51680 | 64.20 | 0.53430 | 84.746 |
| 21 | ∞ | 0.9902 | | | | 86.057 |

TABLE 43
Example 17

| | Infinite | |
|---|---|---|
| | distance | Nearest |
| Lateral | 0.0 | −0.5001 |
| magnification | | |
| Focal length | 112.7894 | 89.5885 |
| Open F-number | 5.76 | 7.15 |
| Maximum full | 42.3 | 34.2 |
| angle of view [°] | | |
| DD[15] | 1.6700 | 25.7238 |

TABLE 44
Example 17

| Sn | 18 | 19 |
|---|---|---|
| KA | 1.0000000000E+00 | 1.0000000000E+00 |
| A4 | 9.8994770074E−07 | 1.6922771796E−07 |
| A6 | 7.0863479320E−09 | 5.8509655989E−09 |
| A8 | −9.9894678294E−13 | −7.9371110267E−12 |
| A10 | −4.8705445660E−14 | −1.6869836813E−14 |
| A12 | 9.9774112443E−17 | 1.7836190138E−17 |
| A14 | −3.8259786144E−19 | 2.5649832870E−19 |
| A16 | 1.9941716788E−21 | −1.1042343821E−21 |
| A18 | −1.2309805446E−24 | 2.8220544273E−24 |
| A20 | −6.2412522424E−27 | −3.6249887279E−27 |

### Example 18

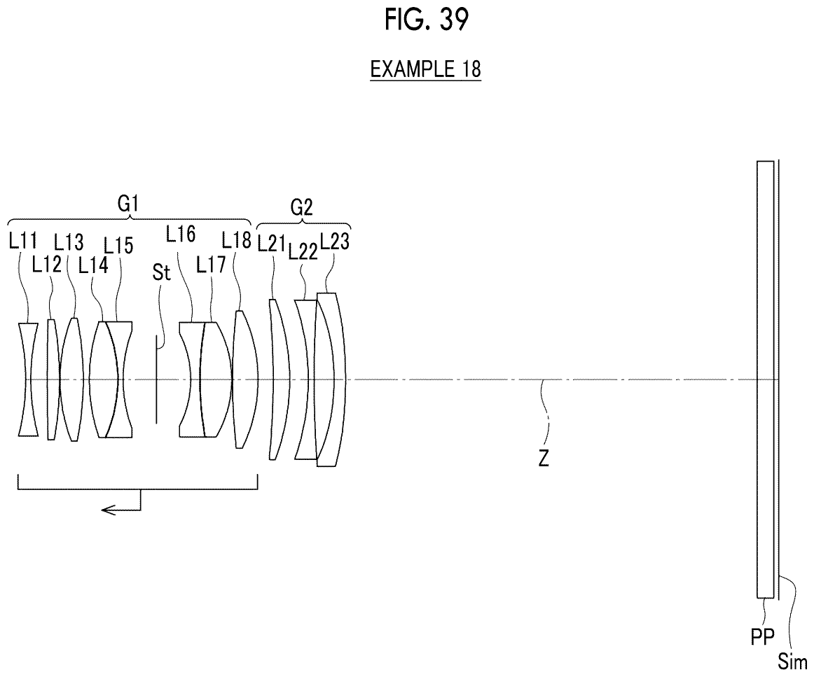

A cross-sectional view of a configuration of an optical system of Example 18 is shown in FIG. 39. The optical system of Example 18 consists of, in order from the object side to the image side, a first lens group G1 that has a positive refractive power and a second lens group G2 that has a negative refractive power. During focusing from the infinite distance object to the nearest object, the first lens group G1 moves toward the object side, and the second lens group G2 does not move with respect to the image plane Sim.

The first lens group G1 consists of, in order from the object side to the image side, lenses L11 to L15, an aperture stop St, and lenses L16 to L18. The second lens group G2 consists of, in order from the object side to the image side, three lenses including lenses L21 to L23.

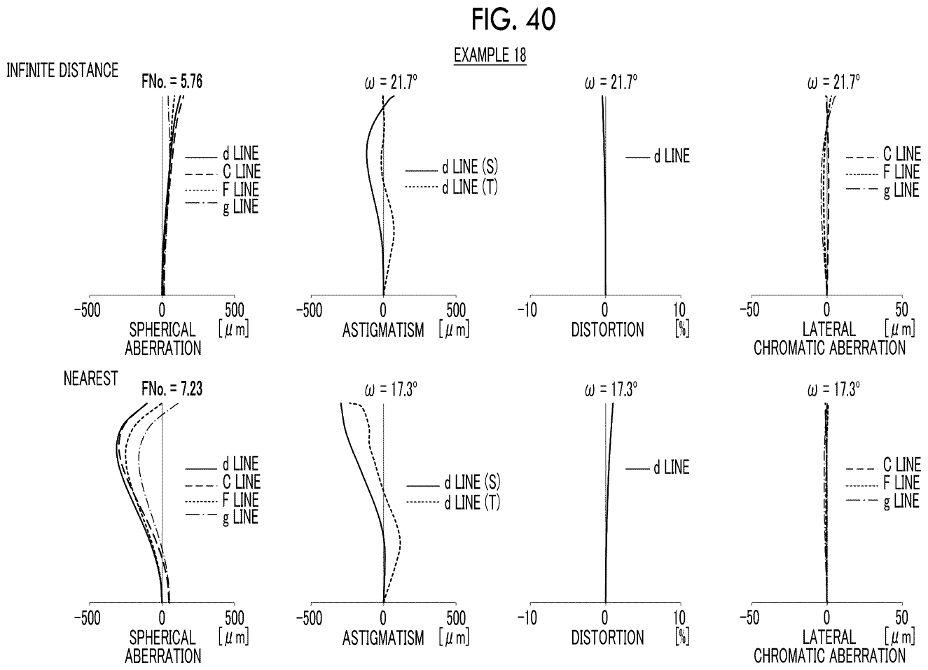

For the optical system of Example 18, basic lens data is shown in Table 45, specifications and variable surface spacings are shown in Table 46, aspherical coefficients are shown in Table 47, and each aberration diagram is shown in FIG. 40.

TABLE 45
Example 18

| Sr | R | D | Nd | νd | θgF | ED |
|---|---|---|---|---|---|---|
| 1 | −46.0659 | 1.0000 | 1.65412 | 39.68 | 0.57378 | 20.940 |
| 2 | 46.0659 | 3.1500 | | | | 21.034 |
| 3 | 500.6199 | 2.3500 | 1.69680 | 55.46 | 0.54260 | 21.801 |
| 4 | −70.1001 | 0.1000 | | | | 22.072 |
| 5 | 35.2255 | 4.4700 | 1.60342 | 38.03 | 0.58356 | 22.400 |
| 6 | −61.9662 | 1.1600 | | | | 22.306 |
| 7 | 36.8316 | 5.4700 | 1.49700 | 81.61 | 0.53804 | 21.119 |
| 8 | −28.7482 | 1.0100 | 1.51742 | 52.20 | 0.55800 | 20.280 |
| 9 | 28.7482 | 6.4300 | | | | 18.590 |
| 10(St) | ∞ | 6.5400 | | | | 17.440 |
| 11 | −20.6965 | 1.8000 | 1.83481 | 42.72 | 0.56477 | 17.325 |
| 12 | 68.0221 | 5.9600 | 1.51742 | 52.20 | 0.55800 | 19.168 |
| 13 | −23.0994 | 0.1500 | | | | 20.800 |
| 14 | 129.5764 | 4.8900 | 1.49700 | 81.61 | 0.53804 | 24.051 |
| 15 | −32.1696 | DD[15] | | | | 25.053 |
| 16 | −167.9098 | 3.1600 | 1.83481 | 42.74 | 0.56490 | 29.530 |
| 17 | −47.1767 | 3.6000 | | | | 29.800 |
| 18 | −48.5517 | 1.1000 | 1.55298 | 55.07 | 0.54469 | 29.743 |
| 19 | 234.9367 | 3.8250 | | | | 30.596 |
| *20 | −49.2419 | 2.2000 | 1.58480 | 58.71 | 0.54116 | 30.727 |
| *21 | −109.1937 | 78.8866 | | | | 32.769 |
| 22 | ∞ | 3.2000 | 1.51680 | 64.20 | 0.53430 | 85.077 |
| 23 | ∞ | 0.9874 | | | | 86.408 |

TABLE 46
Example 18

| | Infinite | |
|---|---|---|
| | distance | Nearest |
| Lateral | 0.0 | −0.5000 |
| magnification | | |
| Focal length | 109.9746 | 88.8827 |
| Open F-number | 5.76 | 7.23 |
| Maximum full | 43.4 | 34.6 |
| angle of view [°] | | |
| DD[15] | 2.9000 | 26.8818 |

TABLE 47
Example 18

| Sn | 20 | 21 |
|---|---|---|
| KA | 1.0000000000E+00 | 1.0000000000E+00 |
| A4 | −1.4891620663E−05 | −1.2287489595E−05 |
| A6 | 1.6689235765E−08 | 1.3828642481E−08 |
| A8 | 1.8215298356E−10 | 2.0444646881E−10 |
| A10 | −1.2029474980E−12 | −1.5065419952E−12 |
| A12 | −3.2918804549E−18 | 3.1939641025E−15 |
| A14 | 1.4798628128E−17 | 6.1701283401E−18 |
| A16 | 3.2311034086E−20 | −2.8426765370E−20 |
| A18 | −4.1122291666E−22 | −8.4745033242E−24 |
| A20 | 7.3036285573E−25 | 8.4536735759E−26 |

Next, an optical apparatus according to the embodiment of the present disclosure will be described. In the following, an example will be described in which the optical system according to the embodiment of the present disclosure is applied as an imaging lens and an imaging apparatus such as a digital camera is configured as an optical apparatus according to one embodiment of the present disclosure.

The digital camera of this example generally includes a body part and a lens unit. The lens unit includes a lens barrel and the above-described imaging lens housed in the lens barrel. In this example, the lens unit is configured as an interchangeable lens that is attachably and detachably mounted on the body part.

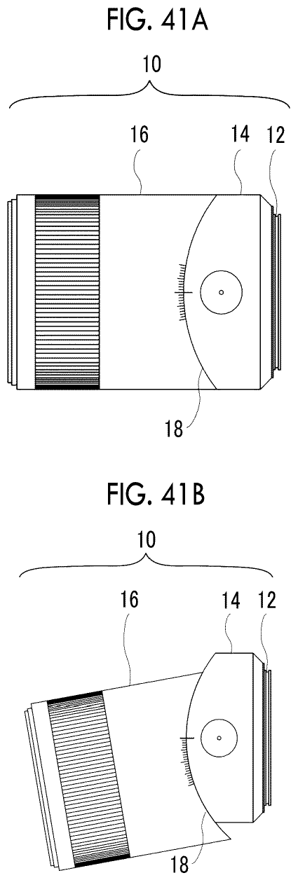

For example, FIGS. 41A and 41B show a schematic appearance of a lens barrel 10 according to one embodiment. The lens barrel 10 shown in FIGS. 41A and 41B has a tilt mechanism that enables tilt rotation. The lens barrel 10 includes a mount 12, a tilt seat 14, and a tilt drive unit 16. The lens unit is mounted on the body part by connecting the mount 12 to the body part. In a state where the lens barrel 10 is mounted on the body part, the tilt seat 14 is fixed to the body part. The tilt drive unit 16 holds the imaging lens housed in the lens barrel 10 and rotationally moves with respect to the tilt seat 14.

The tilt seat 14 and the tilt drive unit 16 are in contact with each other on a circumferential surface 18 having a predetermined curvature radius, and the tilt rotation is performed by the tilt drive unit 16 rotationally moving in a circumferential direction. FIG. 41A shows a state where no tilt rotation is performed. FIG. 41B shows a state where the tilt rotation is performed.

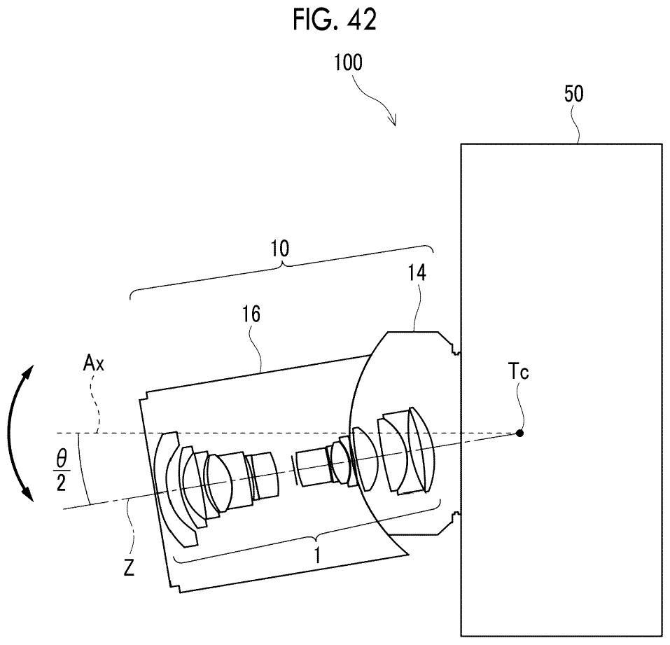

FIG. 42 shows a state where the lens barrel 10 is mounted on the body part 50 in a digital camera 100 and the tilt rotation shown in FIG. 41B is performed. For ease of understanding, FIG. 42 shows only the schematic external shape of the lens barrel 10 and the body part 50, and also shows an optical system 1 according to the embodiment of the present disclosure inside the lens barrel 10.

As the tilt drive unit 16 is tilted and rotated by the tilt mechanism, the optical system 1 inside the lens barrel 10 is tilted and rotated in an up-down direction indicated by an arrow in FIG. 42 with respect to the body part 50 with the tilt center Tc as the center of rotation. It is preferable that the tilt center Tc is a point at a principal point position of the optical system 1 or in the vicinity of the principal point position. FIG. 42 shows a state where the tilt rotation is performed in a downward direction of a horizontal axis Ax of the body part 50 and an angle formed by the optical axis Z of the optical system 1 and the horizontal axis Ax is an angle θ/2.

In a case where a maximum angle range of the tilt rotation is denoted by θ, it is preferable that the optical apparatus of the present disclosure satisfies Conditional Expression (32). Here, the unit of θ is degrees. The back focal length of the optical system 1 at the air conversion distance in a state where the infinite distance object is in focus is denoted by Bf By not allowing the result of Conditional Expression (32) to be equal to or less than the lower limit thereof, it is possible to perform imaging by further rotating a focusing plane (plane to be focused) on the object side. By not allowing the result of Conditional Expression (32) to be equal to or greater than the upper limit thereof, it is easy to suppress a difference between a maximum value and a minimum value of the amount of peripheral light during the tilt rotation. In order to obtain more favorable characteristics, the optical apparatus more preferably satisfies Conditional Expression (32-1) and still more preferably satisfies Conditional Expression (32-2).

$$0.08 < ( Y \times tan θ ) / Bf < 1 \qquad ( 32 )$$

$$0.12 < ( Y \times tan θ ) / Bf < 0.6 \qquad ( 32 - 1 )$$

$$0.16 < ( Y \times tan θ ) / Bf < 0. 35 \qquad ( 32 - 2 )$$

In the above description, an example has been described in which the angle range in which tilt rotation is possible is the same in the upward and downward directions of the horizontal axis Ax, but, in the technology of the present disclosure, the angle range in which tilt rotation is possible may be different in the upward and downward directions of the horizontal axis Ax. In addition, in the above description, an example has been described in which the lens unit is attachably and detachably mounted on the body part, but, in the technology of the present disclosure, the lens unit and the body part may be integrally configured.

The corresponding values of Conditional Expressions (1) to (32) of the optical systems of Examples 1 to 18 are shown in Tables 48 and 51. The corresponding values of Conditional Expression (32) in Tables 48 to 51 are calculated as θ=20 degrees in all of Examples 1 to 18. Preferred ranges of the conditional expressions may be set using the corresponding values of the examples shown in Tables 48 to 51 as the upper limits and the lower limits of the conditional expressions.

TABLE 48

| | | Example | Example | Example | Example | Example |
|---|---|---|---|---|---|---|
| | | 1 | 2 | 3 | 4 | 5 |
| (1) | TL/Y | 3.7296 | 3.7281 | 3.7050 | 3.7195 | 3.7220 |
| (2) | Bf/f | 1.6215 | 1.6522 | 1.6424 | 1.6577 | 1.6584 |
| (3) | νnc1 − νpc1 | 25.34 | 43.38 | 44.98 | 33.07 | 33.07 |
| (4) | νn3 − νp3 | −4.67 | 6.61 | −2.74 | 9.80 | 9.80 |
| (5) | νnc3 − νpc3 | 8.44 | 1.16 | 8.44 | 3.69 | 3.69 |
| (6) | Enp/Y | 0.4782 | 0.4713 | 0.5128 | 0.4436 | 0.4434 |
| (7) | fG1R/f | 2.6590 | 2.2880 | 2.5248 | 1.6817 | 1.6555 |
| (8) | TL²/(Y × f) | 19.5463 | 19.5115 | 19.2360 | 19.4815 | 19.4981 |
| (9) | Exp/Y | 2.4834 | 2.5182 | 2.4904 | 2.4336 | 2.4329 |
| (10) | Y/Bf | 0.8666 | 0.8496 | 0.8532 | 0.8495 | 0.8487 |
| (11) | Enp/f | 0.6720 | 0.6617 | 0.7186 | 0.6246 | 0.6240 |
| (12) | Bf/TL | 0.3094 | 0.3157 | 0.3163 | 0.3165 | 0.3166 |
| (13) | \|B\| | 0.2083 | 0.2047 | 0.2025 | 0.2081 | 0.2079 |
| (14) | Hstp/f | 0.2017 | 0.2084 | 0.2747 | 0.2143 | 0.2140 |
| (15) | \|(1 − βFF²) × βR²\| | 1.6269 | 2.0032 | 1.7801 | 1.6906 | 1.6922 |
| (16) | (R1r − R2f)/(R1r + R2f) | 0.0175 | −0.1266 | −0.0540 | −0.3726 | −0.3674 |
| (17) | (R3f + R3r)/(R3f − R3r) | 0.8324 | 0.8427 | 1.0441 | 1.1228 | 1.1218 |
| (18) | d12/h1 − (1/R1r − 1/R2f) × h1 | 0.1735 | 0.2106 | 0.1997 | 0.2645 | 0.2634 |
| (19) | Noa | 1.5831 | 1.5831 | 1.5831 | 1.5848 | 1.5848 |
| (20) | νoa | 59.38 | 59.38 | 59.38 | 58.71 | 58.71 |
| (21) | Nia | 1.8061 | 1.6935 | 1.8061 | 1.5848 | 1.5848 |
| (22) | νia | 40.73 | 53.20 | 40.73 | 58.71 | 58.71 |
| (23) | hLfi × (1/RLfi + 1/DLfi) | 0.9394 | 1.0094 | 1.2303 | 1.6295 | 1.6282 |
| (24) | Rne × (1/fe − 1/Bf) | −0.5108 | −0.8266 | −0.4406 | −5.3509 | −5.3553 |
| (25) | f/f1 | −0.2320 | −0.0657 | −0.1273 | −0.0091 | 0.0142 |
| (26) | f/f2 | 0.6233 | 0.6134 | 0.6365 | 0.5354 | 0.5293 |
| (27) | f/f3 | −0.1078 | −0.1438 | −0.1151 | −0.0775 | −0.0772 |
| (28) | f/f4 | — | — | — | — | — |
| (29) | f2/f1 | −0.3723 | −0.1070 | −0.2000 | −0.0170 | 0.0269 |
| (30) | f2/f3 | −0.1730 | −0.2344 | −0.1809 | −0.1447 | −0.1460 |
| (31) | Y/fsR | 0.7027 | 0.6171 | 0.6808 | 0.5807 | 0.5714 |
| (32) | (Y × tanθ)/Bf | 0.3154 | 0.3092 | 0.3105 | 0.3092 | 0.3089 |

TABLE 49

| | | Example | Example | Example | Example | Example |
|---|---|---|---|---|---|---|
| | | 6 | 7 | 8 | 9 | 10 |
| (1) | TL/Y | 3.7238 | 3.7282 | 3.8993 | 4.1158 | 3.9911 |
| (2) | Bf/f | 1.6386 | 1.5815 | 1.6105 | 1.0350 | 1.0389 |
| (3) | νnc1 − νpc1 | 33.07 | 33.07 | 33.07 | — | — |
| (4) | νn3 − νp3 | 17.03 | 7.00 | — | −28.67 | 3.92 |
| (5) | νnc3 − νpc3 | 0.38 | 5.50 | — | −49.22 | −50.01 |
| (6) | Enp/Y | 0.4583 | 0.4484 | 0.4709 | 0.9423 | 0.9015 |
| (7) | fG1R/f | 1.7150 | 1.7176 | 1.7213 | 1.5599 | 1.3874 |
| (8) | TL²/(Y × f) | 19.1834 | 18.9813 | 21.2338 | 11.9830 | 11.2740 |
| (9) | Exp/Y | 2.4110 | 2.4457 | 2.4867 | 2.0052 | 2.0946 |
| (10) | Y/Bf | 0.8443 | 0.8635 | 0.8672 | 0.6835 | 0.6813 |
| (11) | Enp/f | 0.6341 | 0.6124 | 0.6576 | 0.6666 | 0.6381 |
| (12) | Bf/TL | 0.3181 | 0.3106 | 0.2957 | 0.3555 | 0.3678 |
| (13) | \|B\| | 0.2151 | 0.2163 | 0.2272 | 0.5000 | 0.5001 |
| (14) | Hstp/f | 0.2124 | 0.2095 | 0.2212 | 0.1396 | 0.1479 |
| (15) | \|(1 − βFF²) × βR²\| | 1.2926 | 1.7126 | 0.9851 | 0.7632 | 0.0122 |
| (16) | (R1r − R2f)/(R1r + R2f) | −0.3926 | −0.3286 | −0.5904 | −1.3129 | −0.5050 |
| (17) | (R3f + R3r)/(R3f − R3r) | 1.1125 | 1.1071 | 1.8287 | −2.1399 | 2.1589 |
| (18) | d12/h1 − (1/R1r − 1/R2f) × h1 | 0.2675 | 0.2550 | 0.2604 | 0.5255 | 0.3546 |
| (19) | Noa | 1.5848 | 1.5848 | 1.5848 | — | — |
| (20) | νoa | 58.71 | 58.71 | 58.71 | — | — |
| (21) | Nia | 1.5503 | 1.5584 | 1.5378 | — | — |
| (22) | νia | 75.50 | 54.01 | 74.70 | — | — |
| (23) | hLfi × (1/RLfi + 1/DLfi) | 1.7422 | 1.6367 | 0.7654 | 3.4624 | 3.2085 |
| (24) | Rne × (1/fe − 1/Bf) | −4.5262 | −4.9902 | −4.7738 | −0.8612 | −2.9426 |
| (25) | f/f1 | 0.0036 | 0.0039 | −0.1220 | −0.8736 | −0.1103 |
| (26) | f/f2 | 0.4690 | 0.5473 | 0.4309 | 0.5902 | 0.7370 |
| (27) | f/f3 | 0.0079 | −0.0798 | — | 0.4987 | −0.1718 |
| (28) | f/f4 | — | — | — | — | — |
| (29) | f2/f1 | 0.0077 | 0.0071 | −0.2832 | −1.4801 | −0.1496 |
| (30) | f2/f3 | 0.0168 | −0.1458 | — | 0.8449 | −0.2331 |
| (31) | Y/fsR | 0.5707 | 0.5708 | 0.6018 | 0.0253 | 0.1584 |
| (32) | (Y × tanθ)/Bf | 0.3073 | 0.3143 | 0.3156 | 0.2488 | 0.2480 |

TABLE 50

| | | Example | Example | Example | Example | Example |
|---|---|---|---|---|---|---|
| | | 11 | 12 | 13 | 14 | 15 |
| (1) | TL/Y | 4.0525 | 3.5652 | 4.6016 | 4.5698 | 3.2309 |
| (2) | Bf/f | 0.6481 | 0.8351 | 0.7194 | 0.6268 | 0.7611 |
| (3) | νnc1 − νpc1 | — | −4.24 | — | −41.86 | −3.10 |
| (4) | νn3 − νp3 | 11.23 | — | −24.50 | −23.33 | — |
| (5) | νnc3 − νpc3 | −49.35 | — | −8.11 | −23.33 | — |
| (6) | Enp/Y | 1.1283 | 0.7362 | 1.1496 | 0.8704 | 0.3559 |
| (7) | fG1R/f | 1.2339 | 0.3489 | 0.5698 | 0.5032 | 1.1978 |
| (8) | TL²/(Y × f) | 6.6962 | 4.8528 | 8.1472 | 8.0321 | 4.1397 |
| (9) | Exp/Y | 2.3498 | 2.6469 | 2.5827 | 2.4590 | 2.8957 |
| (10) | Y/Bf | 0.6291 | 0.4572 | 0.5348 | 0.6136 | 0.5210 |
| (11) | Enp/f | 0.4601 | 0.2811 | 0.4423 | 0.3348 | 0.1411 |
| (12) | Bf/TL | 0.3922 | 0.6135 | 0.4063 | 0.3566 | 0.5940 |
| (13) | \|B\| | 0.5001 | 0.5001 | 0.5001 | 0.5001 | 0.5000 |
| (14) | Hstp/f | 0.1138 | 0.1031 | 0.1379 | 0.1018 | 0.0725 |
| (15) | \|(1 − βFF²) × βR²\| | 0.4183 | 2.7854 | 0.1251 | 1.6939 | 1.8763 |
| (16) | (R1r − R2f)/(R1r + R2f) | −2.0455 | −0.3084 | −0.2920 | −0.1334 | −0.6577 |
| (17) | (R3f + R3r)/(R3f − R3r) | −1.0595 | 0.3110 | 0.2575 | −0.4829 | −0.4443 |
| (18) | d12/h1 − (1/R1r − 1/R2f) × h1 | 0.7739 | 0.1800 | 0.1388 | 0.6899 | 0.1175 |
| (19) | Noa | — | — | — | — | — |
| (20) | νoa | — | — | — | — | — |
| (21) | Nia | — | — | — | — | — |
| (22) | νia | — | — | — | — | — |
| (23) | hLfi × (1/RLfi + 1/DLfi) | 6.3009 | 2.4343 | 0.9589 | 4.0269 | 2.0259 |
| (24) | Rne × (1/fe − 1/Bf) | −0.4225 | −0.3342 | −1.4109 | −1.5507 | −1.6160 |
| (25) | f/f1 | −0.6468 | 1.6690 | 0.4012 | 1.3421 | 1.3698 |
| (26) | f/f2 | 1.3821 | −0.7541 | −0.5601 | −1.5244 | −0.3988 |
| (27) | f/f3 | −0.3778 | — | 1.0478 | 1.4796 | — |
| (28) | f/f4 | — | — | 1.3077 | 1.0715 | — |
| (29) | f2/f1 | −0.4679 | −2.2132 | −0.7162 | −0.8804 | −3.4344 |
| (30) | f2/f3 | −0.2733 | — | −1.8706 | −0.9706 | — |
| (31) | Y/fsR | 0.0464 | 0.4327 | 0.1512 | 0.4658 | 0.1253 |
| (32) | (Y × tanθ)/Bf | 0.2290 | 0.1664 | 0.1947 | 0.2233 | 0.1896 |

TABLE 51

| | | Exam- | Exam- | Exam- |
|---|---|---|---|---|
| | | ple 16 | ple 17 | ple 18 |
| (1) | TL/Y | 3.1272 | 3.2439 | 3.2773 |
| (2) | Bf/f | 0.6776 | 0.7298 | 0.7456 |
| (3) | νnc1 − νpc1 | −5.94 | −2.71 | −9.48 |
| (4) | νn3 − νp3 | — | — | — |
| (5) | νnc3 − νpc3 | — | — | — |
| (6) | Enp/Y | 0.3692 | 0.3878 | 0.4325 |
| (7) | fG1R/f | 1.3187 | 1.1123 | 1.4512 |
| (8) | TL²/(Y × f) | 3.7825 | 4.0687 | 4.2693 |
| (9) | Exp/Y | 2.4445 | 2.5686 | 2.5374 |
| (10) | Y/Bf | 0.5708 | 0.5298 | 0.5331 |
| (11) | Enp/f | 0.1428 | 0.1499 | 0.1719 |
| (12) | Bf/TL | 0.5602 | 0.5819 | 0.5724 |
| (13) | \|B\| | 0.5001 | 0.5001 | 0.5000 |
| (14) | Hstp/f | 0.0773 | 0.0773 | 0.0793 |
| (15) | \|(1 − βFF²) × βR²\| | 2.1071 | 2.3447 | 2.2926 |
| (16) | (R1r − R2f)/(R1r + R2f) | −0.4497 | −0.5569 | −0.8315 |
| (17) | (R3f + R3r)/(R3f − R3r) | −0.4180 | −0.2617 | −0.2751 |
| (18) | d12/h1 − (1/R1r − 1/R2f) × h1 | 0.1867 | 0.3123 | 0.4276 |
| (19) | Noa | — | — | — |
| (20) | Noa | — | — | — |
| (21) | Nia | 1.5831 | 1.5831 | 1.5848 |
| (22) | Nia | 59.38 | 59.38 | 58.71 |
| (23) | hLfi × (1/RLfi + 1/DLfi) | 1.9838 | 1.7001 | 2.1723 |
| (24) | Rne × (1/fe − 1/Bf) | −0.2949 | −0.2736 | −4.3764 |
| (25) | f/f1 | 1.4516 | 1.5312 | 1.5141 |
| (26) | f/f2 | −0.7631 | −0.7931 | −0.7183 |
| (27) | f/f3 | — | — | — |
| (28) | f/f4 | — | — | — |
| (29) | f2/f1 | −1.9022 | −1.9308 | −2.1078 |
| (30) | f2/f3 | — | — | — |
| (31) | Y/fsR | −0.0304 | 0.0054 | −0.0544 |
| (32) | (Y × tanθ)/Bf | 0.2078 | 0.1928 | 0.1940 |

A technology of the present disclosure has been hitherto described through the embodiments and the examples, but the technology of the present disclosure is not limited to the above-mentioned embodiments and examples, and may be modified into various forms. For example, the curvature radius, the surface spacing, the refractive index, the Abbe number, the partial dispersion ratio, and the aspherical coefficient of each lens are not limited to the values shown in each example and may have other values.

In addition, the optical apparatus of the present disclosure is also not limited to the above. The optical apparatus of the present disclosure is not limited to a digital camera and can have various aspects of a film camera, a video camera, a security camera, a video capturing camera, a broadcasting camera, a projector, and the like. As long as the optical system according to the embodiment of the present disclosure is included, an optical apparatus that does not have the tilt-rotatable configuration described above is also included in the technical scope of the present disclosure.

In regard with the embodiment and the examples described above, the following supplementary notes are further disclosed.

### [Supplementary Note 1]

An optical system comprising:
an aperture stop that has a variable opening diameter and that determines an F number of the optical system,
in which at least one positive lens and at least one negative lens are disposed closer to an object side than the aperture stop,
at least one positive lens and at least one negative lens are disposed closer to an image side than the aperture stop,
an image side surface of at least one negative lens among the negative lenses disposed closer to the object side than the aperture stop has a concave shape, and
in a case where
   a sum of a distance on an optical axis from a lens surface of the optical system closest to the object side to a lens surface of the optical system closest to the image side and a back focal length of the optical system at an air conversion distance in a state where an infinite distance object is in focus is denoted by TL,
   a focal length of the optical system in a state where the infinite distance object is in focus is denoted by f,
   a maximum half angle of view in a state where the infinite distance object is in focus is denoted by om, and

$$Y = f \times tan ω m is established ,$$

Conditional Expression (1) is satisfied, which is represented by

$$1 < TL / Y < 6.5 . \qquad ( 1 )$$

### [Supplementary Note 2]

The optical system according to Supplementary Note 1,
in which the optical system consists of, in order from the object side to the image side, a first lens group that has a refractive power, a second lens group that has a positive refractive power, and a third lens group that has a refractive power,
during focusing, the first lens group and the third lens group do not move with respect to an image plane, and the second lens group moves along the optical axis, and
in a case where the back focal length of the optical system at the air conversion distance in a state where the infinite distance object is in focus is denoted by Bf, Conditional Expression (2) is satisfied, which is represented by

$$0.5 < Bf / f < 3. \qquad ( 2 )$$

### [Supplementary Note 3]

The optical system according to Supplementary Note 1 or 2, further comprising, successively in order from a position closest to the object side to the image side:
a first lens group that has a refractive power; and
a second lens group that has a positive refractive power,
in which the aperture stop is disposed between a lens surface of the first lens group closest to the image side and a lens surface of the second lens group closest to the object side,
during focusing, the first lens group does not move with respect to an image plane, and the second lens group moves along the optical axis,
the first lens group includes at least one cemented lens formed by cementing at least one positive lens and at least one negative lens,
a surface of a first cemented lens, which is a cemented lens closest to the image side among the cemented lenses included in the first lens group, closest to the object side has a concave shape, and
in a case where
   an average value of Abbe numbers of all negative lenses included in the first cemented lens based on a d line is denoted by vnc1, and
   an average value of Abbe numbers of all positive lenses included in the first cemented lens based on the d line is denoted by vpc1,
   Conditional Expression (3) is satisfied, which is represented by

$$16 < vnc 1 - vpc 1 < 75. \qquad ( 3 )$$

### [Supplementary Note 4]

The optical system according to any one of Supplementary Notes 1 to 3,
in which, in a case where the back focal length of the optical system at the air conversion distance in a state where the infinite distance object is in focus is denoted by Bf, Conditional Expression (2) is satisfied, which is represented by

$$0.5 < Bf / f < 3. \qquad ( 2 )$$

### [Supplementary Note 5]

The optical system according to any one of Supplementary Notes 1 to 4,
in which, in a case where a group consisting of all optical elements disposed closer to the object side than a spacing closest to the object side among spacings that change during focusing is defined as a first lens group, the first lens group includes at least one cemented lens formed by cementing at least one positive lens and at least one negative lens, and
in a case where
   a cemented lens closest to the image side among the cemented lenses included in the first lens group is defined as a first cemented lens,
   an average value of Abbe numbers of all negative lenses included in the first cemented lens based on a d line is denoted by vnc1, and
   an average value of Abbe numbers of all positive lenses included in the first cemented lens based on the d line is denoted by vpc1,
   Conditional Expression (3) is satisfied, which is represented by

$$16 < vnc 1 - vpc 1 < 75. \qquad ( 3 )$$

### [Supplementary Note 6]

The optical system according to any one of Supplementary Notes 1 to 5,
in which, in a case where a group consisting of all optical elements disposed closer to the object side than a spacing closest to the object side among spacings that change during focusing is defined as a first lens group, the first lens group includes at least one cemented lens formed by cementing at least one positive lens and at least one negative lens, and
in a case where a cemented lens closest to the image side among the cemented lenses included in the first lens group is defined as a first cemented lens, the first lens group includes, on the object side with respect to the first cemented lens, a negative meniscus lens convex toward the object side, a negative meniscus lens convex toward the object side, and a negative lens successively in order from the object side to the image side.

### [Supplementary Note 7]

The optical system according to any one of Supplementary Notes 1 to 6,
in which the optical system consists of, in order from the object side to the image side, a first lens group, a second lens group, and a third lens group that has a refractive power, with spacings that change during focusing as boundaries between the lens groups.

### [Supplementary Note 8]

The optical system according to any one of Supplementary Notes 1 to 7, further comprising, successively in order from a position closest to the object side to the image side:
a first lens group;
a second lens group; and
a third lens group that has a refractive power,
in which spacings that change during focusing are provided as boundaries between the lens groups, and
during focusing, the third lens group does not move with respect to an image plane.

### [Supplementary Note 9]

The optical system according to any one of Supplementary Notes 1 to 8, further comprising, successively in order from a position closest to the object side to the image side:
a first lens group;
a second lens group; and
a third lens group that has a refractive power,
in which spacings that change during focusing are provided as boundaries between the lens groups, and
the third lens group includes at least one positive lens and at least one negative lens.

### [Supplementary Note 10]

The optical system according to Supplementary Note 9,
in which, in a case where
   an average value of Abbe numbers of all negative lenses included in the third lens group based on a d line is denoted by vn3, and
   an average value of Abbe numbers of all positive lenses included in the third lens group based on the d line is denoted by vp3,
   Conditional Expression (4) is satisfied, which is represented by

$$- 20 < vn 3 - vp 3 < 20. \qquad ( 4 )$$

### [Supplementary Note 11]

The optical system according to any one of Supplementary Notes 1 to 10, further comprising, successively in order from a position closest to the object side to the image side:
a first lens group;
a second lens group; and
a third lens group that has a refractive power,
in which spacings that change during focusing are provided as boundaries between the lens groups,
the third lens group includes at least one cemented lens formed by cementing at least one positive lens and at least one negative lens, and
in a case where
   a cemented lens closest to the image side among the cemented lenses included in the third lens group is defined as a third cemented lens,
   an average value of Abbe numbers of all negative lenses included in the third cemented lens based on a d line is denoted by vnc3, and
   an average value of Abbe numbers of all positive lenses included in the third cemented lens based on the d line is denoted by vpc3,
   Conditional Expression (5) is satisfied, which is represented by

$$- 80 < vnc 3 - vpc 3 < 20. \qquad ( 5 )$$

### [Supplementary Note 12]

The optical system according to any one of Supplementary Notes 1 to 11, further comprising, successively in order from a position closest to the object side to the image side:
a first lens group;
a second lens group; and
a third lens group that has a negative refractive power,
in which spacings that change during focusing are provided as boundaries between the lens groups.

### [Supplementary Note 13]

The optical system according to any one of Supplementary Notes 1 to 12,
in which, in a case where a distance on the optical axis from the lens surface of the optical system closest to the object side to a paraxial entrance pupil position in a state where the infinite distance object is in focus is denoted by Enp, Conditional Expression (6) is satisfied, which is represented by

$$0.28 < Enp / Y < 1.2 . \qquad ( 6 )$$

### [Supplementary Note 14]

The optical system according to any one of Supplementary Notes 1 to 13, further comprising, successively in order from a position closest to the object side to the image side:
a first lens group; and
a second lens group,
in which a spacing that changes during focusing is provided as a boundary between the lens groups, and
during focusing, all lenses in the second lens group and the aperture stop move along the optical axis in an integrated manner.

### [Supplementary Note 15]

The optical system according to any one of Supplementary Notes 1 to 14, further comprising, successively in order from a position closest to the object side to the image side:
a first lens group; and
a second lens group,
in which a spacing that changes during focusing is provided as a boundary between the lens groups, and
the aperture stop is disposed closest to the object side in the second lens group.

### [Supplementary Note 16]

The optical system according to any one of Supplementary Notes 1 to 15, further comprising, successively in order from a position closest to the object side to the image side:
a first lens group; and
a second lens group,
in which a spacing that changes during focusing is provided as a boundary between the lens groups, and
in a case where
   a negative lens which is second from the object side among negative lenses included in the first lens group is defined as a second negative lens, and
   a combined focal length of all optical elements in the first lens group disposed closer to the image side than the second negative lens in a state where the infinite distance object is in focus is denoted by fG1R,
   Conditional Expression (7) is satisfied, which is represented by

$$0.45 < fG 1 R / f < 3.5 . \qquad ( 7 )$$

### [Supplementary Note 17]

The optical system according to any one of Supplementary Notes 1 to 16,
in which Conditional expression (8) is satisfied, which is represented by

$$3.6 < T {L}^{2} / ( Y \times f ) < 30. \qquad ( 8 )$$

### [Supplementary Note 18]

The optical system according to any one of Supplementary Notes 1 to 17,
in which, in a case where
   a distance on the optical axis from a paraxial exit pupil position to an image plane in a state where the infinite distance object is in focus is denoted by Exp, and
   Exp is calculated using the air conversion distance for an optical member having no refractive power in a case where the optical member is disposed between the image plane and the paraxial exit pupil position,
   Conditional Expression (9) is satisfied, which is represented by

$$1.2 < Exp / Y < 3.8 . \qquad ( 9 )$$

### [Supplementary Note 19]

The optical system according to any one of Supplementary Notes 1 to 18, further comprising, successively in order from a position closest to the object side to the image side:
a first lens group that has a negative refractive power; and
a second lens group,
in which a spacing that changes during focusing is provided as a boundary between the lens groups.

### [Supplementary Note 20]

The optical system according to any one of Supplementary Notes 1 to 19,
in which, in a case where the back focal length of the optical system at the air conversion distance in a state where the infinite distance object is in focus is denoted by Bf, Conditional Expression (10) is satisfied, which is represented by

$$0.3 < Y / Bf < 1.2 . \qquad ( 10 )$$

### [Supplementary Note 21]

The optical system according to any one of Supplementary Notes 1 to 20,
in which, in a case where a distance on the optical axis from the lens surface of the optical system closest to the object side to a paraxial entrance pupil position in a state where the infinite distance object is in focus is denoted by Enp, Conditional Expression (11) is satisfied, which is represented by

$$0.01 < Enp / f < 0.8 . \qquad ( 11 )$$

### [Supplementary Note 22]

The optical system according to Supplementary Note 21,
in which Conditional Expression (11-1) is satisfied, which is represented by

$$0.01 < Enp / f < 0.2 . \qquad ( 11 - 1 )$$

### [Supplementary Note 23]

The optical system according to any one of Supplementary Notes 1 to 22,
in which, in a case where the back focal length of the optical system at the air conversion distance in a state where the infinite distance object is in focus is denoted by Bf, Conditional Expression (12) is satisfied, which is represented by

$$0.2 < Bf / TL < 10. \qquad ( 12 )$$

### [Supplementary Note 24]

The optical system according to any one of Supplementary Notes 1 to 23,
in which, in a case where
   a distance on the optical axis from the lens surface of the optical system closest to the object side to a paraxial entrance pupil position in a state where the infinite distance object is in focus is denoted by Enp, and
   the back focal length of the optical system at the air conversion distance in a state where the infinite distance object is in focus is denoted by Bf,
   Conditional Expressions (11-2) and (12-1) are satisfied, which are represented by

$$0.01 < Enp / f < 0.26 , and \qquad ( 11 - 2 )$$

$$0.5 < Bf / TL < 10. \qquad ( 12 - 1 )$$

### [Supplementary Note 25]

The optical system according to any one of Supplementary Notes 1 to 24,
in which, in a case where
   a distance on the optical axis from the lens surface of the optical system closest to the object side to a paraxial entrance pupil position in a state where the infinite distance object is in focus is denoted by Enp, and
   the back focal length of the optical system at the air conversion distance in a state where the infinite distance object is in focus is denoted by Bf,
   Conditional Expressions (6-3) and (12-1) are satisfied, which are represented by

$$0.01 < Enp / Y < 0.57 , and \qquad ( 6 - 3 )$$

$$0.5 < Bf / TL < 10. \qquad ( 12 - 1 )$$

### [Supplementary Note 26]

The optical system according to any one of Supplementary Notes 1 to 25,
in which, in a case where a lateral magnification of the optical system in a state where a nearest object is in focus is denoted by B, Conditional Expression (13) is satisfied, which is represented by

$$0.2 < \vert B \vert < 1.2 . \qquad ( 13 )$$

### [Supplementary Note 27]

The optical system according to any one of Supplementary Notes 1 to 26,
in which, in a case where a maximum radius of an opening of the aperture stop is denoted by Hstp, Conditional Expression (14) is satisfied, which is represented by

$$0.03 < Hstp / f < 0.4 . \qquad ( 14 )$$

### [Supplementary Note 28]

The optical system according to any one of Supplementary Notes 1 to 27,
in which, in a case where
   a group closest to the object side among groups that move during focusing is defined as a first focusing group,
   a lateral magnification of the first focusing group in a state where the infinite distance object is in focus is denoted by OFF,
   a combined lateral magnification of all lenses closer to the image side than the first focusing group in a state where the infinite distance object is in focus is denoted by βR, and
   βR=1 is established in a case where there is no lens on the image side with respect to the first focusing group,
   Conditional Expression (15) is satisfied, which is represented by

$$0.3 < \vert ( 1 - β {FF}^{2} ) \times β {R}^{2} \vert < 4. \qquad ( 15 )$$

### [Supplementary Note 29]

The optical system according to any one of Supplementary Notes 1 to 28,
in which, in a case where
   a paraxial radius of curvature of an image side surface of a lens closest to the object side is denoted by R1r, and
   a paraxial radius of curvature of an object side surface of a lens which is second from the object side is denoted by R2f,
   Conditional Expression (16) is satisfied, which is represented by

$$- 1.5 < ( R 1 r - R 2 f ) / ( R 1 r + R2f ) < 1.5 . \qquad ( 16 )$$

### [Supplementary Note 30]

The optical system according to any one of Supplementary Notes 1 to 29,
in which, in a case where
   a paraxial radius of curvature of an object side surface of a lens which is third from the object side is denoted by R3f, and
   a paraxial radius of curvature of an image side surface of the lens which is third from the object side is denoted by R3r,
   Conditional Expression (17) is satisfied, which is represented by

$$- 1 < ( R 3 f + R 3 r ) / ( R 3 f - R 3 r ) < 2.5 . \qquad ( 17 )$$

### [Supplementary Note 31]

The optical system according to any one of Supplementary Notes 1 to 30,
in which, in a case where
   a spacing on the optical axis between a lens closest to the object side and a lens which is second from the object side is denoted by d12,
   a distance on the optical axis from the lens surface of the optical system closest to the object side to a paraxial entrance pupil position in a state where the infinite distance object is in focus is denoted by Enp,
   a paraxial radius of curvature of an image side surface of the lens closest to the object side is denoted by R1r,
   a paraxial radius of curvature of an object side surface of the lens which is second from the object side is denoted by R2f, and

$$h 1 = E n p \times tan ω m is established ,$$

Conditional Expression (18) is satisfied, which is represented by

$$0.05 < d 12 / h 1 - ( 1 / R 1 r - 1 / R 2 f ) \times h 1 < 0.7 . \qquad ( 18 )$$

### [Supplementary Note 32]

The optical system according to any one of Supplementary Notes 1 to 31,
in which at least one first aspherical lens having at least one surface whose absolute value of a curvature at a position of a maximum effective diameter is greater than an absolute value of a paraxial curvature is disposed closer to the object side than the aperture stop.

### [Supplementary Note 33]

The optical system according to Supplementary Note 32,
in which, in a case where a refractive index of a first aspherical lens closest to the object side among the first aspherical lenses at a d line is denoted by Noa, Conditional Expression (19) is satisfied, which is represented by

$$1.45 < Noa < 1.7 . \qquad ( 19 )$$

### [Supplementary Note 34]

The optical system according to Supplementary Note 32,
in which, in a case where an Abbe number of a first aspherical lens closest to the object side among the first aspherical lenses based on a d line is voa, Conditional Expression (20) is satisfied, which is represented by

$$45 < voa < 85. \qquad ( 20 )$$

### [Supplementary Note 35]

The optical system according to any one of Supplementary Notes 1 to 34,
in which at least one second aspherical lens in which a refractive power at a position of a maximum effective diameter is shifted in a negative direction with respect to a refractive power in a paraxial region is disposed closer to the image side than the aperture stop.

### [Supplementary Note 36]

The optical system according to Supplementary Note 35,
in which, in a case where a refractive index of an aspherical lens closest to the image side among aspherical lenses disposed closer to the image side than the aperture stop at a d line is denoted by Nia, Conditional Expression (21) is satisfied, which is represented by

$$1. 45 < Nia < 2. \qquad ( 21 )$$

### [Supplementary Note 37]

The optical system according to Supplementary Note 35,
in which, in a case where an Abbe number of an aspherical lens closest to the image side among aspherical lenses disposed closer to the image side than the aperture stop based on a d line is denoted by via, Conditional Expression (22) is satisfied, which is represented by

$$38 < via < 100. \qquad ( 22 )$$

### [Supplementary Note 38]

The optical system according to any one of Supplementary Notes 1 to 37,
in which an image side surface of a positive lens closest to the aperture stop among positive lenses disposed closer to the object side than the aperture stop has a convex shape.

### [Supplementary Note 39]

The optical system according to any one of Supplementary Notes 1 to 38,
in which a negative meniscus lens, a negative meniscus lens, and a negative lens are disposed successively in order from a position closest to the object side to the image side.

### [Supplementary Note 40]

The optical system according to any one of Supplementary Notes 1 to 39, further comprising:
at least one cemented lens,
in which a cemented lens closest to the image side among the cemented lenses included in the optical system has a cemented surface convex toward the object side.

### [Supplementary Note 41]

The optical system according to any one of Supplementary Notes 1 to 40,
in which a cemented lens is disposed closest to the image side, and
the cemented lens disposed closest to the image side has a cemented surface convex toward the object side.

### [Supplementary Note 42]

The optical system according to any one of Supplementary Notes 1 to 41,
in which a negative lens and a positive lens are disposed successively in order from a position closest to the image side to the object side.

### [Supplementary Note 43]

The optical system according to any one of Supplementary Notes 1, to 41
in which a negative lens, a negative lens, a positive lens are disposed successively in order from a position closest to the image side to the object side.

### [Supplementary Note 44]

The optical system according to any one of Supplementary Notes 1 to 43,
in which, in a case where a group closest to the object side among groups that move during focusing is defined as a first focusing group, a lens surface of the first focusing group closest to the object side has a convex shape.

### [Supplementary Note 45]

The optical system according to any one of Supplementary Notes 1 to 44,
in which, in a case where a group closest to the object side among groups that move during focusing is defined as a first focusing group, the first focusing group includes five or more lenses.

### [Supplementary Note 46]

The optical system according to any one of Supplementary Notes 1 to 45,
in which, in a case where a group closest to the object side among groups that move during focusing is defined as a first focusing group, the aperture stop is disposed between a lens surface of the first focusing group closest to the object side and a lens surface of the first focusing group closest to the image side.

### [Supplementary Note 47]

The optical system according to any one of Supplementary Notes 1 to 47,
in which, in a case where a group closest to the object side among groups that move during focusing is defined as a first focusing group, a lens closest to the image side in the first focusing group is a positive lens convex toward the image side.

### [Supplementary Note 48]

The optical system according to Supplementary Note 47,
in which, in a case where
   an effective radius of an image side surface of the lens closest to the image side in the first focusing group is denoted by hLfi,
   a paraxial radius of curvature of the image side surface of the lens closest to the image side in the first focusing group is denoted by RLfi, and
   a thickness on the optical axis of the lens closest to the image side in the first focusing group is DLfi,
   Conditional Expression (23) is satisfied, which is represented by

$$0.3 < hLfi \times ( 1 / RLfi + 1 / DLfi ) < 5. \qquad ( 23 )$$

### [Supplementary Note 49]

The optical system according to any one of Supplementary Notes 1 to 48, further comprising:
at least one concave surface that is concave toward the image side and that is in contact with air,
in which, in a case where
   a concave surface closest to the image side among the concave surfaces is defined as an image side concave surface,
   a paraxial radius of curvature of the image side concave surface is Rne,
   a combined focal length of all optical elements in the optical system disposed closer to the image side than the image side concave surface is denoted by fe,
   fe takes an infinite value in a case where there is no optical element on the image side with respect to the image side concave surface, and
   the back focal length of the optical system at the air conversion distance in a state where the infinite distance object is in focus is denoted by Bf,
   Conditional Expression (24) is satisfied, which is represented by

$$- 8 < R n e \times ( 1 / fe - 1 / Bf ) < - 0.1 . \qquad ( 24 )$$

### [Supplementary Note 50]

The optical system according to any one of Supplementary Notes 1 to 49, further comprising, successively in order from a position closest to the object side to the image side:
a first lens group; and
a second lens group,
in which a spacing that changes during focusing is provided as a boundary between the lens groups, and
in a case where a focal length of the first lens group is denoted by f1, Conditional Expression (25) is satisfied, which is represented by

$$- 2 < f / f 1 < 3. \qquad ( 25 )$$

### [Supplementary Note 51]

The optical system according to any one of Supplementary Notes 1 to 50, further comprising, successively in order from a position closest to the object side to the image side:
a first lens group; and
a second lens group,
in which a spacing that changes during focusing is provided as a boundary between the lens groups, and
in a case where a focal length of the second lens group is denoted by f2, Conditional Expression (26) is satisfied, which is represented by

$$- 2.5 < f / f 2 < 2. \qquad ( 26 )$$

### [Supplementary Note 52]

The optical system according to any one of Supplementary Notes 1 to 51, further comprising, successively in order from a position closest to the object side to the image side:
a first lens group;
a second lens group; and
a third lens group,
in which spacings that change during focusing are provided as boundaries between the lens groups, and
in a case where a focal length of the third lens group is denoted by f3, Conditional Expression (27) is satisfied, which is represented by

$$- 0.35 < f / f 3 < 1.8 . \qquad ( 27 )$$

### [Supplementary Note 53]

The optical system according to any one of Supplementary Notes 1 to 52, further comprising, successively in order from a position closest to the object side to the image side:
a first lens group;
a second lens group;
a third lens group; and
a fourth lens group,
in which spacings that change during focusing are provided as boundaries between the lens groups, and
in a case where a focal length of the fourth lens group is denoted by f4, Conditional Expression (28) is satisfied, which is represented by

$$0.6 < f / f 4 < 1.6 . \qquad ( 28 )$$

### [Supplementary Note 54]

The optical system according to any one of Supplementary Notes 1 to 53, further comprising, successively in order from a position closest to the object side to the image side:
a first lens group; and
a second lens group,
in which a spacing that changes during focusing is provided as a boundary between the lens groups, and
in a case where
   a focal length of the first lens group is denoted by f1, and
   a focal length of the second lens group is denoted by f2,
   Conditional Expression (29) is satisfied, which is represented by

$$- 7 < f 2 / f 1 < 0.5 . \qquad ( 29 )$$

### [Supplementary Note 55]

The optical system according to any one of Supplementary Notes 1 to 54, further comprising, successively in order from a position closest to the object side to the image side:
a first lens group;
a second lens group; and
a third lens group,
in which spacings that change during focusing are provided as boundaries between the lens groups, and
in a case where
   a focal length of the second lens group is denoted by f2, and
   a focal length of the third lens group is denoted by f3,
   Conditional Expression (30) is satisfied, which is represented by

$$- 2.5 < f 2 / f 3 < 1.5 . \qquad ( 30 )$$

### [Supplementary Note 56]

The optical system according to any one of Supplementary Notes 1 to 55,
in which, in a case where a combined focal length of all optical elements in the optical system disposed closer to the image side than the aperture stop is fsR, Conditional Expression (31) is satisfied, which is represented by

$$- 0.2 < Y / fsR < 1.1 . \qquad ( 31 )$$

### [Supplementary Note 57]

An optical apparatus comprising:
the optical system according to any one of Supplementary Notes 1 to 56.

### [Supplementary Note 58]

The optical apparatus according to Supplementary Note 57, further comprising:
a body part,
in which the optical system is tilt-rotatable with respect to the body part.

### [Supplementary Note 59]

The optical apparatus according to Supplementary Note 58,
in which, in a case where
   a maximum angle range of the tilt rotation is denoted by θ,
   a unit of θ is defined as degrees, and
   the back focal length of the optical system at the air conversion distance in a state where the optical system is focused on the infinite distance object is denoted by Bf,
   Conditional Expression (32) is satisfied, which is represented by

$$0.08 < ( Y \times tan θ ) / Bf < 1. \qquad ( 32 )$$

All documents, patent applications, and technical standards described in this specification are herein incorporated by reference to the same extent that each individual document, patent application, or technical standard was specifically and individually indicated to be incorporated by reference.

What is claimed is:

1. An optical system comprising:
an aperture stop that has a variable opening diameter and that determines an F number of the optical system,
wherein at least one positive lens and at least one negative lens are disposed closer to an object side than the aperture stop,
at least one positive lens and at least one negative lens are disposed closer to an image side than the aperture stop,
an image side surface of at least one negative lens among the negative lenses disposed closer to the object side than the aperture stop has a concave shape, and
in a case where
a sum of a distance on an optical axis from a lens surface of the optical system closest to the object side to a lens surface of the optical system closest to the image side and a back focal length of the optical system at an air conversion distance in a state where an infinite distance object is in focus is denoted by TL,
a focal length of the optical system in a state where the infinite distance object is in focus is denoted by f,
a maximum half angle of view in a state where the infinite distance object is in focus is denoted by om, and
$$Y = f \times tan ω m is established ,$$
Conditional Expression (1) is satisfied, which is represented by
$$1 < TL / Y < 6.5 . \qquad ( 1 )$$

2. The optical system according to claim 1,
wherein the optical system consists of, in order from the object side to the image side, a first lens group that has a refractive power, a second lens group that has a positive refractive power, and a third lens group that has a refractive power,
during focusing, the first lens group and the third lens group do not move with respect to an image plane, and the second lens group moves along the optical axis, and
in a case where the back focal length of the optical system at the air conversion distance in a state where the infinite distance object is in focus is denoted by Bf, Conditional Expression (2) is satisfied, which is represented by
$$0.5 < Bf / f < 3. \qquad ( 2 )$$

3. The optical system according to claim 1, comprising, successively in order from a position closest to the object side to the image side:
a first lens group that has a refractive power; and
a second lens group that has a positive refractive power,
wherein the aperture stop is disposed between a lens surface of the first lens group closest to the image side and a lens surface of the second lens group closest to the object side,
during focusing, the first lens group does not move with respect to an image plane, and the second lens group moves along the optical axis,
the first lens group includes at least one cemented lens formed by cementing at least one positive lens and at least one negative lens,
a surface of a first cemented lens, which is a cemented lens closest to the image side among the cemented lenses included in the first lens group, closest to the object side has a concave shape, and
in a case where
an average value of Abbe numbers of all negative lenses included in the first cemented lens based on a d line is denoted by vnc1, and
an average value of Abbe numbers of all positive lenses included in the first cemented lens based on the d line is denoted by vpc1,
Conditional Expression (3) is satisfied, which is represented by
$$16 < vnc 1 - vpc 1 < 75. \qquad ( 3 )$$

4. The optical system according to claim 1,
wherein, in a case where the back focal length of the optical system at the air conversion distance in a state where the infinite distance object is in focus is denoted by Bf, Conditional Expression (2) is satisfied, which is represented by
$$0.5 < Bf / f < 3. \qquad ( 2 )$$

5. The optical system according to claim 1,
wherein, in a case where a group consisting of all optical elements disposed closer to the object side than a spacing closest to the object side among spacings that change during focusing is defined as a first lens group, the first lens group includes at least one cemented lens formed by cementing at least one positive lens and at least one negative lens, and
in a case where
a cemented lens closest to the image side among the cemented lenses included in the first lens group is defined as a first cemented lens,
an average value of Abbe numbers of all negative lenses included in the first cemented lens based on a d line is denoted by vnc1, and
an average value of Abbe numbers of all positive lenses included in the first cemented lens based on the d line is denoted by vpc1,
Conditional Expression (3) is satisfied, which is represented by
$$16 < vnc 1 - vpc 1 < 75. \qquad ( 3 )$$

6. The optical system according to claim 1,
wherein, in a case where a group consisting of all optical elements disposed closer to the object side than a spacing closest to the object side among spacings that change during focusing is defined as a first lens group, the first lens group includes at least one cemented lens formed by cementing at least one positive lens and at least one negative lens, and
in a case where a cemented lens closest to the image side among the cemented lenses included in the first lens group is defined as a first cemented lens, the first lens group includes, on the object side with respect to the first cemented lens, a negative meniscus lens convex toward the object side, a negative meniscus lens convex toward the object side, and a negative lens successively in order from the object side to the image side.

7. The optical system according to claim 1,
wherein the optical system consists of, in order from the object side to the image side, a first lens group, a second lens group, and a third lens group that has a refractive power, with spacings that change during focusing as boundaries between the lens groups.

8. The optical system according to claim 1, comprising, successively in order from a position closest to the object side to the image side:
a first lens group;
a second lens group; and
a third lens group that has a refractive power,
wherein spacings that change during focusing are provided as boundaries between the lens groups, and
during focusing, the third lens group does not move with respect to an image plane.

9. The optical system according to claim 1, comprising, successively in order from a position closest to the object side to the image side:
a first lens group;
a second lens group; and
a third lens group that has a refractive power,
wherein spacings that change during focusing are provided as boundaries between the lens groups, and
the third lens group includes at least one positive lens and at least one negative lens.

10. The optical system according to claim 9,
wherein, in a case where
an average value of Abbe numbers of all negative lenses included in the third lens group based on a d line is denoted by vn3, and
an average value of Abbe numbers of all positive lenses included in the third lens group based on the d line is denoted by vp3,
Conditional Expression (4) is satisfied, which is represented by
$$- 20 < vn 3 - vp 3 < 20. \qquad ( 4 )$$

11. The optical system according to claim 1, comprising, successively in order from a position closest to the object side to the image side:
a first lens group;
a second lens group; and
a third lens group that has a refractive power,
wherein spacings that change during focusing are provided as boundaries between the lens groups,
the third lens group includes at least one cemented lens formed by cementing at least one positive lens and at least one negative lens, and
in a case where
a cemented lens closest to the image side among the cemented lenses included in the third lens group is defined as a third cemented lens,
an average value of Abbe numbers of all negative lenses included in the third cemented lens based on a d line is denoted by vnc3, and
an average value of Abbe numbers of all positive lenses included in the third cemented lens based on the d line is denoted by vpc3,
Conditional Expression (5) is satisfied, which is represented by
$$- 80 < vnc 3 - vpc 3 < 20. \qquad ( 5 )$$

12. The optical system according to claim 1, comprising, successively in order from a position closest to the object side to the image side:
a first lens group;
a second lens group; and
a third lens group that has a negative refractive power,
wherein spacings that change during focusing are provided as boundaries between the lens groups.

13. The optical system according to claim 1, comprising, successively in order from a position closest to the object side to the image side:
a first lens group; and
a second lens group,
wherein a spacing that changes during focusing is provided as a boundary between the lens groups, and
during focusing, all lenses in the second lens group and the aperture stop move along the optical axis in an integrated manner.

14. The optical system according to claim 1, comprising, successively in order from a position closest to the object side to the image side:
a first lens group; and
a second lens group,
wherein a spacing that changes during focusing is provided as a boundary between the lens groups, and
the aperture stop is disposed closest to the object side in the second lens group.

15. The optical system according to claim 1, comprising, successively in order from a position closest to the object side to the image side:
a first lens group; and
a second lens group,
wherein a spacing that changes during focusing is provided as a boundary between the lens groups, and
in a case where
a negative lens which is second from the object side among negative lenses included in the first lens group is defined as a second negative lens, and
a combined focal length of all optical elements in the first lens group disposed closer to the image side than the second negative lens in a state where the infinite distance object is in focus is denoted by fG1R,
Conditional Expression (7) is satisfied, which is represented by
$$0.45 < fG 1 R / f < 3.5 . \qquad ( 7 )$$

16. The optical system according to claim 1,
wherein Conditional expression (8) is satisfied, which is represented by
$$3.6 < T {L}^{2} / ( Y \times f ) < 30. \qquad ( 8 )$$

17. The optical system according to claim 1, comprising, successively in order from a position closest to the object side to the image side:
a first lens group that has a negative refractive power; and
a second lens group,
wherein a spacing that changes during focusing is provided as a boundary between the lens groups.

18. The optical system according to claim 1,
wherein, in a case where the back focal length of the optical system at the air conversion distance in a state where the infinite distance object is in focus is denoted by Bf, Conditional Expression (10) is satisfied, which is represented by
$$0.3 < Y / Bf < 1.2 . \qquad ( 10 )$$

19. The optical system according to claim 1,
wherein, in a case where the back focal length of the optical system at the air conversion distance in a state where the infinite distance object is in focus is denoted by Bf, Conditional Expression (12) is satisfied, which is represented by
$$0. 2 < Bf / TL < 10. \qquad ( 12 )$$

20. The optical system according to claim 1,
wherein, in a case where
a distance on the optical axis from the lens surface of the optical system closest to the object side to a paraxial entrance pupil position in a state where the infinite distance object is in focus is denoted by Enp, and
the back focal length of the optical system at the air conversion distance in a state where the infinite distance object is in focus is denoted by Bf,
Conditional Expressions (11-2) and (12-1) are satisfied, which are represented by
$$0.01 < Enp / f < 0.26 , and \qquad ( 11 - 2 )$$
$$0.5 < Bf / TL < 10. \qquad ( 12 - 1 )$$

21. The optical system according to claim 1,
wherein, in a case where
a distance on the optical axis from the lens surface of the optical system closest to the object side to a paraxial entrance pupil position in a state where the infinite distance object is in focus is denoted by Enp, and
the back focal length of the optical system at the air conversion distance in a state where the infinite distance object is in focus is denoted by Bf,
Conditional Expressions (6-3) and (12-1) are satisfied, which are represented by
$$0.01 < Enp / Y < 0.57 , and \qquad ( 6 - 3 )$$
$$0.5 < Bf / TL < 10. \qquad ( 12 - 1 )$$

22. The optical system according to claim 1,
wherein, in a case where a lateral magnification of the optical system in a state where a nearest object is in focus is denoted by B, Conditional Expression (13) is satisfied, which is represented by
$$0.2 < \vert B \vert < 1.2 . \qquad ( 13 )$$

23. The optical system according to claim 1,
wherein, in a case where a maximum radius of an opening of the aperture stop is denoted by Hstp, Conditional Expression (14) is satisfied, which is represented by
$$0.03 < Hstp / f < 0.4 . \qquad ( 14 )$$

24. The optical system according to claim 1,
wherein, in a case where
a group closest to the object side among groups that move during focusing is defined as a first focusing group,
a lateral magnification of the first focusing group in a state where the infinite distance object is in focus is denoted by OFF,
a combined lateral magnification of all lenses closer to the image side than the first focusing group in a state where the infinite distance object is in focus is denoted by βR, and
βR=1 is established in a case where there is no lens on the image side with respect to the first focusing group,
Conditional Expression (15) is satisfied, which is represented by
$$0.3 < \vert ( 1 - β {FF}^{2} ) \times β {R}^{2} \vert < 4. \qquad ( 15 )$$

25. The optical system according to claim 1,
wherein, in a case where
a paraxial radius of curvature of an image side surface of a lens closest to the object side is denoted by R1r, and
a paraxial radius of curvature of an object side surface of a lens which is second from the object side is denoted by R2f,
Conditional Expression (16) is satisfied, which is represented by
$$- 1.5 < ( R 1 r - R 2 f ) / ( R 1 r + R 2 f ) < 1.5 . \qquad ( 16 )$$

26. The optical system according to claim 1,
wherein, in a case where
a paraxial radius of curvature of an object side surface of a lens which is third from the object side is denoted by R3f, and
a paraxial radius of curvature of an image side surface of the lens which is third from the object side is denoted by R3r,
Conditional Expression (17) is satisfied, which is represented by
$$- 1 < ( R 3 f + R 3 r ) / ( R 3 f - R 3 r ) < 2.5 . \qquad ( 17 )$$

27. The optical system according to claim 1,
wherein an image side surface of a positive lens closest to the aperture stop among positive lenses disposed closer to the object side than the aperture stop has a convex shape.

28. The optical system according to claim 1,
wherein a negative meniscus lens, a negative meniscus lens, and a negative lens are disposed successively in order from a position closest to the object side to the image side.

29. The optical system according to claim 1, comprising:
at least one cemented lens,
wherein a cemented lens closest to the image side among the cemented lenses included in the optical system has a cemented surface convex toward the object side.

30. The optical system according to claim 1,
wherein a cemented lens is disposed closest to the image side, and
the cemented lens disposed closest to the image side has a cemented surface convex toward the object side.

31. The optical system according to claim 1,
wherein, in a case where a group closest to the object side among groups that move during focusing is defined as a first focusing group, a lens surface of the first focusing group closest to the object side has a convex shape.

32. The optical system according to claim 1,
wherein, in a case where a group closest to the object side among groups that move during focusing is defined as a first focusing group, the first focusing group includes five or more lenses.

33. The optical system according to claim 1,
wherein, in a case where a group closest to the object side among groups that move during focusing is defined as a first focusing group, a lens closest to the image side in the first focusing group is a positive lens convex toward the image side.

34. The optical system according to claim 33,
wherein, in a case where
an effective radius of an image side surface of the lens closest to the image side in the first focusing group is denoted by hLfi,
a paraxial radius of curvature of the image side surface of the lens closest to the image side in the first focusing group is denoted by RLfi, and
a thickness on the optical axis of the lens closest to the image side in the first focusing group is DLfi,
Conditional Expression (23) is satisfied, which is represented by
$$0.3 < hLfi \times ( 1 / RLfi + 1 / DLfi ) < 5. \qquad ( 23 )$$

35. The optical system according to claim 1, comprising:
at least one concave surface that is concave toward the image side and that is in contact with air,
wherein, in a case where
a concave surface closest to the image side among the concave surfaces is defined as an image side concave surface,
a paraxial radius of curvature of the image side concave surface is Rne,
a combined focal length of all optical elements in the optical system disposed closer to the image side than the image side concave surface is denoted by fe,
fe takes an infinite value in a case where there is no optical element on the image side with respect to the image side concave surface, and
the back focal length of the optical system at the air conversion distance in a state where the infinite distance object is in focus is denoted by Bf,
Conditional Expression (24) is satisfied, which is represented by
$$- 8 < Rne \times ( 1 / fe - 1 / Bf ) < - 0.1 . \qquad ( 24 )$$

36. The optical system according to claim 1, comprising, successively in order from a position closest to the object side to the image side:
a first lens group; and
a second lens group,
wherein a spacing that changes during focusing is provided as a boundary between the lens groups, and
in a case where a focal length of the first lens group is denoted by f1, Conditional Expression (25) is satisfied, which is represented by
$$- 2 < f / f 1 < 3. \qquad ( 25 )$$

37. The optical system according to claim 1, comprising, successively in order from a position closest to the object side to the image side:
a first lens group; and
a second lens group,
wherein a spacing that changes during focusing is provided as a boundary between the lens groups, and
in a case where a focal length of the second lens group is denoted by f2, Conditional Expression (26) is satisfied, which is represented by
$$- 2.5 < f / f 2 < 2. \qquad ( 26 )$$

38. The optical system according to claim 1, comprising, successively in order from a position closest to the object side to the image side:
a first lens group;
a second lens group; and
a third lens group,
wherein spacings that change during focusing are provided as boundaries between the lens groups, and
in a case where a focal length of the third lens group is denoted by f3, Conditional Expression (27) is satisfied, which is represented by
$$- 0.35 < f / f 3 < 1.8 . \qquad ( 27 )$$

39. The optical system according to claim 1, comprising, successively in order from a position closest to the object side to the image side:
a first lens group; and
a second lens group,
wherein a spacing that changes during focusing is provided as a boundary between the lens groups, and
in a case where
a focal length of the first lens group is denoted by f1, and
a focal length of the second lens group is denoted by f2,
Conditional Expression (29) is satisfied, which is represented by
$$- 7 < f 2 / f 1 < 0.5 . \qquad ( 29 )$$

40. The optical system according to claim 1, comprising, successively in order from a position closest to the object side to the image side:
a first lens group;
a second lens group; and
a third lens group,
wherein spacings that change during focusing are provided as boundaries between the lens groups, and
in a case where
a focal length of the second lens group is denoted by f2, and
a focal length of the third lens group is denoted by f3,
Conditional Expression (30) is satisfied, which is represented by
$$- 2.5 < f 2 / f 3 < 1.5 . \qquad ( 30 )$$

41. The optical system according to claim 1,
wherein, in a case where a combined focal length of all optical elements in the optical system disposed closer to the image side than the aperture stop is fsR, Conditional Expression (31) is satisfied, which is represented by
$$- 0.2 < Y / fsR < 1.1 . \qquad ( 31 )$$

42. An optical apparatus comprising:
the optical system according to claim 1.

43. The optical apparatus according to claim 42, further comprising:
a body part,
wherein the optical system is tilt-rotatable with respect to the body part.

44. The optical apparatus according to claim 43,
wherein, in a case where
a maximum angle range of the tilt rotation is denoted by θ,
a unit of θ is defined as degrees, and
the back focal length of the optical system at the air conversion distance in a state where the optical system is focused on the infinite distance object is denoted by Bf,
Conditional Expression (32) is satisfied, which is represented by
$$0.08 < ( Y \times tan θ ) / Bf < 1. \qquad ( 32 )$$
